(19) United States
(12) Patent Application Publication
(10) Pub. No.: US 2026/0361921 A1
(43) Pub. Date: Nov. 12, 2026

(54) METHOD, APPARATUS, AND MEDIUM FOR VISUAL DATA PROCESSING

(71) Applicants: Douyin Vision Co., Ltd., Beijing (CN); Bytedance Inc., Los Angeles (CN)

(72) Inventors: Ye-Kui WANG, Los Angeles, CA (US); Semih ESENLIK, Los Angeles, CA (US); Zhaobin ZHANG, Los Angeles, CA (US); Li ZHANG, Los Angeles, CA (US); Jizheng XU, Los Angeles, CA (US); Yaojun WU, Beijing (CN); Kai ZHANG, Los Angeles, CA (US)

(21) Appl. No.: 19/715,999

(22) Filed: Jun. 22, 2026

Related U.S. Application Data
(63) Continuation of application No. PCT/CN2024/140942, filed on Dec. 20, 2024.

(30) Foreign Application Priority Data
Dec. 22, 2023 (WO) PCT/CN2023/141272

(51) Int. Cl. H04N 19/70; G06T 9/00

(52) U.S. Cl. CPC H04N 19/70; G06T 9/002

(57) ABSTRACT

Embodiments of the present disclosure provide a solution for visual data processing. A method for visual data processing is proposed. The method comprises: performing a conversion between visual data and a codestream of the visual data with a neural network (NN)-based model, wherein the codestream comprises at least one indication indicating whether multithreads is used for coding at least one of the following: a hyper tensor codestream in the codestream, a quality map codestream in the codestream, a primary component residual codestream in the codestream, or a secondary component residual codestream in the codestream.

### CROSS REFERENCE

This application is a continuation of International Application No. PCT/CN2024/140942, filed on Dec. 20, 2024, which claims the benefit of International Application No. PCT/CN2023/141272, filed on Dec. 22, 2023. The entire contents of these applications are hereby incorporated by reference in their entireties.

### FIELDS

Embodiments of the present disclosure relates generally to visual data processing techniques, and more particularly, to neural network-based visual data coding.

### BACKGROUND

The past decade has witnessed the rapid development of deep learning in a variety of areas, especially in computer vision and image processing. Neural network was invented originally with the interdisciplinary research of neuroscience and mathematics. It has shown strong capabilities in the context of non-linear transform and classification. Neural network-based image/video compression technology has gained significant progress during the past half decade. It is reported that the latest neural network-based image compression algorithm achieves comparable rate-distortion (R-D) performance with Versatile Video Coding (VVC). With the performance of neural image compression continually being improved, neural network-based video compression has become an actively developing research area. However, coding efficiency of neural network-based image/video coding is generally expected to be further improved.

### SUMMARY

Embodiments of the present disclosure provide a solution for visual data processing.

In a first aspect, a method for visual data processing is proposed. The method comprises: performing a conversion between visual data and a codestream of the visual data with a neural network (NN)-based model, wherein the codestream comprises at least one indication indicating whether multithreads is used for coding at least one of the following: a hyper tensor codestream in the codestream, a quality map codestream in the codestream, a primary component residual codestream in the codestream, or a secondary component residual codestream in the codestream.

Based on the method in accordance with the first aspect of the present disclosure, the codestream comprises at least one indication indicating whether multithreads is used for coding at least one of the following: a hyper tensor codestream in the codestream, a quality map codestream in the codestream, a primary component residual codestream in the codestream, or a secondary component residual codestream in the codestream. Compared with the conventional solution lacking such an indication(s), the proposed method can better support the application of multithreads for coding the codestream, and thus the coding efficiency can be improved.

In a second aspect, an apparatus for visual data processing is proposed. The apparatus comprises a processor and a non-transitory memory with instructions thereon. The instructions upon execution by the processor, cause the processor to perform a method in accordance with the first aspect of the present disclosure.

In a third aspect, a non-transitory computer-readable storage medium is proposed. The non-transitory computer-readable storage medium stores instructions that cause a processor to perform a method in accordance with the first aspect of the present disclosure.

In a fourth aspect, another non-transitory computer-readable recording medium is proposed. The non-transitory computer-readable recording medium stores a codestream of visual data which is generated by a method performed by an apparatus for visual data processing. The method comprises: performing a conversion between the visual data and the codestream with a neural network (NN)-based model, wherein the codestream comprises at least one indication indicating whether multithreads is used for coding at least one of the following: a hyper tensor codestream in the codestream, a quality map codestream in the codestream, a primary component residual codestream in the codestream, or a secondary component residual codestream in the codestream.

In a fifth aspect, a method for storing a codestream of visual data is proposed. The method comprises: performing a conversion between the visual data and the codestream with a neural network (NN)-based model; and storing the codestream in a non-transitory computer-readable recording medium, wherein the codestream comprises at least one indication indicating whether multithreads is used for coding at least one of the following: a hyper tensor codestream in the codestream, a quality map codestream in the codestream, a primary component residual codestream in the codestream, or a secondary component residual codestream in the codestream.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

Through the following detailed description with reference to the accompanying drawings, the above and other objectives, features, and advantages of example embodiments of the present disclosure will become more apparent. In the example embodiments of the present disclosure, the same reference numerals usually refer to the same components.

FIG. 1A illustrates a block diagram that illustrates an example visual data coding system, in accordance with some embodiments of the present disclosure;

FIG. 1B is a schematic diagram illustrating an example transform coding scheme;

FIG. 2 illustrates example latent representations of an image;

FIG. 3 is a schematic diagram illustrating an example autoencoder implementing a hyperprior model;

FIG. 4 is a schematic diagram illustrating an example combined model configured to jointly optimize a context model along with a hyperprior and the autoencoder;

FIG. 5 illustrates an example encoding process;

FIG. 6 illustrates an example decoding process;

FIG. 7 illustrates an example decoding process according to some embodiments of the present disclosure;

FIG. 8 illustrates an example learning-based image codec architecture;

FIG. 9 illustrates an example synthesis transform for learning based image coding;

FIG. 10 illustrates an example leaky Rectified Linear Unit (ReLU) activation function;

FIG. 11 illustrates an example ReLU activation function;

FIG. 12 illustrates latent tiles in synthesis transform;

FIG. 13 illustrates a bitstream layout;

FIG. 14 illustrates an example decoder structure;

FIG. 15 illustrates an example hyper scale decoder;

FIG. 16 illustrates an example hyper decoder;

FIG. 17 illustrates a diagram of an example multistage context modelling (MCM) structure;

FIG. 18 illustrates an example implementation of primary component guided adaptive up-sampling filter;

FIG. 19 illustrates two example partition patterns, wherein equipartitioned regions shown on the left, and shifted regions shown on the right;

FIGS. 20A-20C illustrate three example alignment schemes;

FIG. 21 illustrates latent tiles in synthesis transform;

FIG. 22 illustrates an example bitstream layout;

FIG. 23 illustrates an example decoder structure;

FIG. 24 illustrates an example hyper scale decoder;

FIG. 25 illustrates an example hyper decoder;

FIG. 26 illustrates a diagram of an example MCM structure;

FIG. 27 illustrates an example implementation of primary component guided adaptive up-sampling filter;

FIG. 28 illustrates a flowchart of a method for visual data processing in accordance with embodiments of the present disclosure; and

FIG. 29 illustrates a block diagram of a computing device in which various embodiments of the present disclosure can be implemented.

Throughout the drawings, the same or similar reference numerals usually refer to the same or similar elements.

### DETAILED DESCRIPTION

Principle of the present disclosure will now be described with reference to some embodiments. It is to be understood that these embodiments are described only for the purpose of illustration and help those skilled in the art to understand and implement the present disclosure, without suggesting any limitation as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an example embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

### Example Environment

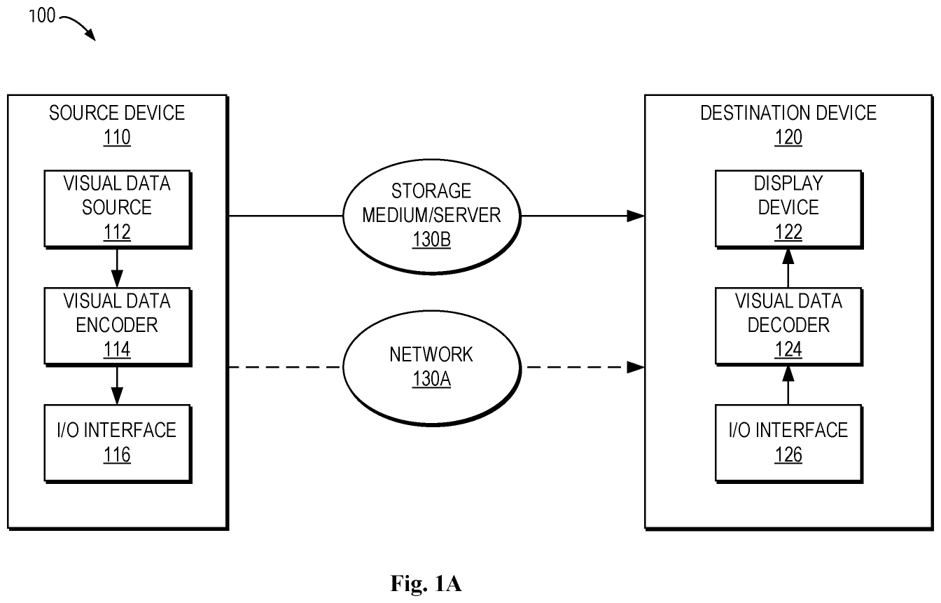

FIG. 1A is a block diagram that illustrates an example visual data coding system 100 that may utilize the techniques of this disclosure. As shown, the visual data coding system 100 may include a source device 110 and a destination device 120. The source device 110 can be also referred to as a visual data encoding device, and the destination device 120 can be also referred to as a visual data decoding device. In operation, the source device 110 can be configured to generate encoded visual data and the destination device 120 can be configured to decode the encoded visual data generated by the source device 110. The source device 110 may include a visual data source 112, a visual data encoder 114, and an input/output (I/O) interface 116.

The visual data source 112 may include a source such as a visual data capture device. Examples of the visual data capture device include, but are not limited to, an interface to receive visual data from a visual data provider, a computer graphics system for generating visual data, and/or a combination thereof.

The visual data may comprise one or more pictures of a video or one or more images. The visual data encoder 114 encodes the visual data from the visual data source 112 to generate a bitstream. The bitstream may include a sequence of bits that form a coded representation of the visual data. The bitstream may include coded pictures and associated visual data. The coded picture is a coded representation of a picture. The associated visual data may include sequence parameter sets, picture parameter sets, and other syntax structures. The I/O interface 116 may include a modulator/demodulator and/or a transmitter.

The encoded visual data may be transmitted directly to destination device 120 via the I/O interface 116 through the network 130A. The encoded visual data may also be stored onto a storage medium/server 130B for access by destination device 120.

The destination device 120 may include an I/O interface 126, a visual data decoder 124, and a display device 122. The I/O interface 126 may include a receiver and/or a modem. The I/O interface 126 may acquire encoded visual data from the source device 110 or the storage medium/server 130B. The visual data decoder 124 may decode the encoded visual data. The display device 122 may display the decoded visual data to a user. The display device 122 may be integrated with the destination device 120, or may be external to the destination device 120 which is configured to interface with an external display device.

The visual data encoder 114 and the visual data decoder 124 may operate according to a visual data coding standard, such as video coding standard or still picture coding standard and other current and/or further standards.

Some exemplary embodiments of the present disclosure will be described in detailed hereinafter. It should be understood that section headings are used in the present document to facilitate ease of understanding and do not limit the embodiments disclosed in a section to only that section. Furthermore, while certain embodiments are described with reference to Versatile Video Coding or other specific visual data codecs, the disclosed techniques are applicable to other coding technologies also. Furthermore, while some embodiments describe coding steps in detail, it will be understood that corresponding steps decoding that undo the coding will be implemented by a decoder. Furthermore, the term visual data processing encompasses visual data coding or compression, visual data decoding or decompression and visual data transcoding in which visual data are represented from one compressed format into another compressed format or at a different compressed bitrate.

### 1. Brief Summary

This disclosure is related to neural network (NN)-based image and video coding. Specifically, it is related to support of regional accessibility, wherein regional accessibility refers to the capability of correctly decoding only a regional part of an image (also referred to as a picture) or a video. The ideas may be applied individually or in various combinations, for image and/or video coding methods and specifications.

### 2. Introduction

The past decade has witnessed the rapid development of deep learning in a variety of areas, especially in computer vision and image processing. Inspired from the great success of deep learning technology to computer vision areas, many researchers have shifted their attention from conventional image/video compression techniques to neural image/video compression technologies. Neural network was invented originally with the interdisciplinary research of neuroscience and mathematics. It has shown strong capabilities in the context of non-linear transform and classification. Neural network-based image/video compression technology has gained significant progress during the past half decade. It is reported that the latest neural network-based image compression algorithm achieves comparable R-D performance with Versatile Video Coding (VVC), the latest video coding standard developed by Joint Video Experts Team (JVET) with experts from MPEG and VCEG. With the performance of neural image compression continually being improved, neural network-based video compression has become an actively developing research area. However, neural network-based video coding still remains in its infancy due to the inherent difficulty of the problem.

### 1.1 Image/Video Compression

Image/video compression (also referred to as image/video coding) usually refers to the computing technology that compresses image/video into binary code to facilitate storage and transmission. The binary codes may or may not support losslessly reconstructing the original image/video, termed lossless compression and lossy compression. Most of the efforts are devoted to lossy compression since lossless reconstruction is not necessary in most scenarios. Usually the performance of image/video compression algorithms is evaluated from two aspects, i.e. compression ratio and reconstruction quality. Compression ratio is directly related to the number of binary codes, the less the better; Reconstruction quality is measured by comparing the reconstructed image/video with the original image/video, the higher the better.

Image/video compression techniques can be divided into two branches, the classical video coding methods and the neural-network-based video compression methods. Classical video coding schemes adopt transform-based solutions, in which researchers have exploited statistical dependency in the latent variables (e.g., DCT or wavelet coefficients) by carefully hand-engineering entropy codes modeling the dependencies in the quantized regime. Neural network-based video compression is in two flavors, neural network-based coding tools and end-to-end neural network-based video compression. The former is embedded into existing classical video codecs as coding tools and only serves as part of the framework, while the latter is a separate framework developed based on neural networks without depending on classical video codecs.

In the last three decades, a series of classical video coding standards have been developed to accommodate the increasing visual content. The international standardization organizations ISO/IEC has two expert groups namely Joint Photographic Experts Group (JPEG) and Moving Picture Experts Group (MPEG), and ITU-T also has its own Video Coding Experts Group (VCEG) which is for standardization of image/video coding technology. The influential video coding standards published by these organizations include JPEG, JPEG 2000, H.262, H.264/AVC and H.265/HEVC. After H.265/HEVC, the Joint Video Experts Team (JVET) formed by MPEG and VCEG has been working on a new video coding standard Versatile Video Coding (VVC). The first version of VVC was released in July 2020. An average of 50% bitrate reduction is reported by VVC under the same visual quality compared with HEVC.

Neural network-based image/video compression is not a new invention since there were a number of researchers working on neural network-based image coding. But the network architectures were relatively shallow, and the performance was not satisfactory. Benefit from the abundance of data and the support of powerful computing resources, neural network-based methods are better exploited in a variety of applications. At present, neural network-based image/video compression has shown promising improvements, confirmed its feasibility. Nevertheless, this technology is still far from mature and a lot of challenges need to be addressed.

### 1.2 Neural Networks

Neural networks, also known as artificial neural networks (ANN), are the computational models used in machine learning technology which are usually composed of multiple processing layers and each layer is composed of multiple simple but non-linear basic computational units. One benefit of such deep networks is believed to be the capacity for processing data with multiple levels of abstraction and converting data into different kinds of representations. Note that these representations are not manually designed; instead, the deep network including the processing layers is learned from massive data using a general machine learning procedure. Deep learning eliminates the necessity of handcrafted representations, and thus is regarded useful especially for processing natively unstructured data, such as acoustic and visual signal, whilst processing such data has been a longstanding difficulty in the artificial intelligence field.

### 1.3 Neural Networks for Image Compression

Existing neural networks for image compression methods can be classified in two categories, i.e., pixel probability modeling and auto-encoder. The former one belongs to the predictive coding strategy, while the latter one is the transform-based solution. Sometimes, these two methods are combined together in literature.

### 1.3.1 Pixel Probability Modeling

According to Shannon's information theory, the optimal method for lossless coding can reach the minimal coding rate−log₂ p(x) where p(x) is the probability of symbol x. A number of lossless coding methods were developed in literature and among them arithmetic coding is believed to be among the optimal ones. Given a probability distribution p(x), arithmetic coding ensures that the coding rate to be as close as possible to its theoretical limit −log₂p(x) without considering the rounding error. Therefore, the remaining problem is to how to determine the probability, which is however very challenging for natural image/video due to the curse of dimensionality. Following the predictive coding strategy, one way to model p(x) is to predict pixel probabilities one by one in a raster scan order based on previous observations, where x is an image.

p(x)=p(x₁)p(x₂|x₁) . . . p(xᵢ|x₁, . . . ,xᵢ₋₁) . . . p(x_{m×n}|x₁, . . . ,x_{m×n-1}) (1)

where m and n are the height and width of the image, respectively. The previous observation is also known as the context of the current pixel. When the image is large, it can be difficult to estimate the conditional probability, thereby a simplified method is to limit the range of its context.

p(x)=p(x₁)p(x₂|x₁) . . . p(xᵢ|xᵢ₋ₖ, . . . ,xᵢ₋₁) . . . p(x_{m×n}|x_{m×n-k}, . . . ,x_{m×n-1}) (2)

where k is a pre-defined constant controlling the range of the context.

It should be noted that the condition may also take the sample values of other color components into consideration. For example, when coding the RGB color component, R sample is dependent on previously coded pixels (including R/G/B samples), the current G sample may be coded according to previously coded pixels and the current R sample, while for coding the current B sample, the previously coded pixels and the current R and G samples may also be taken into consideration.

Neural networks were originally introduced for computer vision tasks and have been proven to be effective in regression and classification problems. Therefore, it has been proposed using neural networks to estimate the probability of p(xᵢ) given its context x₁, x₂, . . . , xᵢ₋₁.

Most of the methods directly model the probability distribution in the pixel domain. Some researchers also attempt to model the probability distribution as a conditional one upon explicit or latent representations. That being said, it may be estimated that

$$p ( x \vert h ) = {\prod }_{i = 1}^{m \times n} p ( {x}_{i} \vert {x}_{1} , … , {x}_{i - 1} , h ) \qquad ( 3 )$$

where h is the additional condition and p(x)=p(h)p(x|h), meaning the modeling is split into an unconditional one and a conditional one. The additional condition can be image label information or high-level representations.

### 1.3.2 Auto-Encoder

Auto-encoder originates from the well-known work proposed by Hinton and Salakhutdinov. The method is trained for dimensionality reduction and consists of two parts: encoding and decoding. The encoding part converts the high-dimension input signal to low-dimension representations, typically with reduced spatial size but a greater number of channels. The decoding part attempts to recover the high-dimension input from the low-dimension representation. Auto-encoder enables automated learning of representations and eliminates the need of hand-crafted features, which is also believed to be one of the most important advantages of neural networks. FIG. 1B illustrates a typical transform coding scheme. The original image x is transformed by the analysis network gₐ to achieve the latent representation y. The latent representation y is quantized and compressed into bits. The number of bits R is used to measure the coding rate. The quantized latent representation ŷ is then inversely transformed by a synthesis network gₛ to obtain the reconstructed image R. The distortion is calculated in a perceptual space by transforming x and \hat{x} with the function gₚ.

It is intuitive to apply auto-encoder network to lossy image compression. It is only needed to encode the learned latent representation from the well-trained neural networks. However, it is not trivial to adapt auto-encoder to image compression since the original auto-encoder is not optimized for compression thereby not efficient by directly using a trained auto-encoder. In addition, there exist other major challenges: First, the low-dimension representation should be quantized before being encoded, but the quantization is not differentiable, which is required in backpropagation while training the neural networks. Second, the objective under compression scenario is different since both the distortion and the rate need to be take into consideration. Estimating the rate is challenging. Third, a practical image coding scheme needs to support variable rate, scalability, encoding/decoding speed, interoperability. In response to these challenges, a number of researchers have been actively contributing to this area.

The prototype auto-encoder for image compression is in FIG. 1B, which can be regarded as a transform coding strategy. The original image x is transformed with the analysis network y=gₐ(x), where y is the latent representation which will be quantized and coded. The synthesis network will inversely transform the quantized latent representation ŷ back to obtain the reconstructed image \hat{x}=gₛ(ŷ). The framework is trained with the rate-distortion loss function, i.e., [symbol] =D+λR, where D is the distortion between x and \hat{x}, R is the rate calculated or estimated from the quantized representation ŷ, and λ is the Lagrange multiplier. It should be noted that D can be calculated in either pixel domain or perceptual domain. All existing research works follow this prototype and the difference might only be the network structure or loss function.

### 1.3.3 Hyper Prior Model

In the transform coding approach to image compression, the encoder subnetwork (section 2.3.2) transforms the image vector x using a parametric analysis transform gₐ(x, Ø_{g}) into a latent representation y, which is then quantized to form ŷ. Because ŷ is discrete-valued, it can be losslessly compressed using entropy coding techniques such as arithmetic coding and transmitted as a sequence of bits.

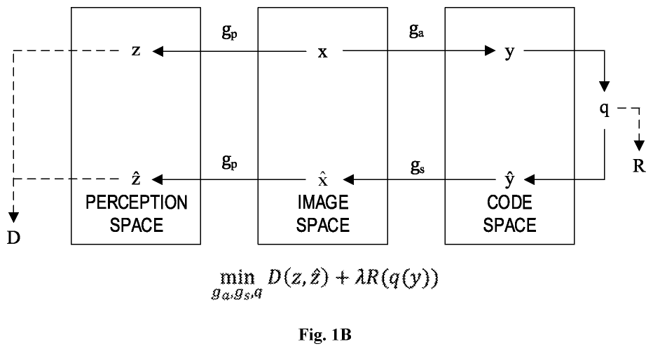

As evident from the middle left and middle right image of FIG. 2, there are significant spatial dependencies among the elements of ŷ. Notably, their scales (middle right image) appear to be coupled spatially. An additional set of random variables \hat{z} can be introduced to capture the spatial dependencies and to further reduce the redundancies.

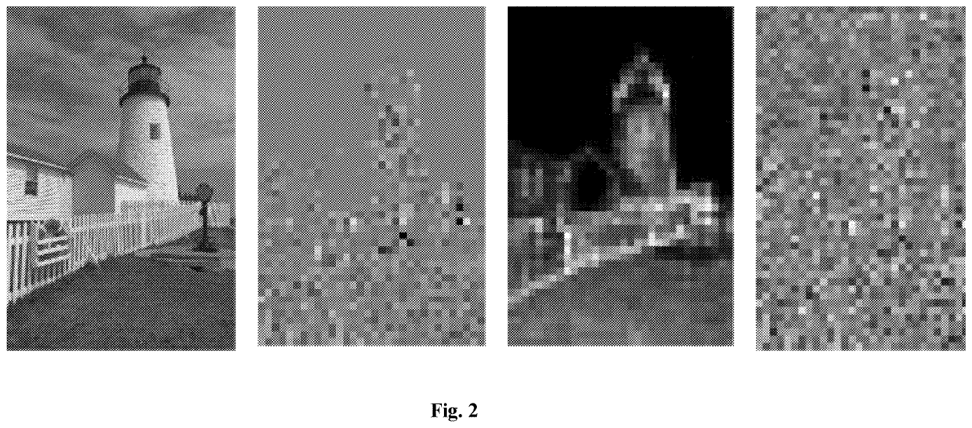

In this case the image compression network is depicted in FIG. 3.

In FIG. 3, the left hand of the models is the encoder gₐ and decoder gₛ (explained in section 2.3.2). The right-hand side is the additional hyper encoder hₐ and hyper decoder hₛ networks that are used to obtain 2. In this architecture the encoder subjects the input image x to gₐ, yielding the responses y with spatially varying standard deviations. The responses y are fed into hₐ, summarizing the distribution of standard deviations in z. z is then quantized (2), compressed, and transmitted as side information. The encoder then uses the quantized vector \hat{z} to estimate σ, the spatial distribution of standard deviations, and uses it to compress and transmit the quantized image representation ŷ. The decoder first recovers 2 from the compressed signal. It then uses hₛ to obtain σ, which provides it with the correct probability estimates to successfully recover ŷ as well. It then feeds ŷ into gₛ to obtain the reconstructed image.

When the hyper encoder and hyper decoder are added to the image compression network, the spatial redundancies of the quantized latent y are reduced. The rightmost image in FIG. 2 correspond to the quantized latent when hyper encoder/decoder are used. Compared to middle right image, the spatial redundancies are significantly reduced, as the samples of the quantized latent are less correlated.

In FIG. 2: Left: an image from the Kodak dataset. Middle left: visualization of a latent representation y of that image. Middle right: standard deviations a of the latent. Right: latents y after the hyper prior (hyper encoder and decoder) network is introduced.

FIG. 3 illustrates Network architecture of a autoencoder implementing the hyperprior model. The left side shows an image autoencoder network, the right side corresponds to the hyperprior subnetwork. The analysis and synthesis transforms are denoted as gₐ and gₐ. Q represents quantization, and AE, AD represent arithmetic encoder and arithmetic decoder, respectively. The hyperprior model consists of two subnetworks, hyper encoder (denoted with hₐ) and hyper decoder (denoted with hₛ). The hyper prior model generates a quantized hyper latent (2) which comprises information about the probability distribution of the samples of the quantized latent y. 2 is included in the bitsteam and transmitted to the receiver (decoder) along with y.

### 1.3.4 Context Model

Although the hyper prior model improves the modelling of the probability distribution of the quantized latent y, additional improvement can be obtained by utilizing an autoregressive model that predicts quantized latents from their causal context (Context Model).

The term auto-regressive means that the output of a process is later used as input to it. For example the context model subnetwork generates one sample of a latent, which is later used as input to obtain the next sample.

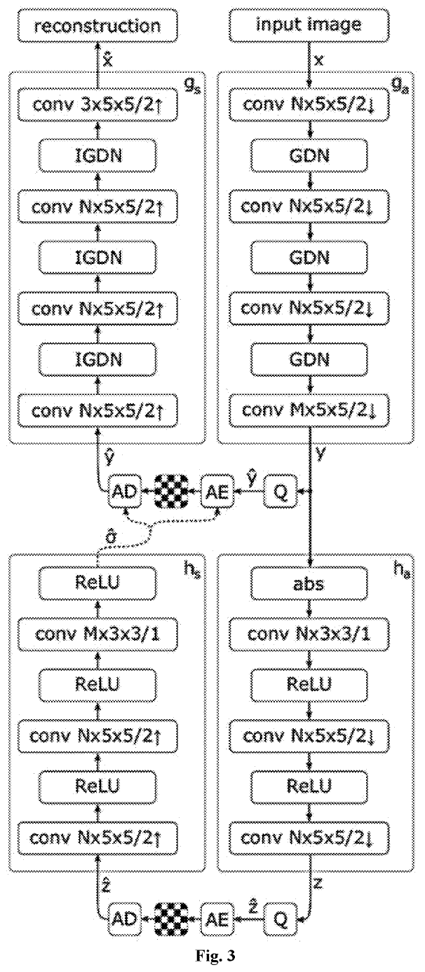

FIG. 4 is a schematic diagram illustrating an example combined model configured to jointly optimize a context model along with a hyperprior and the autoencoder. The following Table 1 illustrates meaning of different symbols.

TABLE 1
Illustration of symbols

| Component | Symbol |
|---|---|
| Input Image | x |
| Encoder | f(x; θₑ) |
| Latents | y |
| Latents (quantized) | ŷ |
| Decoder | g(ŷ; θ_{d}) |
| Hyper Encoder | fₕ(y; θₕₑ) |
| Hyper-Latents | z |
| Hyper-Latents (quantized) | \hat{z} |
| Hyper Decoder | gₕ(\hat{z}; θ_{hd}) |
| Context Model | g_{cm}(y_{<i}; θ_{cm}) |
| Entropy Parameters | gₑₚ(·; θₑₚ) |
| Reconstruction | \hat{x} |

A joint architecture can be utilized where both hyper prior model subnetwork (hyper encoder and hyper decoder) and a context model subnetwork are utilized. The hyper prior and the context model are combined to learn a probabilistic model over quantized latents y, which is then used for entropy coding. As depicted in FIG. 4, the outputs of context subnetwork and hyper decoder subnetwork are combined by the subnetwork called Entropy Parameters, which generates the mean y and scale (or variance) a parameters for a Gaussian probability model.

The gaussian probability model is then used to encode the samples of the quantized latents into bitstream with the help of the arithmetic encoder (AE) module. In the decoder the gaussian probability model is utilized to obtain the quantized latents y from the bitstream by arithmetic decoder (AD) module.

FIG. 4 illustrates the combined model jointly optimizes an autoregressive component that estimates the probability distributions of latents from their causal context (Context Model) along with a hyperprior and the underlying autoencoder. Real-valued latent representations are quantized (Q) to create quantized latents (f) and quantized hyper-latents (\hat{z}), which are compressed into a bitstream using an arithmetic encoder (AE) and decompressed by an arithmetic decoder (AD). The highlighted region corresponds to the components that are executed by the receiver (i.e. a decoder) to recover an image from a compressed bitstream.

Typically the latent samples are modeled as gaussian distribution or gaussian mixture models (not limited to). According to FIG. 4, the context model and hyper prior are jointly used to estimate the probability distribution of the latent samples. Since a gaussian distribution can be defined by a mean and a variance (aka sigma or scale), the joint model is used to estimate the mean and variance (denoted as μ and σ).

### 1.3.5 Gained Variational Autoencoders (G-VAE)

Typically, neural network-based image/video compression methodologies need to train multiple models to adapt to different rates. Gained variational autoencoders (G-VAE) is the variational autoencoder with a pair of gain units, which is designed to achieve continuously variable rate adaptation using a single model. It comprises of a pair of gain units, which are typically inserted to the output of encoder and input of decoder. The output of the encoder is defined as the latent representation y∈R^{c*h*w}, where c, h, w represent the number of channels, the height and width of the latent representation. Each channel of the latent representation is denoted as y₍ᵢ₎∈R^{h*w}, where i=0, 1, . . . , c−1. A pair of gain units include a gain matrix M∈R^{c*n} and an inverse gain matrix, where n is the number of gain vectors. The gain vector can be denoted as mₛ={αₛ₍₀₎, αₛ₍₁₎, . . . , α_{s(c-1)}}, αₛ₍ᵢ₎∈R where s denotes the index of the gain vectors in the gain matrix.

The motivation of gain matrix is similar to the quantization table in JPEG by controlling the quantization loss based on the characteristics of different channels. To apply the gain matrix to the latent representation, each channel is multiplied with the corresponding value in a gain vector.

y̅ₛ=y⊙mₛ

where ⊙ is channel-wise multiplication, i.e., y̅ₛ₍ᵢ₎=y₍ᵢ₎×αₛ₍ᵢ₎, and αₛ₍ᵢ₎ is the i-th gain value in the gain vector mₛ. The inverse gain matrix used at the decoder side can be denoted as M′∈R^{c*n}, which consists of n inverse gain vectors, i.e., M′={δₛ₍₀₎, δₛ₍₁₎, . . . , δ_{s(c-1)}}, δₛ₍ᵢ₎∈R. The inverse gain process is expressed as:

$${y}_{s}^{′} = \hat{y} ⊙ {m}_{s}^{′}$$

where ŷ is the decoded quantized latent representation and

$${y}_{s}^{′}$$

is the inversely gained quantized latent representation, which will be fed into the synthesis network.

To achieve continuous variable rate adjustment, interpolation is used between vectors. Given two pairs of gain vectors

$$\{ {m}_{t} , {m}_{{t}^{´}} \} and \{ {m}_{r} , {m}_{r}^{′} \} ,$$

the interpolated gain vector can be obtained via the following equations.

mᵥ=[(mᵣ)^{l}·(mₜ)^{i-l}]

$${m}_{v}^{′} = [ {( {m}_{r}^{′} )}^{l} \cdot {( {m}_{t}^{′} )}^{1 - l} ]$$

where l∈R is an interpolation coefficient, which controls the corresponding bit rate of the generated gain vector pair. Since 1 is a real number, an arbitrary bit rate between the given two gain vector pairs can be achieved.

### 1.3.6 the Encoding Process Using Joint Auto-Regressive Hyper Prior Model

The FIG. 4. corresponds to the state of the art compression method. In this section and the next, the encoding and decoding processes will be described separately.

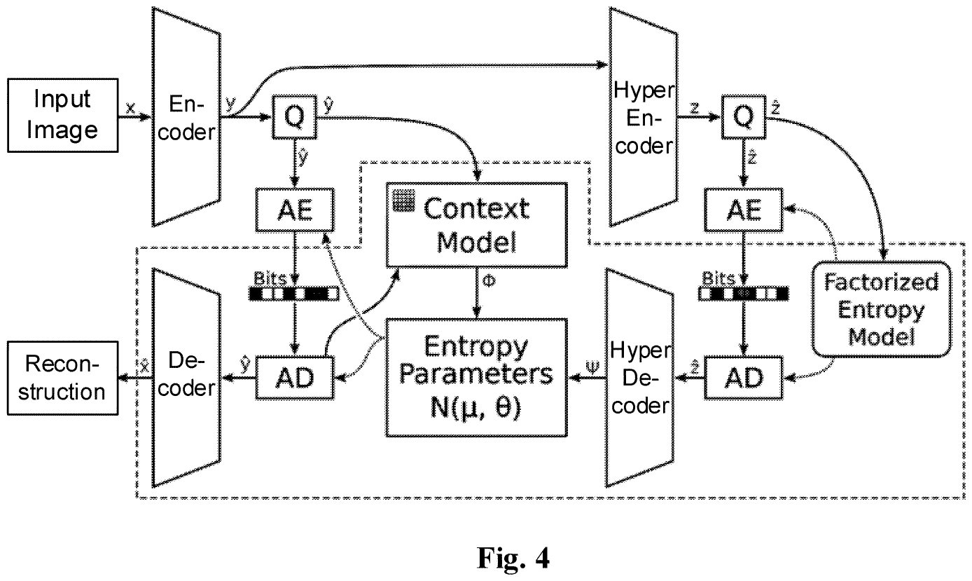

The FIG. 5 depicts the encoding process. The input image is first processed with an encoder subnetwork. The encoder transforms the input image into a transformed representation called latent, denoted by y. y is then input to a quantizer block, denoted by Q, to obtain the quantized latent (ŷ). ŷ is then converted to a bitstream (bits1) using an arithmetic encoding module (denoted AE). The arithmetic encoding block converts each sample of the ŷ into a bitstream (bits1) one by one, in a sequential order.

The modules hyper encoder, context, hyper decoder, and entropy parameters subnetworks are used to estimate the probability distributions of the samples of the quantized latent ŷ. the latent y is input to hyper encoder, which outputs the hyper latent (denoted by z). The hyper latent is then quantized (2) and a second bitstream (bits2) is generated using arithmetic encoding (AE) module. The factorized entropy module generates the probability distribution, that is used to encode the quantized hyper latent into bitstream. The quantized hyper latent includes information about the probability distribution of the quantized latent (ŷ).

The Entropy Parameters subnetwork generates the probability distribution estimations, that are used to encode the quantized latent ŷ. The information that is generated by the Entropy Parameters typically include a mean μ and scale (or variance) α parameters, that are together used to obtain a gaussian probability distribution. A gaussian distribution of a random variable x is defined as

$$f ( x ) = \frac{1}{σ \sqrt{2 π}} {e}^{- \frac{1}{2} {( \frac{x - μ}{σ} )}^{2}}$$

wherein the parameter μ is the mean or expectation of the distribution (and also its median and mode), while the parameter σ is its standard deviation (or variance, or scale). In order to define a gaussian distribution, the mean and the variance need to be determined. In an existing design, the entropy parameters module are used to estimate the mean and the variance values.

The subnetwork hyper decoder generates part of the information that is used by the entropy parameters subnetwork, the other part of the information is generated by the autoregressive module called context module. The context module generates information about the probability distribution of a sample of the quantized latent, using the samples that are already encoded by the arithmetic encoding (AE) module. The quantized latent ŷ is typically a matrix composed of many samples. The samples can be indicated using indices, such as ŷ[i,j,k] or ŷ[i,j] depending on the dimensions of the matrix ŷ. The samples ŷ[i,j] are encoded by AE one by one, typically using a raster scan order. In a raster scan order the rows of a matrix are processed from top to bottom, wherein the samples in a row are processed from left to right. In such a scenario (wherein the raster scan order is used by the AE to encode the samples into bitstream), the context module generates the information pertaining to a sample ŷ[i,j], using the samples encoded before, in raster scan order. The information generated by the context module and the hyper decoder are combined by the entropy parameters module to generate the probability distributions that are used to encode the quantized latent ŷ into bitstream (bits1).

Finally the first and the second bitstream are transmitted to the decoder as result of the encoding process.

It is noted that the other names can be used for the modules described above.

In the above description, the all of the elements in FIG. 5 are collectively called encoder. The analysis transform that converts the input image into latent representation is also called an encoder (or auto-encoder).

### 1.3.7 the Decoding Process Using Joint Auto-Regressive Hyper Prior Model

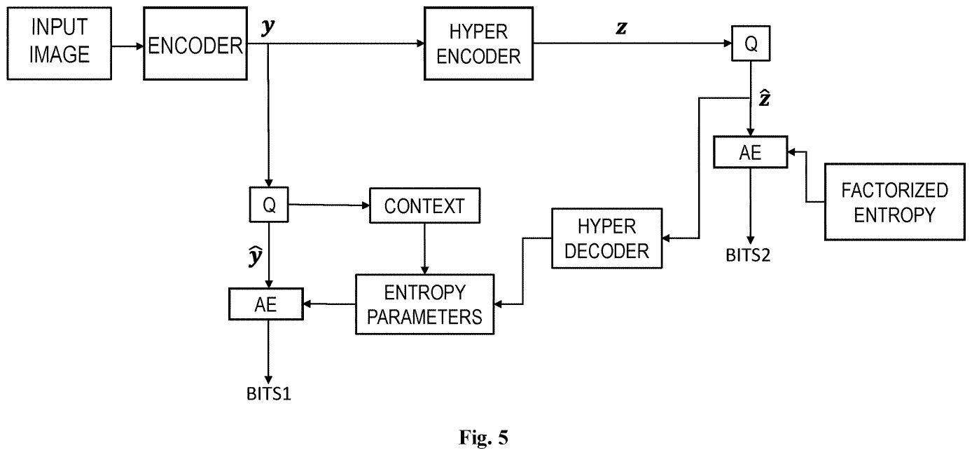

The FIG. 6 depicts the decoding process separately.

In the decoding process, the decoder first receives the first bitstream (bits1) and the second bitstream (bits2) that are generated by a corresponding encoder. The bits2 is first decoded by the arithmetic decoding (AD) module by utilizing the probability distributions generated by the factorized entropy subnetwork. The factorized entropy module typically generates the probability distributions using a predetermined template, for example using predetermined mean and variance values in the case of gaussian distribution. The output of the arithmetic decoding process of the bits2 is \hat{z}, which is the quantized hyper latent. The AD process reverts to AE process that was applied in the encoder. The processes of AE and AD are lossless, meaning that the quantized hyper latent \hat{z} that was generated by the encoder can be reconstructed at the decoder without any change.

After obtaining of \hat{z}, it is processed by the hyper decoder, whose output is fed to entropy parameters module. The three subnetworks, context, hyper decoder and entropy parameters that are employed in the decoder are identical to the ones in the encoder. Therefore the exact same probability distributions can be obtained in the decoder (as in encoder), which is essential for reconstructing the quantized latent ŷ without any loss. As a result the identical version of the quantized latent ŷ that was obtained in the encoder can be obtained in the decoder. After the probability distributions (e.g. the mean and variance parameters) are obtained by the entropy parameters subnetwork, the arithmetic decoding module decodes the samples of the quantized latent one by one from the bitstream bits1. From a practical standpoint, autoregressive model (the context model) is inherently serial, and therefore cannot be sped up using techniques such as parallelization.

Finally the fully reconstructed quantized latent ŷ is input to the synthesis transform (denoted as decoder in FIG. 6) module to obtain the reconstructed image.

In the above description, the all of the elements in FIG. 6 are collectively called decoder. The synthesis transform that converts the quantized latent into reconstructed image is also called a decoder (or auto-decoder).

### 1.4 Neural Networks for Video Compression

Similar to conventional video coding technologies, neural image compression serves as the foundation of intra compression in neural network-based video compression, thus development of neural network-based video compression technology comes later than neural network-based image compression but needs far more efforts to solve the challenges due to its complexity. Starting from 2017, a few researchers have been working on neural network-based video compression schemes. Compared with image compression, video compression needs efficient methods to remove inter-picture redundancy. Inter-picture prediction is then a crucial step in these works. Motion estimation and compensation is widely adopted but is not implemented by trained neural networks until recently.

Studies on neural network-based video compression can be divided into two categories according to the targeted scenarios: random access and the low-latency. In random access case, it requires the decoding can be started from any point of the sequence, typically divides the entire sequence into multiple individual segments and each segment can be decoded independently. In low-latency case, it aims at reducing decoding time thereby usually merely temporally previous frames can be used as reference frames to decode subsequent frames.

### 1.5 Preliminaries

Almost all the natural image/video is in digital format. A grayscale digital image can be represented by x∈ [symbol] ^{m×n}, where [symbol] is the set of values of a pixel, m is the image height and n is the image width. For example, [symbol] ={0, 1, 2, . . . , 255} is a common setting and in this case | [symbol] |=256=28, thus the pixel can be represented by an 8-bit integer. An uncompressed grayscale digital image has 8 bits-per-pixel (bpp), while compressed bits are definitely less.

A color image is typically represented in multiple channels to record the color information. For example, in the RGB color space an image can be denoted by x∈ [symbol] ^{m×n×3} with three separate channels storing Red, Green and Blue information. Similar to the 8-bit grayscale image, an uncompressed 8-bit RGB image has 24 bpp. Digital images/videos can be represented in different color spaces. The neural network-based video compression schemes are mostly developed in RGB color space while the traditional codecs typically use YUV color space to represent the video sequences. In YUV color space, an image is decomposed into three channels, namely Y, Cb and Cr, where Y is the luminance component and Cb/Cr are the chroma components. The benefits come from that Cb and Cr are typically down sampled to achieve pre-compression since human vision system is less sensitive to chroma components.

A color video sequence is composed of multiple color images, called frames, to record scenes at different timestamps. For example, in the RGB color space, a color video can be denoted by X={x₀, x₁, . . . , xₜ, . . . , x_{T-1}} where T is the number of frames in this video sequence, x∈ [symbol] ^{m×n}. If m=1080, n=1920, | [symbol] |=28, and the video has 50 frames-per-second (fps), then the data rate of this uncompressed video is 1920×1080×8×3×50=2,488,320,000 bits-per-second (bps), about 2.32 Gbps, which needs a lot storage thereby definitely needs to be compressed before transmission over the internet.

Usually the lossless methods can achieve compression ratio of about 1.5 to 3 for natural images, which is clearly below requirement. Therefore, lossy compression is developed to achieve further compression ratio, but at the cost of incurred distortion. The distortion can be measured by calculating the average squared difference between the original image and the reconstructed image, i.e., mean-squared-error (MSE). For a grayscale image, MSE can be calculated with the following equation.

$$MSE = \frac{{‖ x - \hat{x} ‖}^{2}}{m \times n} \qquad ( 4 )$$

Accordingly, the quality of the reconstructed image compared with the original image can be measured by peak signal-to-noise ratio (PSNR):

$$PSNR = 10 \times {log}_{10} \frac{{( max ( 𝔻 ) )}^{2}}{MSE} \qquad ( 5 )$$

where max( [symbol] ) is the maximal value in [symbol] , e.g., 255 for 8-bit grayscale images. There are other quality evaluation metrics such as structural similarity (SSIM) and multi-scale SSIM (MS-SSIM).

To compare different lossless compression schemes, it is sufficient to compare either the compression ratio given the resulting rate or vice versa. However, to compare different lossy compression methods, it has to take into account both the rate and reconstructed quality. For example, to calculate the relative rates at several different quality levels, and then to average the rates, is a commonly adopted method; the average relative rate is known as Bjontegaard's delta-rate (BD-rate). There are other important aspects to evaluate image/video coding schemes, including encoding/decoding complexity, scalability, robustness, and so on.

### 1.6 Separate Processing of Luma and Chroma Components of an Image

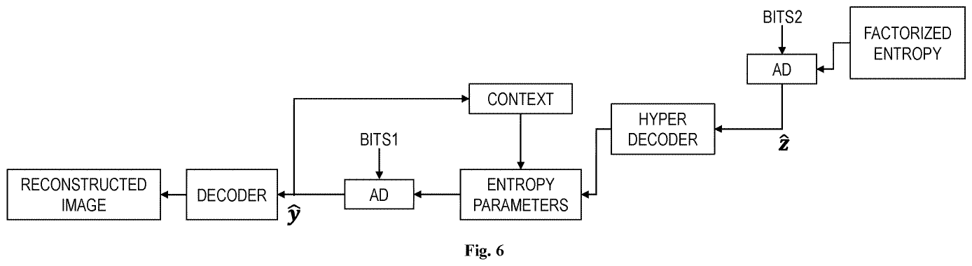

FIG. 7 illustrates the decoding process according to some example embodiments of the present disclosure. According to one implementation, the luma and chroma components of an image can be decoded using separate subnetworks. In FIG. 7, the luma component of the image is processed by the subnetwoks “Synthesis”, “Prediction fusion”, “Mask Conv”, “Hyper Decoder”, “Hyper scale decoder” etc. Whereas the chroma components are processed by the subnetworks: “Synthesis UV”, “Prediction fusion UV”, “Mask Conv UV”, “Hyper Decoder UV”, “Hyper scale decoder UV” etc.

A benefit of the above separate processing is that the computational complexity of the processing of an image is reduced by application of separate processing. Typically in neural network based image and video decoding, the computational complexity is proportional to the square of the number of feature maps. If the number of total feature maps is equal to 192 for example, computational complexity will be proportional to 192×192. On the other hand if the feature maps are divided into 128 for luma and 64 for chroma (in the case of separate processing), the computational complexity is proportional to 128×128+64×64, which corresponds to a reduction in complexity by 45%. Typically the separate processing of luma and chroma components of an image does not result in a prohibitive reduction in performance, as the correlation between the luma and chroma components are typically very small.

The processing (Decoding process) in FIG. 7 can be explained below:
1. Firstly, the factorized entropy model is used to decode the quantized latents for luma and chroma, i.e., \hat{z} and \hat{z}ᵤᵥ in FIG. 7.
2. The probability parameters (e.g. variance) generated by the second network are used to generate a quantized residual latent by performing the arithmetic decoding process.
3. The quantized residual latent is inversely gained with the inverse gain unit (iGain) as shown in orange color in FIG. 7. The outputs of the inverse gain units are denoted as ŵ and ŵᵤᵥ for luma and chroma components, respectively.
4. For the luma component, the following steps are performed in a loop until all elements of ŷ are obtained:
   a. A first subnetwork is used to estimate a mean value parameter of a quantized latent (ŷ), using the already obtained samples of ŷ.
   b. The quantized residual latent ŵ and the mean value are used to obtain the next element of ŷ.
5. After all of the samples of ŷ are obtained, a synthesis transform can be applied to obtain the reconstructed image.
6. For chroma component, step 4 and 5 are the same but with a separate set of networks.
7. The decoded luma component is used as additional information to obtain the chroma component.

Specifically, the Inter Channel Correlation Information filter sub-network (ICCI) is used for chroma component restoration. The luma is fed into the ICCI sub-network as additional information to assist the chroma component decoding.
8. Adaptive color transform (ACT) is performed after the luma and chroma components are reconstructed. The module named ICCI is a neural-network based postprocessing module. The example embodiments of the present disclosure are not limited to the UCCI subnetwork, any other neural network based postprocessing module might also be used.

An exemplary implementation of some example embodiments of the present disclosure is depicted in FIG. 7 (the decoding process). The framework comprises two branches for luma and chroma components respectively. In each of the branch, the first subnetwork comprises the context, prediction and optionally the hyper decoder modules. The second network comprises the hyper scale decoder module. The quantized hyper latent are 2 and \hat{z}ᵤᵥ. The arithmetic decoding process generates the quantized residual latents, which are further fed into the iGain units to obtain the gained quantized residual latents ŵ and ŵᵤᵥ.

After the residual latent is obtained, a recursive prediction operation is performed to obtain the latent ŷ and ŷᵤᵥ. The following steps describe how to obtain the samples of latent ŷ[:, i, j], and the chroma component is processed in the same way but with different networks.
1. An autoregressive context module is used to generate first input of a prediction module using the samples ŷ[:, m, n] where the (m, n) pair are the indices of the samples of the latent that are already obtained.
2. Optionally the second input of the prediction module is obtained by using a hyper decoder and a quantized hyper latent [symbol] .
3. Using the first input and the second input, the prediction module generates the mean value mean[:, i,j].
4. The mean value mean[:, i, j] and the quantized residual latent ŵ[:, i,j] are added together to obtain the latent ŷ[:, i, j].
5. The steps 1-4 are repeated for the next sample.

Whether to and/or how to apply at least one method disclosed in the document may be signaled from the encoder to the decoder, e.g. in the bitstream.

Alternatively, whether to and/or how to apply at least one method disclosed in the document may be determined by the decoder based on coding information, such as dimensions, color format, etc.

Alternative or additionally, the modules named MS1, MS2 or MS3+O (in FIG. 7), might be included in the processing flow. The said modules might perform an operation to their input by multiplying the input with a scalar or adding an adding an additive component to the input to obtain the output. The scalar or the additive component that are used by the said modules might be indicated in a bitstream.

The module named RD or the module named AD in FIG. 7 might be an entropy decoding module. It might be a range decoder or an arithmetic decoder or the like.

The example embodiments of the present disclosure described herein are not limited to the specific combination of the units exemplified in FIG. 7. Some of the modules might be missing and some of the modules might be displaced in processing order. Also additional modules might be included. For example:
1. The ICCI module might be removed. In that case the output of the Synthesis module and the Synthesis UV module might be combined by means of another module, that might be based on neural networks.
2. One or more of the modules named MS1, MS2 or MS3+O might be removed. The core of the proposed solution is not affected by the removing of one or more of the said scaling and adding modules.

In FIG. 7, other operations that are performed during the processing of the luma and chroma components are also indicated using the star symbol. These processes are denoted as MS1, MS2, MS3+O. These processing might be, but not limited to, adaptive quantization, latent sample scaling, and latent sample offsetting operations. For example, in an adaptive quantization process might correspond to scaling of a sample with multiplier before the prediction process, wherein the multiplier is predefined or whose value is indicated in the bitstream. The latent scaling process might correspond to the process where a sample is scaled with a multiplier after the prediction process, wherein the value of the multiplier is either predefined or indicated in the bitstream. The offsetting operation might correspond to adding an additive element to the sample, again wherein the value of the additive element might be indicated in the bitstream or inferred or predetermined.

Another operation might be tiling operation, wherein samples are first tiled (grouped) into overlapping or non-overlapping regions, wherein each region is processed independently. For example the samples corresponding to the luma component might be divided into tiles with a tile height of 20 samples, whereas the chroma components might be divided into tiles with a tile height of 10 samples for processing.

Another operation might be application of wavefront parallel processing. In wavefront parallel processing, a number of samples might be processed in parallel, and the amount of samples that can be processed in parallel might be indicated by a control parameter. The said control parameter might be indicated in the bitstream, be inferred, or can be predetermined. In the case of separate luma and chroma processing, the number of samples that can be processed in parallel might be different, hence different indicators can be signalled in the bitstream to control the operation of luma and chrome processing separately.

### 1.7 Colors Separation and Conditional Coding

In one example the primary and secondary color components of an image are coded separately, using networks with similar architecture, but different number of channels as shown in 8. All boxes with same names are sub-networks with the similar architecture, only input-output tensor size and number of channels are different.

Number of channels for primary component is Cₚ=128, for secondary components is Cₛ=64. The vertical arrows (with arrowhead pointing downwards) indicate data flow related to secondary color components coding. Vertical arrows show data exchange between primary and secondary components pipelines.

The input signal to be encoded is notated as x, latent space tensor in bottleneck of variational auto-encoder is y. Subscript “Y” indicates primary component, subscript “UV” is used for concatenated secondary components, there are chroma components.

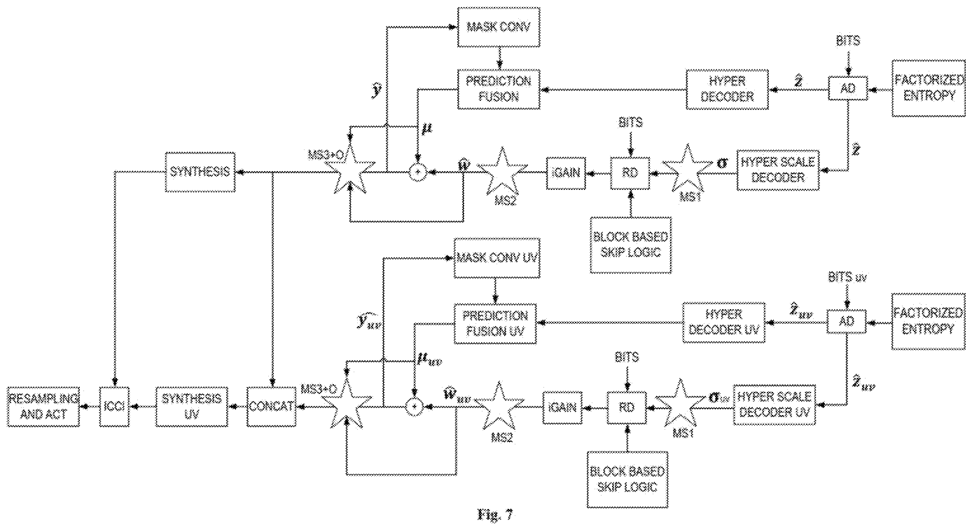

FIG. 8 illustrates learning-based image codec architecture.

First the input image that has RGB color format is converted to primary (Y) and secondary components (UV). The primary component x_{Y} is coded independently from secondary components x_{UV} and the coded picture size is equal to input/decoded picture size. The secondary components are coded conditionally, using x_{Y} as auxiliary information from primary component for encoding x_{UV} and using ŷ_{Y} as a latent tensor with auxiliary information from primary component for decoding ŷ_{UV} reconstruction. The codec structure for primary component and secondary components are almost identical except the number of channels, size of the channels and the several entropy models for transforming latent tensor to bitstream, therefore primary and secondary latent tensor will generate two different bitstream based on two different entropy models. Prior to the encoding x_{Y}, x_{UV} goes through a module which adjusts the sample location by down-sampling (marked as “s↓” on FIG. 1), this essentially means that coded picture size for secondary component is different from the coded picture size for primary component. The scaling factor s is variable, but the default scaling factor is s=2. The size of auxiliary input tensor in conditional coding is adjusted in order the encoder receives primary and secondary components tensor with the same picture size. After reconstruction, the secondary component is rescaled to the original picture size with a neural-network based upsampling filter module (“NN-color filter sT” on FIG. 1), which outputs secondary components up-sampled with factor s.

The example in FIG. 8 exemplifies an image coding system, where the input image is first transformed into primary (Y) and secondary components (UV). The outputs \hat{x}_{Y}, \hat{x}_{UV} are the reconstructed outputs corresponding to the primary and secondary components. At the and of the processing, x_{Y}, x_{U}v are converted back to RGB color format. Typically the x_{U}v is downsampled (resized) before processing with the encoding and decoding modules (neural networks). For example the size of the x_{U}v might be reduced by a factor of 50% in each of the vertical and horizontal dimensions. Therefore the processing of the secondary component includes approximately 50%×50%=25% less samples, therefore it is computationally less complex.

### 1.8 Cropping Operation in Neural Network Based Coding

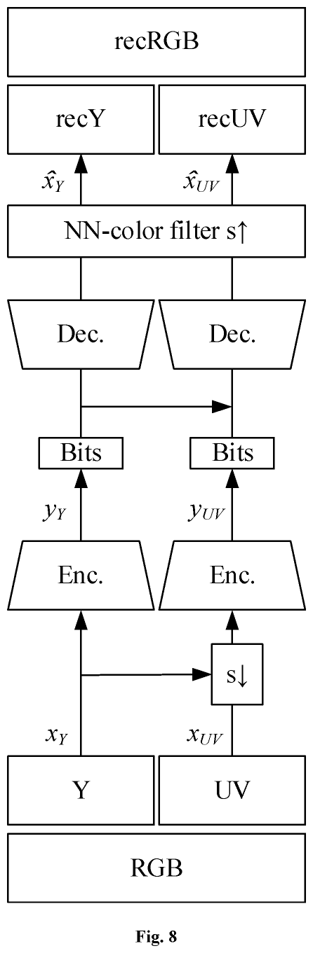

FIG. 9 illustrates synthesis transform example for learning based image coding. The example synthesis transform above includes a sequence of 4 convolutions with up-sampling with stride of 2. The synthesis transform sub-Net is depicted on FIG. 9. The size of the tensor in different parts of synthesis transform before cropping layer is the diagram on FIG. 9.

The cropping layer changes tensor size h_{d}×w_{d} to h_{d-1}×w_{d-1}, where h_{d}=2·ceil(H/2^{d}); w_{d}=2·ceil(W/2^{d}); here d is the depth of proceeding convolution in the codec architecture. For primary component Synthesis Transform receives input tensor with size h×w; h=ceil(H/16); w=ceil(W/16). The output of Synthesis Transform for primary component is 1×h₀×w₀, where h₀=H; h₀=W.

For secondary component Synthesis Transform receives input tensor with size h_{UV}×w_{UV}; h_{UV}=ceil(ceil(H/s)/16); w_{UV}=ceil(ceil(W/s)/16). The output of the Synthesis Transform for primary component is 2×h_{UV0}×w_{UV0}, where hᵤᵥ₀=ceil(H/s); h₀=ceil(W/s). For secondary components input sizes are h₀=ceil(H/s); wₒ=ceil(W/s), where s is the scale factor. The scale factor might be 2 for example, wherein the secondary component is downsampled by a factor of 2.

Based on the above explanation, the operation of the cropping layers depend on the output size H,W and the depth of the cropping layer. The depth of the left-most cropping layer in FIG. 9 is equal to 0. The output of this cropping layer must be equal to H, W (the output size), if the size of the input of this cropping layer is greater than H or W in horizontal or vertical dimension respectively, cropping needs to be performed in that dimension. The second cropping layer counting from left to right has a depth of 1. The output of the second cropping layer must be equal to h₁=2·ceil(H/2¹); w₁=2·ceil(W/2¹), which means if the input of this second cropping layer is greater than h1, w1 in any dimension, than cropping is applied in that dimension. In summary, the operation of cropping layers are controlled by the output size H,W. In one example if H and W are both equal to 16, then the cropping layers do not perform any cropping. On the other hand if H and W are both equal to 17, then all 4 cropping layers are going to perform cropping.

### 1.9 Bitwise Shifting

The bitwise shift operator can be represented using the function bitshift(x, n), where n is an integer number. If n is greater than 0, it corresponds to right-shift operator (>>), which moves the bits of of the input to the right, and the left-shift operator (<<), which moves the bits to the left. In another words the bitshift(x, n) operation corresponds to:

bitshift(x,n)=x*2ⁿ, or

bitshift(x,n)=floor(x*2ⁿ), or

bitshift(x,n)=x//2ⁿ.

The output of the bitshift operation is an integer value. In some implementations, the floor( ) function might be added to the definition.

Floor(x) is equal to the largest integer less than or equal to x.

The “//” operator or the integer division operator: It is an operation that comprises division and truncation of the result toward zero. For example, 7/4 and −7/−4 are truncated to 1 and −7/4 and 7/−4 are truncated to −1.

rightshift(x,n)=x>>n or

leftshift(x,n)=x<<n
Equation 3: alternative implementation of the bitshift operator as rightshift or leftshift.
x>>y Arithmetic right shift of a two's complement integer representation of x by y binary digits. This function is defined only for non-negative integer values of y. Bits shifted into the most significant bits (MSBs) as a result of the right shift have a value equal to the MSB of x prior to the shift operation.
x<<y Arithmetic left shift of a two's complement integer representation of x by y binary digits. This function is defined only for non-negative integer values of y. Bits shifted into the least significant bits (LSBs) as a result of the left shift have a value equal to 0.

### 1.10 Convolution Operation

The convolution is a fairly simple operation at heart: you start with a kernel, which is simply a small matrix of weights. This kernel “slides” over the input data, performing an elementwise multiplication with the part of the input it is currently on, and then summing up the results into a single output pixel. In some cases the convolution operation might comprise a “bias”, which is added to the output of the elementwise multiplication operation. The convolution operation might be described by the following mathematical formula. An output out1 can be obtained as:

$$out 1 [ x , y ] = conv 1 ( I ) = {\sum }_{k = 0}^{M} {\sum }_{i = 0}^{N} {\sum }_{j = 0}^{P} w {1}_{k} [ i , j ] \times {I}_{k} [ x + i , y + j ] + K 1$$

wherein w1 are the multiplication factors, K1 is called a bias (an additive term) and Iₖ is the k^{th} input, and N is the kernel size in one direction and P is the kernel size in another direction. The convolution layer might consist of convolution operations wherein more than one output might be generated. Other equivalent depictions of the convolution operation might be found below:

$$out 1 [ x , y ] = conv 1 ( I ) = {\sum }_{k = 0}^{M} {\sum }_{i = 0}^{N} {\sum }_{j = 0}^{P} w 1 [ k , i , j ] \times I [ k , x + i , y + j ] + K 1$$

$$out [ c , x , y ] = conv ( I ) = {\sum }_{k = 0}^{M} {\sum }_{i = 0}^{N} {\sum }_{j = 0}^{P} w [ c , k , i , j ] \times I [ k , x + i , y + j ] + K [ c ]$$

In the above equations “c” indicates the channel number. It is equivalent to output number, out[1,x,y] is one output and out[2,x,y] is a second output. Wherein the k is the input number, I[1,x,y] is one input and I[2,x,y] is a second input.

The w1, or w describe weights of the convolution operation.

### 1.11 Leaky_Relu Activation Function

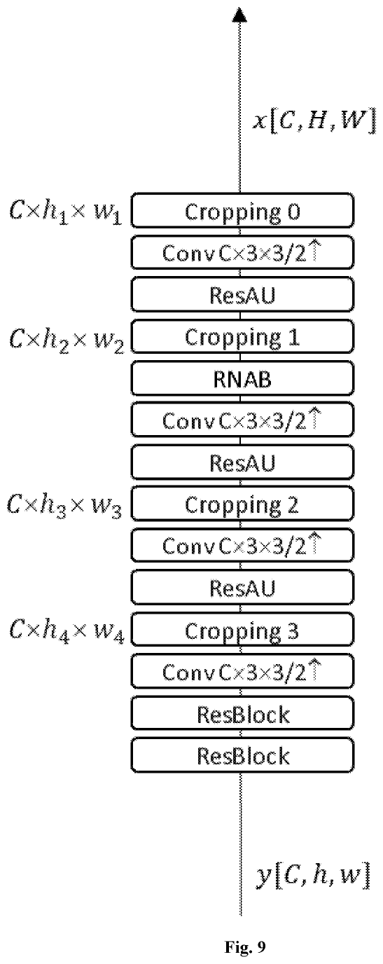

The leaky relu activation function is depicted in FIG. 10. According to the function, if the input is a positive value, the output is equal to the input. If the input (y) is a negative value, the output is equal to a*y. The a is typically (not limited to) a value that is smaller than 1 and greater than 0. Since the multiplier a is smaller than 1, it can be implemented either as a multiplication with a non-integer number, or with a division operation. The multiplier a might be called the negative slope of the leaky relu function.

### 1.12 Relu Activation Function

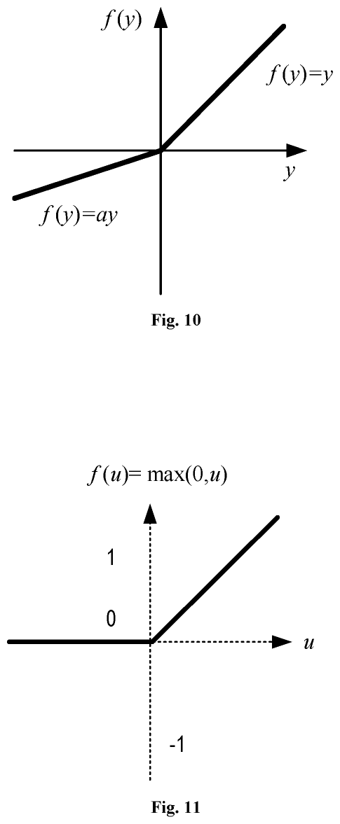

The relu activation function is depicted in FIG. 11. According to the function, if the input is a positive value, the output is equal to the input. If the input (y) is a negative value, the output is equal to 0.

### 1.13 the JPEG AI Image Coding Standard

The existing design utilizes some NN-based image coding methods described mentioned above. Some of the features are described or summarized below. The numbers in parentheses are section numbers for reference.

### 1. (3.5.20) Padding Layer

padding layer is denoted as Padd(Hᵢₙ, Wᵢₙ, d, s_{d}), where Hᵢₙ, Wᵢₙ are height and width of tensor—input to Analysis transform, s_{d} is stride of proceeding convolution, d is depth of convolution layer in deep learnable encoder. Padding layer receives tensor of size [C, h_{d-1}, w_{d-1}] and outputs tensor of size [C, s_{d}h_{d}, s_{d}w_{d}], where h_{d}=ceil(h_{d-1}/s_{d}); w_{d}=ceil(w_{d},s_{d}), h₀=Hᵢₙ, w₀=Wᵢₙ. By default padding is performed by replication. Different model of padding can be specified (for example, padding by zeros).

### 2. (3.5.22) Cropping Layer

cropping layer is denoted as Crop(Hᵢₙ, Wᵢₙ, d, s_{d}), where Hᵢₙ, Wᵢₙ are height and width of tensor—output to Synthesis transform, s_{d} is stride of proceeding transposed convolution, d is depth of convolution layer in deep learnable reconstruction process. Cropping layer outputs a tensor of size [C, h_{d-1}, w_{d-1}], where h_{d-1}, w_{d-1} defined in Table 2. Note, that h₀=Hᵢₙ, w₀=Wᵢₙ. Cropping is performed by discarding redundant elements.

TABLE 2
Tensor size parameters for primary and secondary
components decoding.

| | Primary “Y” | Secondary “UV” |
|---|---|---|
| | component | component |
| Hᵢₙ | H | ceil(H/(3 − Cᵥₑᵣ)) |
| Wᵢₙ | W | ceil(W/(3 − Cₕₒᵣ)) |
| Cᵢₙ | 1 | 2 |
| h_{d}, d = 0, . . . , 6 | ceil(Hᵢₙ/2^{d}) | ceil(Hᵢₙ/2^{(d<4)?d:d-1}) |
| W_{d}, d = 0, . . . , 6 | ceil(Wᵢₙ/2^{d}) | ceil(Wᵢₙ/2^{(d<4)?d:d-1}) |
| C | Cₚ = 160 | Cₛ = 32 |
| C₃ | 96 + 32 * opIdx | 64 |
| C₂ = C₁ | 64 + 64 * opIdx | 64 |
| C_{d} | 0 | 160 |

TABLE 3
Supported combinations of output picture format
and scaling factors

| | color | | | | |
|---|---|---|---|---|---|
| | sampling | | | | |
| output picture | mode | | | | |
| color sampling | coded | | | | |
| mode | picture | cᵥₑᵣ | cₕₒᵣ | sᵥₑᵣ | sₕₒᵣ |
| 4:4:4 | 4:4:4 | 2 | 2 | 2 | 2 |
| H_{Y} = H_{UV} = H | 4:2:2 | Not applicable | | | |
| W_{Y} = W_{UV} = W | 4:2:0 | 1 | 1 | 2 | 2 |
| 4:2:2 | 4:4:4 | Not applicable | | | |
| H_{Y} = H_{UV} = H | 4:2:2 | 2 | 1 | 2 | 1 |
| W_{Y} = W; W_{UV} = | 4:2:0 | 1 | 1 | 2 | 1 |
| W/2 | | | | | |
| 4:2:0 | 4:4:4 | Not applicable | | | |
| H_{Y} = H; H_{UV} = H/2 | 4:2:2 | Not applicable | | | |
| W_{Y} = W; W_{UV} = | 4:2:0 | 1 | 1 | 1 | 1 |
| W/2 | | | | | |

### 3. (8.4) Latent Space Tiles

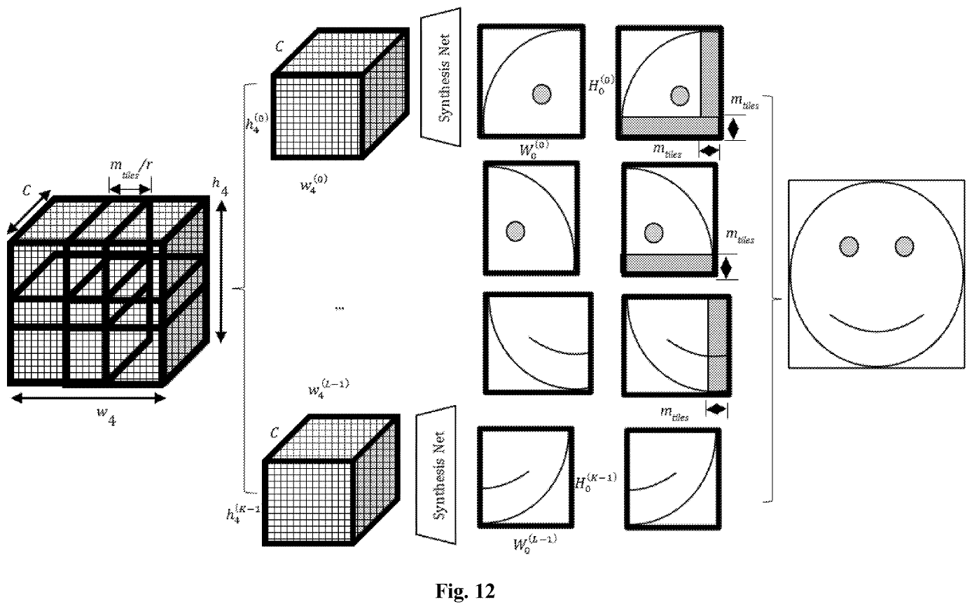

Latent space tiles decoding can be enabled for each component independently by flags signalled in picture header (section 9.3). If tile_enable_Luma or tile_enable_Choma is true then corresponding component is decoded using latent tiling process illustrated on FIG. 12.

The number and location of tiles are determined by values tile size Sₜᵢₗₑ (equal to tile_size_Luma for primary component and tile_size_Chroma for secondary component) and tile overlap mₜᵢₗₑ (tile_overlap_Luma for primary component tile_overlap_Chroma for secondary component) signalled in picture header (section 9.3). Further, the ratio r=Hᵢₙ/h₄=wᵢₙ/w₄ between signal domain size and latent tensor size is known, which is r=24 for primary and r=23 for secondary component.

The number of tiles vertically is K=ceil ((Hᵢₙ−mₜᵢₗₑ)/(Sₜᵢₗₑ−mₜᵢₗₑ)) and horizontally L=ceil((Wᵢₙ−mₜᵢₗₑ)/(Sₜᵢₗₑ−mₜᵢₗₑ)), where Hᵢₙ, Wᵢₙ are height and width of output color plane.

Hᵢₙ, Wᵢₙ are height and width of output color plane.

For k=0, . . . , K−1 and l=0, . . . , L−1
Define tiles coordinates and sizes

$$o {i}_{0}^{( k )} = k \cdot ( {S}_{tile} - {m}_{tile} ) - vertical dimension tile start in signal domain ;$$

$$o {i}_{4}^{( k )} = {i}_{0}^{( k )} / r - vertical dimension tile start in latent space ;$$

$$o {H}_{0}^{( k )} = ( ( {i}_{0}^{( k )} + {S}_{tile} ) \leq {H}_{in} ) ? {S}_{tile} : {H}_{in} - {i}_{0}^{( k )} - verticle dimension tile size in signal domain ;$$

$$o {h}_{4}^{( k )} = ceil ( {H}_{0}^{( k )} / r ) - vertical dimension tile size in latent space ;$$

$$o {j}_{0}^{( i )} = l \cdot ( {S}_{tile} - {m}_{tile} ) - horizontal dimension tile start in signal domain ;$$

$$o {j}_{4}^{( l )} = {j}_{0}^{( i )} / r - horizontal dimension tile start in latent space ;$$

$$o {W}_{0}^{( l )} = ( ( {j}_{0}^{( l )} + {S}_{tile} ) \leq {W}_{in} ) ? {S}_{tile} : {W}_{in} - {j}_{0}^{( i )} - horizontal dimension tile size in signal domain ;$$

$$o {w}_{4}^{( l )} = ceil ( {W}_{0}^{( l )} / r ) - horizontal dimension tile size in latent space .$$

tile latent space tensor

$$o For c = 0 , … , C - 1 , i = 0 , … , {h}_{4}^{( k )} - 1 and j = 0 , … , {w}_{4}^{( l )} - 1$$

$$⌊ {\hat{y}}_{k , l} [ c , i , j ] = \hat{y} [ c , {i}_{4}^{( k )} + i , {j}_{4}^{( l )} + j ]$$

$$o For c = 0 , … , {C}_{d} - 1 , i = 0 , … , {h}_{4}^{( k )} - 1 and j = 0 , … , {w}_{4}^{( l )} - 1$$

$$\vert {\tilde{y}}_{k , l} [ c , i , j ] = \tilde{y} [ c , {i}_{4}^{( k )} + i , {j}_{4}^{( l )} + j ]$$

Synthesis transform for one file
Synthesis transform described in section 8.3 with ŷ_{k,l}, \tilde{y}_{k,l} of sizes

$${h}_{4}^{( k )} and {w}_{4}^{( l )}$$

as inputs and \hat{x}_{k,l} of size

$${H}_{0}^{( k )} and {W}_{0}^{( l )}$$

as output.
Merging reconstructed parts of tensor into one

$$o {ov}_{l} = ( {j}_{0}^{( k )} == 0 ) ? 0 : {m}_{tile} / 2 - overlap used on left boundary of the tile ;$$

$$o {ov}_{t} = ( {i}_{0}^{( l )} == 0 ) ? 0 : {m}_{tile} / 2 - overlap used on top boundary of the tile ;$$

$$o {ov}_{r} = ( {j}_{0}^{( k )} + {W}_{0}^{( l )} >= {W}_{in} ) ? 0 : {m}_{tile} / 2 - overlap used on right boundary of the tile ;$$

$$o {ov}_{b} = ( {j}_{0}^{( l )} + {H}_{0}^{( k )} >= {H}_{in} ) ? 0 : {m}_{tile} / 2 - overlap used on bottom boundary of the tile ;$$

$$o {H}_{1}^{( k )} = {H}_{0}^{( k )} - {ov}_{t} - {ov}_{b} vertical dimension tile size in signal domain without tile overlap ;$$

$$o {W}_{1}^{( l )} = {W}_{0}^{( l )} - {ov}_{l} - {ov}_{r} horizontal dimension tile size in signal domain without tile overlap ;$$

$$o For c = 0 , … , {C}_{in} - 1 , i = 0 , … , {H}_{1}^{( k )} - 1 and j = 0 , … , {W}_{1}^{( l )} - 1 ,$$

$$⊏ \hat{x} [ c , {i}_{0}^{( k )} + {ov}_{t} + i , {j}_{0}^{( l )} + {ov}_{j} + j ] = {\hat{x}}_{k , l} [ c , {ov}_{t} + i , {ov}_{1} + j ] .$$

Tile size location and overlap signalling in Picture Header is described in Annex C.

### 4. (9.2) Code Stream Layout

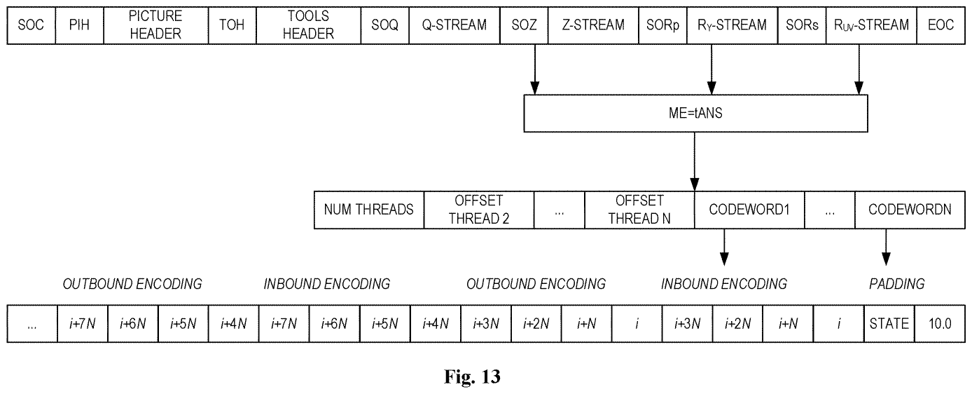

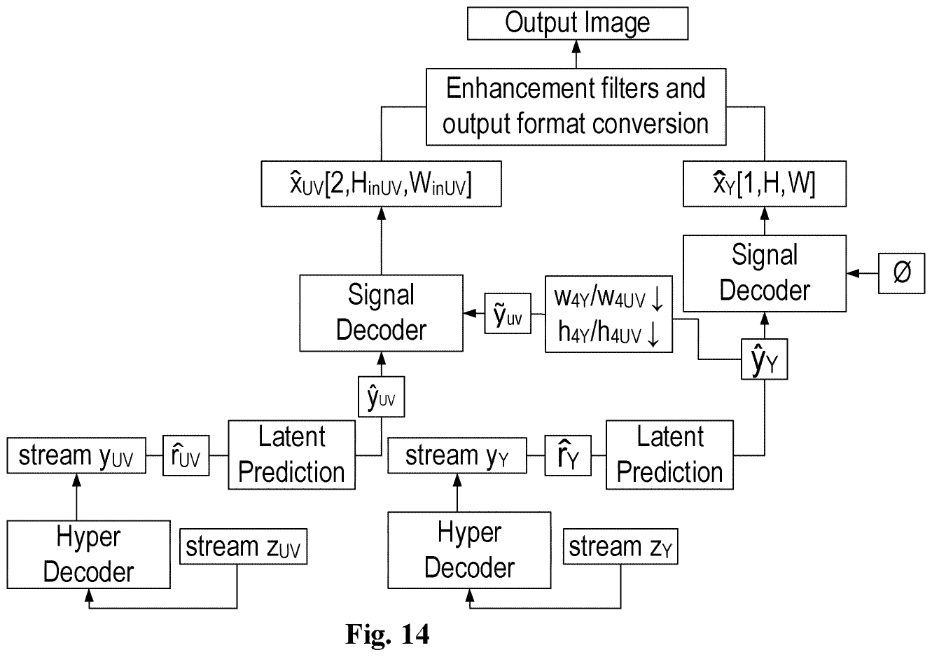

Code stream structure is depicted in FIG. 13. The code stream is composed of six parts with byte boundary, which are:
1. SOC—Start Of Codestream marker;
2. PIH (Picture Header marker) followed by picture header (section 9.3);
3. TOH (Tools Header marker) followed by tools information (section 9.3.1.1);
4. SOQ (start of Quality map marker) followed by code stream;
5. SOZ (Start of Z-stream marker) followed codestream of hyper tensor z, including \hat{z}_{Y} (“stream z_{Y}” in FIG. 14, which illustrates a general JPEG AI decoder structure) and \hat{z}_{UV} (“stream zuy” in FIG. 14);
6. SORp (Start of Residual stream for primary component marker) followed by codestream of primary component residual, which includes \hat{r}_{Y} (“stream y_{Y}” in FIG. 14);
7. SORs (Start of Residual stream for secondary component marker) followed by codestream of secondary component residual, which includes \hat{r}_{UV} (“stream y_{UV}” in FIG. 14);
8. EOC—End Of Codestream marker.

The overall syntax structure of an image is:

| | Descriptor |
|---|---|
| picture( ) { | |
| SOC | u(16) |
| picture_header( ) | |
| tools_header( ) | |
| if (gain_3D_enable_flag) | |
| q_stream( ) | |
| z_stream( ) | |
| r_primary_stream( ) | |
| r_secondary_stream( ) | |
| EOC | u(16) |

}

| Code | | | |
|---|---|---|---|
| assignment | Symbol | Description | Mandatory/Optional |
| 0xff80 | SOC | Start of codestream | Mandatory |
| 0xff81 | EOC | End of codestream | Mandatory |
| 0xff82 | PIH | Picture header | Mandatory |
| 0xff83 | TOH | Tools header | Optional |
| 0xff84 | VUI | Reserved for | Optional |
| | | rendering | |
| | | information | |
| 0xff85 | xxx | Reserved | Optional |
| 0xff86 | xxx | Reserved | Optional |
| 0xff87 | xxx | Reserved | Optional |
| 0xff88 | SOZ | Start of z | Mandatory |
| 0xff89 | SORp | Start of residual | Mandatory |
| | | (primary | |
| | | component) | |
| 0xff8a | SORs | Start of residual | Mandatory |
| | | (secondary | |
| | | component) | |
| 0xff8b | SOQ | Start of quality | Optional |
| | | map | |
| 0xff8c | xxx | Reserved | Optional |
| 0xff8d | xxx | Reserved | Optional |
| 0xff8e | xxx | Reserved | Optional |
| 0xff8f | xxx | Reserved | Optional |

5. (9.3.1) Syntax table

| | Descriptor |
|---|---|
| picture_header( ) { | |
| PIH | u(16) |
| picture_header_size | u(16) |
| img_width | u(16) |
| img_height | u(16) |
| picture_format | u(2) |
| bit_depth | u(1) |
| bit_c_ver | u(1) |
| bit_c_hor | u(1) |
| bit_s_ver | u(1) |
| bit_s_hor | u(1) |
| color_transform_header( ) | u(1) |
| model_header( ) | |
| } | |

6. (9.3.1.1) Model header

| | Descriptor |
|---|---|
| tile_header_Luma(tile_signaling_type) { | |
| tile_enable_Luma | u(1) |
| if (tile_enable_Luma) | |
| tile_size_Luma | u(13) |
| tile_overlap_Luma | u(8) |
| } | |
| tile_header_Chroma(tile_signaling_type) { | |
| tile_enable_Chroma | u(1) |
| tile_size_Chroma | u(13) |
| tile_overlap_Chroma | u(8) |
| } | |
| color_transform_header( ) { | |
| color_transform_enable | u(1) |
| if( color_transform_enable ) | |
| for ( i=0;i<3;i++ ) | |
| for ( j=0;j<3;j++ ) | |
| color_transform_matrix[i][j] | u(8) |
| for ( i=0;i<3;i++ ) | |
| color_transform_offset[i] | u(8) |
| } | |

### 7. (9.3.2) Picture Header Semantics

Following serves information is signalled:
picture_header_size is the number of bytes in the picture header excluding the first two-byte marker;
img_width plus 64 specifies width of an input picture (from 64 to 65600);
img_height plus 64 specifies height of the input picture (from 64 to 65600);
picture_format is a data format of the output picture (YUV420=0, YUV444=1, sRGB=2, YUV422=3);
bit_depth is a bit-depth the output picture (“0” corresponds to 8 and “1” corresponds to 10);
bit_c_ver is one bit value which defines c_ver=1+bit_c_ver, c_ver controls internal subsampling mode of the secondary component in vertical direction as defined in Table 3 and Table 2. If bit_c_ver is not present in bit-stream then c_ver is equal to 2.
bit_c_hor is one bit value which defines c_hor=1+bit_-c_hor, c_ver controls internal subsampling mode of the secondary component in vertical direction as defined in Table 3 and Table 2. If bit_c_hor is not present in bit-stream then c_hor is equal to 2.
bit_s_ver is one bit value which defines s_ver which is used for align coding subsampling mode of the secondary component and subsampling mode in output picture format in vertical direction as defined in Table 3. Usage of s_ver is descried in section 7.6 If bit_c_ver is not present in bit-stream then s_ver is equal to 1.
bit_s_hor is one bit value which defines c_hor=1+bit_c_hor, c_ver controls internal subsampling mode of the secondary component in vertical direction as defined in Table 3 Usage of s_ver is descried in section 7.6 If bit_c_ver is not present in bit-stream then s_hor is equal to 1.
scale_comp[2] are vertical and horizontal ratio between primary and secondary components sizes of coded picture sᵥₑᵣ=scale_comp[0] and sₕₒᵣ=scale_comp[1]; if not present (res_changer_enable=false) then sᵥₑᵣ=2 and sₕₒᵣ=2. Allowed values are listed in Table 3.
independent_beta_uv is a flag (false/true) which indicates do the rate control parameter (β) for primary and secondary components are the same.
beta_displacement_log_y—parameter indicating ratio between rate control parameter beta selected by encoder for primary component and one used in the model training.
betaDisplacementLogY=beta_displacement_log_y−2¹¹
beta_displacement_log_uv—parameter indicating ratio between rate control parameter beta selected by encoder for secondary component and one used in the model training.
betaDisplacementLogUV=beta displacement_log_uv−2¹¹
model_id is an identificator of pre-stored checkpoint with model's weights, model_id=0, 1, 2, 3 or 4.
opIdx is an identificator for operation point, 0 means “base”, 1 means “high” operation point.
tile_enable_Luma and tile_enable_Chroma are enable flags for tiling of primary and secondary components.
tile_size_Luma and tile_size_Chroma are size of tiles for primary and secondary components.
tile_overlap_Luma and tile_overlap_Luma are sizes of tiles overlapping areas for primary and secondary components.
cube_group_flag is 1-bit unsigned integer. cube_group_flag=0 indicates no cube_flag is signalled in one group, and cube flags of one group are set to be 1. cube_group_flag=1 indicates cube flags of one group are signaled. cube_luma_flag is 1D array of size ((h_{4,Y}+7)>>3)·((w_{4,Y}+7)>>3), which contains cube flags for primary component. 1 indicates Skip Mode is applied to one cube of residual tensor of primary component \hat{r}_{Y}. 0 indicates Skip Mode is disable for one cube of residual tensor of primary component \hat{r}_{Y}.
cube_chroma_flag is 1D array of size ((h_{4,UV}+7)>>3)·((w_{4,UV}+7)>>3), which contains cube flags for secondary component. 1 indicates Skip Mode is applied to one cube of residual tensor of secondary component \hat{r}_{UV}. 0 indicates Skip Mode is disable for one cube of residual tensor of secondary component \hat{r}_{UV}.
color_transform_enable is an enable flag for color convertion module.
color_transform_matrix[i][j] is a matrix of color convertion. If not present (color_transform_enable is false) then default ITU-R BT.709 colour transform is used (refer to section 7.8).
color_transform_offset[i] is an offset for color transformation If not present (color_transform_enable is false) then default ITU-R BT.709 colour transform is used (refer to section 7.8).

8. (9.5.1.1) Syntax table of hyper tensor

| | Descriptor |
|---|---|
| z_stream( ) { | |
| SOZ | u(16) |
| z_stream_size | u(24) |
| num_threads_z | u(8) |
| for (i =1; i < num_threads_z; ++i) { | |
| thread_offsets_z[i] | u(24) |
| } | |
| for (i =0; i < num_threads_z; ++i) { | |
| sub_stream[i]=sub_stream_init(i, num_threads_z, thread_offsets_z, z_stream_size) | |
| } | |
| for (ch =0; ch < z_primary_ch; ++ch) { | |
| for (i =0; i < num_threads_z; ++i) { | |
| decode_z_data(sub_stream[i], z_primary[ch][], ch, z_primary_width, z primary_height, | |
| i, num_threads_z) | |
| } | |
| } | |
| for (ch =0; ch < z_secondary_ch; ++ch) { | |
| for (i =0; i < num_threads_z; ++i) { | |
| decode_z_data(sub_stream[i], z_secondary[ch][], ch, z_secondary_width, | |
| z_secondary_height, i, num_threads_z) | |
| } | |
| } | |
| } | |

### 9. (9.5.2) Quality Map Information Decoder

The input of this process is
Codestream for quality map;
Indicators for sigma tables which are decoded in picture header:
   quality_map_entropy_indexsy for primary component.
   quality_map_entropy_index_uv for secondary component.
The output of this process is
quality_map_delta_Y is an array of size [w_{4Y}, h_{4Y}] with information used for deriving scaling factor (section 12.2) for primary component residual tensor.
quality_map_delta_UV is an array of size [w_{4UV}, h_{4UV}] with information used for deriving scaling factor (section 12.2) for secondary component residual tensor.

Here sizes [w_{4Y}, h_{4Y}] and [w_{4UV}, h_{4UV}] are defined in Table 2.
q_pnmary_sigma_Idx is a 1D array of size h_{4Y}×w_{4Y}, and each element in this array is equal to q_sigma_Idx[quality_map_entropy_index_y], where the q_sigma_Idx[k] is derived according to Table 4.
q_secondary_sigma_Idx is a 1D array of size h_{4UV}×w_{4UV}, and each element in this array is equal to q_sigma_Idx[quality_map_entropy_index_uv].
q_primary is a 1D array of size h_{4Y}×w_{4Y}, and quality_map_delta_Y is determined by:
   quality_map_delta_Y[i,j]=q_primary[i×w_{4Y}+j], for j=0 . . . w_{4Y}−1, and i=0 . . . h_{4Y}−1.

q_secondary is a 1D array of size h_{4UV}×w_{4UV}, and quality_map_delta-UV is determined by
quality_map_delta_UV[i, j]=q_secondary[i×w_{4UV}+j], for j=0 . . . w_{4UV-1}, and i=0 . . . h_{4UV-1}.

TABLE 4
Determining q_sigma_Idx for quality map delta decoding

| | k | | | | | | | |
|---|---|---|---|---|---|---|---|---|
| | 0 | 1 | 2 | 3 | 4 | 5 | 6 | 7 |
| q_sigma_Idx[k] | 0 | 4 | 5 | 6 | 8 | 10 | 14 | 18 |

10. (9.5.2.1) Syntax table of quality map information tensor

| | Descriptor |
|---|---|
| q_stream( ) { | |
| SOQ | u(16) |
| q_stream_size | u(24) |
| num_threads_q | u(8) |
| for (i =1; i < num_threads_q; ++i) { | |
| thread_offsets_q[i] | u(24) |
| } | |
| for (i =0; i < num_threads_q; ++i) { | |
| sub_stream[i]=sub_stream_init(i, num_threads_q, thread_offsets_q, q_stream_size) | |
| } | |
| for (i =0; i < num_threads_q; ++i) { | |
| decode_r_data(sub_stream[i], q_primary[], q_primary_sigma_Idx[], i, num_threads_q) | |
| } | |
| for (i =0; i < num_threads_q; ++i) { | |
| decode_r_data(sub_stream[i], q_secondary[], q_secondary_sigma_Idx[], i, | |
| num_threads_q) | |
| } | |
| } | |

### 11. (9.5.3) Primary Residual Stream Decoder

The input of this process is
Primary component residual codestream;
mask_skip[Cₚ, h_{4Y}, w_{4Y}] generated by Skip Mask generation (section 13.3.2) for primary component;
sigma_Idx_primary—tensor of size [Cₚ, h_{4Y}, W_{4Y}] which is the output of Sigma quantization (section 10.8) for primary component.
The output of this process is
r_primary—one dimensional array {s} of residual tensor elements which is an input of decoder skip process (section 13.3.4) for primary component.

Here sizes Cₚ, w_{4Y}, h_{4Y} are defined in Table 2. A one dimensional array sigma_Idx_primary_1D is determined though following steps:
Set k=0
For c=0 . . . C_{P}−1,
   For i=0 . . . h_{4Y}−1,
      For j=0 . . . w_{4Y}−1
         if mask_skip[c,i,j] is equal to True, sigma_Idx_primary_1D[k] is set to equal to sigma_Idx_primary[c,i,j] and increase k by 1.

12. (9.5.3.1) Syntax table of primary residual tensor

| | Descriptor |
|---|---|
| r_primary_stream( ) { | |
| SOR | u(16) |
| r_primary_stream_size | u(32) |
| num_threads_r_primary | u(8) |
| for (i =1; i < num_threads_r_primary; ++i) { | |
| thread_offsets_r_primary[i] | u(32) |
| } | |
| for (i=0; i < num_threads_r_primary; ++i) { | |
| sub_stream[i]=sub_stream_init(i, num_threads_r_primary, thread_offsets_r_primary, | |
| r_primary_stream_size) | |
| decode_r_data(sub_stream[i], r_primary[], sigma_Idx_primary[], i, num_threads_r_primary) | |
| } | |
| } | |

### 13. (9.5.4) Secondary Residual Stream Decoder

The input of this process is
Codestream for secondary component residual;
mask_skip[Cₛ, h_{4UV}, w_{4UV}] generated by Skip Mask generation (section 13.3.2) for secondary component;
sigma_Idx_secondary—tensor of size [Cₛ, h_{4UV}, w_{4UV}] which is the output of Sigma quantization (section 10.8) for secondary component.

The output of this process is
r_secondary—one dimensional array {s} of residual tensor elements which is an input of decoder skip process (section 13.3.4) for secondary component.

Here sizes Cₛ, h_{4V} w_{4UV} are defined in Table 2. A one dimensional array sigma_Idx_secondary_1D is determined though following steps:
Set k=0
For c=0 . . . C_{P}−1,
   For i=0 . . . h_{4Y}−1,
      For j=0 . . . w_{4Y}−1
         if mask_skip[c,i,j] is equal to True, sigma_Idx_secondary_1D[k] is set to equal to sigma_Idx_secondary[c,i,j] and increase k by 1.

14. (9.5.4.1) Syntax table of secondary residual tensor

| | Descriptor |
|---|---|
| r_secondary_stream( ) { | |
| SOR | u(16) |
| r_secondary_stream_size | u(24) |
| num_threads_r_secondary | u(8) |
| for (i =1; i < num_threads_r_secondary; ++i) { | |
| thread_offsets_r_secondary[i] | u(24) |
| } | |
| for (i=0; i < num_threads_r_secondary; ++i) { | |
| sub_stream[i]=sub_stream_init(i, num_threads_r_secondary, thread_offsets_r_secondary, | |
| r_secondary_stream_size) | |
| decode_r_data(sub_stream[i], r_secondary[], sigma_Idx_secondary[], i, | |
| num_threads_r_secondary) | |
| } | |
| } | |

### 15. (10.3) Hyper Scale Decoder

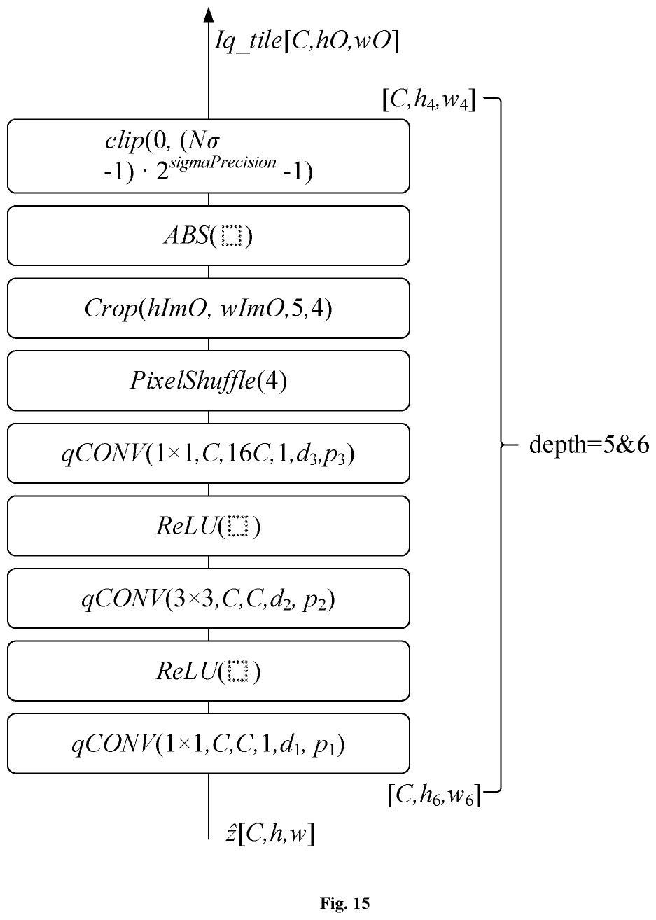

Hyper scale decoder net is depicted in FIG. 15.

The input of hyper scale decoder is
\hat{z}[C, h₆, w₆] reconstructed hyper tensor,
sizes of input/output tensor Hᵢₙ, Wᵢₙ,
operation point indicator opIdx,
model parameters for Hyper Scale Decoder Net defined by pair (modelIdx, opIdx), all multiplier parameters in those models are 8-bits integer.
The output of hyper scale decoder is standard deviation logarithm tensor I_{σ} [C,h₄,w₄] with integer values in a range 0≤I_{σ}<((N_{σ}−1)<<sigmaPrecision), where Na, sigmaPrecision are defined in section 0. Sizes of those tensors for primary and secondary components are listed in Table 2.
All operation in scalable hyper decoder are integer, an accumulator in all computations is within 32 bits integer diapason, multipliers in model parameters are quantized to 8-bits integer. This guarantees bit-exact behaviour of this neural network module. Hyper scale decoder uses special type of operations quantized convolutions. For each quantized convolution in the process the set of clipping values {dₖ} and de-scaling shifts parameters {pₖ}(1≤k≤3) are specified for each channel. All clipping values in quantized convolutions are dₖ=2′. De-scaling shifts {pₖ} are provided in section 15.6.
NOTE—the magnitude of integerized weights in quantized model doesn't exceed 27, shift and clipping value combination ensures the register of quantized convolution is within 32-bits.

The sequence of operations in this module doesn't depend on operation point indicator (opIdx), but model parameters are different for base and high operation point.

Hyper scale decoder starts with quantized convolution kernel size 1×1, stride 1, followed by rectified linear unit. Then there is a stride 1 quantized convolution with kernel size 3×3, followed by rectified linear unit. The next stride 1 quantized convolution (kernel size 1×1) increases the number of channels to 16C. It is followed by pixel shuffle (stride 4), which brings number of channels back to C. The cropping layer (stride 4, depth 5) ensures the size of output tensor is [C,h₄,w₄]. The process concluded with abs operation.

Model with weights are storied in electronic attachment, in format specified in section 4.8 and locates in <oper_point>/model_<MID>/<COMP>/hyper_scale_decoder.onnx, where <oper_point> is “base” or “high”, <MID> is an integer from 0 to 5, <COMP> is “primary” or “secondary”.

### 16. (11.2) Hyper Decoder

The learning-based hyper decoder consists of two independent pipe-lines with identical neural network architecture, except input size and number of channels.

The input of this process is
\hat{z}[C,h₆,w₆] reconstructed hyper latent tensor,
model parameters for Hyper Decoder Net defined by (modelIdx),
operation point indicator opIdx.

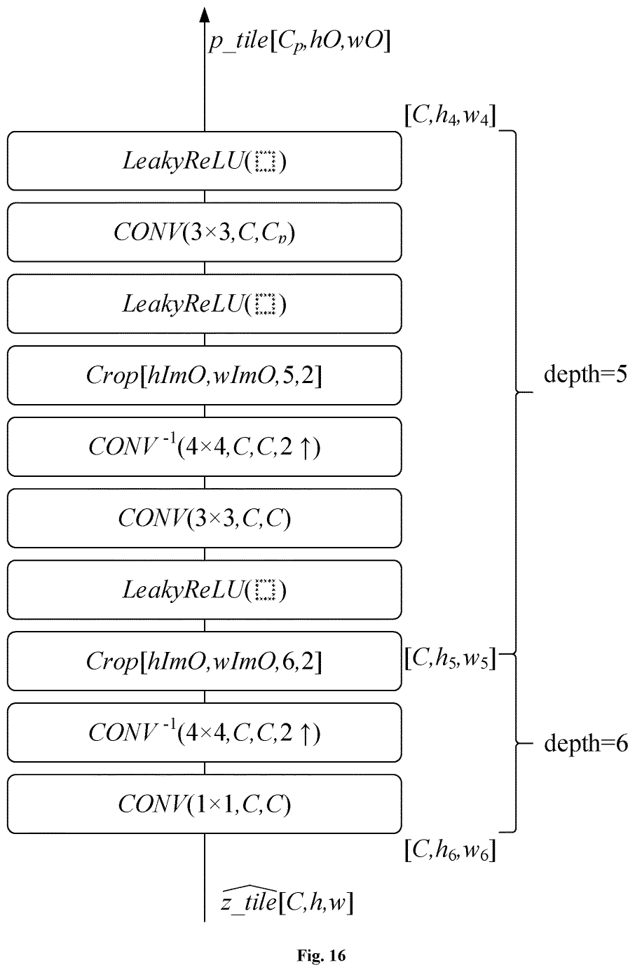

The output of this process is
p[Cₚ, h₄, w₄] is explicit prediction (part of prediction tensor derived from explicitly signalled information), with channels size Cₚ=(opIdx+1)C.
Hyper decoder process is depicted in FIG. 16.

Hyper decoder starts stride 1 convolution with kernel size 1×1, followed by inverse convolution (stride 2, kernel size 4×4), cropping layer (depth 6) and leaky rectified linear unit. Next step is stride 1 convolution with kernel size 3×3, followed by inverse convolution (stride 2, kernel size 4×4), cropping layer (depth 5) and leacky rectified linear unit. Number of channels kep un-changed till this point (equal to number of channels C of input tensor). Hyper decoder concluded by stride 1 convolution with kernel size 3×3 which increases number of channels to 2C for high operation point and keeps number fo channes unchanged for base operation point followed by leacky rectified linear unit.

Model with weights are storied in electronic attachment, in format specified in section 4.8 and locates in <oper_point>/model_<MID>/<COMP>/hyper_decoder.onnx, where <oper_point> is “base” or “high”, <MID> is an integer from 0 to 5, <COMP> is “primary” or “secondary”.

### 17. (11.3) Latent Tensor Reconstruction Process

The input of this process is
operation point indicator opIdx,
\hat{r}[C,h₄,w₄] reconstructed residual tensor, which is an out out of SKIP Model process (13.3.4),
p[Cₚ, h₄, w₄] explicit prediction, with channels size Cₚ=(opIdx+1)C, which is an output of Hyper Decoder (11.2),
The output of this process is
ŷ[C,h₄,w₄] reconstructed latent tensor.

The process is as follows.
If opIdx==0 (base operation point) then multi-stage context modelling process is by-passed,
explicit prediction is added to residual ŷ′=\hat{r}+p[0:C−1,h₄ w₄]:

If opIdx==1 (high operation point) then:
Multi-stage Context Modelling process (section 11.4) is used.

### 18. (11.4) Multistage Context Modelling

The input of this process is
\hat{r}[C,h₄,w₄] reconstructed residual tensor, which is an out out of SKIP Model process (13.3.4),
p[2C,h₄,w₄] explicit prediction, which is an output of Hyper Decoder (11.2),
Eight MCMₖ, k=0, . . . 7 models with parameters defined by (modelIdx, k),
The output of this process is
ŷ′[C,h₄,w₄] reconstructed latent tensor.

The process consists of following steps:
padding layer (depth 5, stride 2) and down-shuffle (11.5.1) M=2 of explicit prediction tensor p[2C,h₄,w₄] to \ddot{p}[8C,hₛ,w₅] re-shaped prediction tensor,
padding layer (depth 5, stride 2) and down-shuffle (11.5.1) M=1 of reconstructed residual \hat{r}[C,h₄,w₄] to \ddot{r}[4C,hₛ,w₅] re-shaped residual tensor,
split \ddot{p}[8C,h₄,w₄] into four parts \ddot{p}ₗ=\ddot{p}[2lC:2(l+1)C−1,h₅,w₅], l=0, . . . , 3 (each parts consists of 2C out of 8C channels),
split \ddot{r}[4C,h₄,w₄] into eight parts \ddot{p}ₗ=\ddot{p}[kC/2:(k+1)C/2−1,hₛ,w₅], k=0, . . . , 7 (each parts consists of C/2 out of 4C channels),
For k=0, . . . , 3
   MCM(k) process which
      takes as an input
         {ÿₘ}, m=0, . . . , k−1 previously reconstructed parts of re-shaped latent space tensor,
         \ddot{r}ₖ—collocated part of reconstructed residual tensor,
         \ddot{p}_{k%4}—part of re-shaped explicit prediction tensor,
      outputs
         produces ÿₖ=ÿ[kC/2:(k+1)C/2−1,h₅,w₅].
Channel net process (11.5.4) over ÿ[0:(2C−1,h₅,w₅] tensor.
P For k=3, . . . , 7
   MCM(k) process which
      takes as an input
         {ÿₘ}, m=0, . . . , k−1 previously reconstructed parts of re-shaped latent space tensor,
         \ddot{r}ₖ—collocated part of reconstructed residual tensor,
         \ddot{p}_{k%4}—part of re-shaped explicit prediction tensor.
      outputs
         produces ÿₖ=ÿ[kC/2:(k+1)C/2−1,hₛ,w₅].
up-shuffle (11.5.2) M=2 and cropping layer (depth 5, stride 2) ÿ[4C,hₛ,w₅] to ŷ′[C,h₄,w₄].
up-shuffle (11.5.2) M=2 and cropping layer (depth 5, stride 2) ü[4C,hₛ,w₅] to μ[C,h₄,w₄] (to be further used in LSBS process 13.4.2).

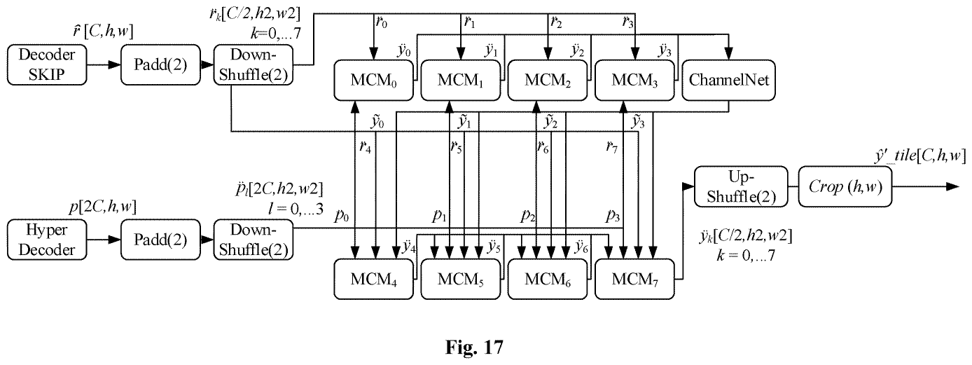

Multi-stage context modelling process is depicted in FIG. 17. This is a recurrent process: later stages uses previously obtained elements of output tensor as an input. Data flow which corresponds usage of previous stages output is marked with arrows in FIG. 17.

Models with weights are storied in electronic attachment, in format specified in section 4.8 and locates in high/model_<MID>/<COMP>/MCM/stage<N>.onnx, where <MID> is an integer from 0 to 5, <COMP> is “primary” or “secondary”, <N> is a number of MCM's stage from 0 to 7.

### 19. (13.3.4) Decoder Side SKIP Operation

At the decoder, the inputs of skip mode process are
1D array s[num_res_elements] after decoding by me-tANS (section 9.5.2) to from the “stream—y”,
mask_skip[C,h₄,w₄].

The output of this process is
the residual tensor \hat{r}[C,h₄,w₄].

The output of the lossless decoding process is a 1D array {sₖ}, whose size is equal to the total number of “1”s in the mask_skip [C,h₄,w₄] tensor.

In other words, the mask_skip [C,h₄,w₄] tensor determines which samples of the residual tensor \hat{r} are included in the bitstream. All of the other samples of the quantized residual tensor are inferred to be equal to zero.

The process of residual skip mode at the decoder is as follows:
Dimensions [C,h₄,w₄] are set equal to number of channels, height and width of the sigma tensor σ (Table 2).
Tensors \hat{r}[C,h₄,w₄] is initialized to be equal to all zeros.
The counter k=0.
The following ordered steps are applied:
For c=0 . . . C−1,
   For i=0 . . . h₄−1
      For, j=0 . . . w₄−1
         if mask_skip [c,i,j] is equal to True, \hat{r}[c,i,j]=mask_skip [c,i,j]·(s[k]−2¹⁶⁻¹+1), and increase k by 1;
         otherwise, \hat{r}[c,i,j]=0.

### 20. (14.1.1) Inter Channel Correlation Information Filter Tiling and Output Selection Process

The ICCI filter processes the input in tiles using the same method described in Section 8.4. The tile size icci_tile_size and tile overlap icci_tile_overlap are same for the primary (Luma) and secondary (Chroma) components and signalled in picture header (Section 9.3). The ratio r between input domain size and output tensor size is fixed to 1 for each component. The minimum tile size is limited to 176 for the stable computation of the model selection explained next.

In total, 10 ICCI filters are included into the design. In each tile tileID for each color component comp=0 . . . 2 (“0” “y”, “1”−“u”, “2”−“v”) the filter is selected based on icci_model_idx[comp][tileID] value which is coded in picture header (Section 9.3). In case icci_model_idx=0, the ICCI processing is bypassed.

### 21. (14.2) Adaptive Upsampler

This section details the primary component guided adaptive upsampler process. This process provides enhancement of secondary components (colour information planes) of image utilising information from primary component.

This process is enabled if EFE_upsampler_enabled_flag is true.
The input of this process is
\hat{x}_{Y}[1,H_{Y},W_{Y}](output of synthesis transfor for primary component),
\hat{x}_{UV}[2,H_{inUV}, W_{inUV}](output of synthesis transfor for secondary component),
The output of this process is
enhanced secondary component \hat{x}′_{UV}[2,H_{UV}, W_{UV}] which goes to the ICCI filter block (section 14.1) and \hat{x}″_{UV}[2,H_{UV}, W_{UV}] which goes to the non-linear filter block (section 14.3).

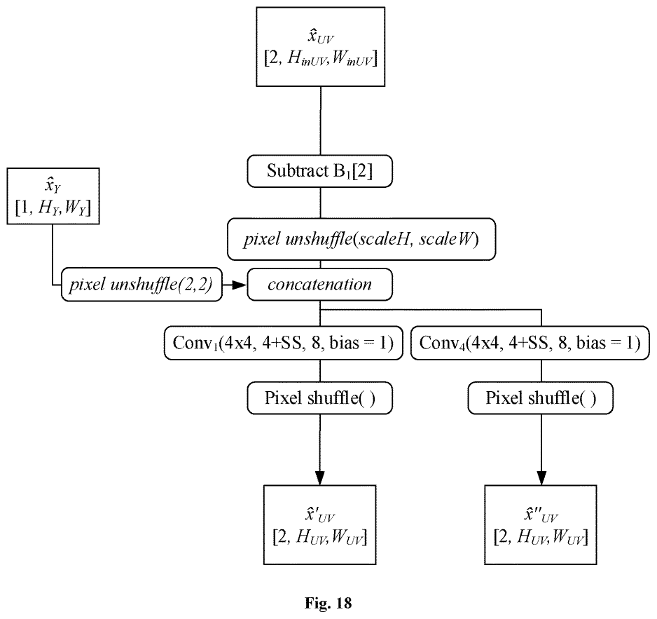

FIG. 18 illustrates an example implementation of primary component guided adaptive up-sampling filter.

If EFE_upsampler_enabled_flag is equal to 0, the \hat{x}′_{UV}[2,H,W] is up-sampled by bi-cubic interpolation as described in section 7.6. Otherwise the following ordered steps are performed:
The parsing process according to parsing table in Section 9.4.1 is invoked to obtain W_{1A}, W_{1B}, W_{4A}, W_{4B} and B₁.
Tiling process is as described in section 14.2.2 is invoked with parsed syntax elements as inputs and Tile1 tensor as output.
Parameter update process as specified in section Section 14.2.1. is invoked with W_{4A} and W_{1A} as inputs and modified W_{4A} and W_{1A} as outputs.
B₁[2] is vector is subtracted channelwise from \hat{x}′_{UV}[2,H_{inUV},W_{inUV}].

$$- U [ 2 \cdot {scale}_{ver} \cdot {scale}_{hor} , \frac{H + 1}{2} , \frac{W + 1}{2} ] and$$

$$Y [ 4 , \frac{H + 1}{2} , \frac{W + 1}{2} ]$$

are set equal to pixelUnshuffle(\hat{x}′_{UV},scaleᵥₑᵣ, scaleₕₒᵣ) and pixelUnshuffle(\hat{x}′_{Y},2,2) respectively.
For x=0 . . . (W+1)/2−1, y=0 . . . (H+1)/2−1, k=0 . . . 1,i=0 . . . oᵥₑᵣ−1, j=0 . . . oₕₒᵣ−1 the following is performed:
   ch=4k+2i+j
   chₒᵤₜ=k·oᵥₑᵣ·oₕₒᵣ+oₕₒᵣ·i+j
   chᵢₙ=k·scaleᵥₑᵣ·scaleₕₒᵣ+scaleₕₒᵣ(i % scaleᵥₑᵣ)+(j % scaleₕₒᵣ)
   t_{idx}=Tile1[k,y,x]
   U′[chₒᵤₜ,y,x]=U[chᵢₙ,y,x]*W_{4A}[t_{idx},ch]+Y[2i+j,y,x]*W_{4B}[t_{idx},k]+B₁[k]
   U′[chₒᵤₜ,y,x]=U[chᵢₙ,y,x]*W_{1A}[0,ch]+Y[2i+j,y,x]*W_{1B}[0,k]+B₁[k]
\hat{x}′_{UV}[2,H_{UV},W_{UV}] and \hat{x}″_{UV}[2,H_{UV},W_{UV}] are set equal to pixelshuffle(U′, oᵥₑᵣ, oₕₒᵣ) and pixelshuffle(U″, oᵥₑᵣ, oₕₒᵣ) respectively.

### 22. (14.4.1) LEF General Process

LEF process receives primary variance tensor \hat{σ}_{Y}[Cₚ,h_{4,Y},w_{4,Y}] and reconstructed primary \hat{x}′_{Y}[1,H,W] as inputs. The output of LEF process is edge enhanced modified \hat{x}′_{Y}[1,H,W].

The following ordered steps are performed:
Picture header parsing process is invoked as described in section Section 9.3. to obtain targetBppIdx,
chIdx is set equal to reference_channel_idx_table[tagetBppIdx],
The \hat{σ}[1,H_{Y},W_{Y}] tensor is obtained as follows, for i=0 . . . H_{Y}−1, j=0 . . . W_{Y}−1,
\hat{σ}[0,i,j]=\hat{σ}_{Y}[chIdx,floor(i·h_{4,Y}÷H_{Y}),floor(i·w_{4,Y}+W_{Y})],
thr[3]=luma_edge_filter_thr_list_table[targetBppIdx],
intensity[4]=luma_edge_filter_intensity_list[targetBppIdx],
\hat{x}′_{Y}=\hat{x}′_{Y}+255,
\hat{x}_{blur}=\hat{x}′_{Y}*kernel,
\hat{x}_{edge}=\hat{x}′_{Y}−\hat{x}_{blur},

$${\hat{σ}}_{Y \_ channel}^{1} [ 1 , {H}_{Y} , {W}_{Y} ] = {\hat{σ}}_{Y \_ channel}^{1} [ 1 , {H}_{Y} , {W}_{Y} ] \div 8190 ,$$

$$⌊ For i = 0 … {H}_{Y} - 1 , j = 0 … {W}_{Y} - 1 ;$$

$${–}^{–} tIdx = \{ \begin{matrix}0 , & {\hat{σ}}_{Y \_ channel}^{1} [ 0 , i , j ] < thr [ 0 ] \\ 1 , & thr [ 0 ] \leq {\hat{σ}}_{Y \_ channel}^{1} [ 0 , i , j ] < thr [ 1 ] \\ 2 , & thr [ 1 ] \leq {\hat{σ}}_{Y \_ channel}^{1} [ 0 , i , j ] < thr [ 2 ] \\ 3 , & thr [ 2 ] \leq {\hat{σ}}_{Y \_ channel}^{1} [ 0 , i , j ]\end{matrix}$$

Ŷ[i,j]=\hat{x}_{edge}[0,i,j]*intensity[tIdx]+\hat{x}_{blur}[0,i,j],
Ŷ is modified as follows, for i=0 . . . H_{Y}−1, j=0 . . . W_{Y}−1:
   Ŷ[i,j]=clip(0,1,Ŷ[i,j])·255.
In this process zero padding is used when the indices of a tensor exceeds the tensor boundaries.
The weights tensor kernel is defined as follows:

$$kernel = [ \begin{matrix}1 \div 13 & 1 \div 13 & 1 \div 13 \\ 1 \div 13 & 5 \div 13 & 1 \div 13 \\ 1 \div 13 & 1 \div 13 & 1 \div 13\end{matrix} ]$$

The reference_channel_idx_table is defined as follows:
   reference_channel_idx_table=[23, 23, 65, 65, 65]
The luma_edge_filter_intensity_list is as follows:

| luma_edge_filter_intensity_ | | | | |
|---|---|---|---|---|
| list [X][Y] | Y = 0 | Y = 1 | Y = 2 | Y = 3 |
| X = 0 | 1.00 | 1.10 | 1.25 | 1.40 |
| X = 1 | 1.00 | 1.08 | 1.12 | 1.16 |
| X = 2 | 1.00 | 1.05 | 1.06 | 1.07 |
| X = 3 | 1.00 | 1.02 | 1.03 | 1.04 |
| X = 4 | 1.00 | 1.01 | 1.02 | 1.03 |

The luma_edge_filter_thr_list_table is defined as follows:

| luma_edge_filter_thr_list_ | | | |
|---|---|---|---|
| table [X][Y] | Y = 0 | Y = 1 | Y = 2 |
| X = 0 | 0.3 | 2.0 | 6.0 |
| X = 1 | 0.4 | 3.0 | 7.0 |
| X = 2 | 0.5 | 6.0 | 10.0 |
| X = 3 | 0.6 | 7.0 | 12.0 |
| X = 4 | 0.7 | 8.0 | 14.0 |

### 3. Problems

The existing design has the following problems:
1) Per the current codestream structure, in an JPEG AI codestream containing a coded picture, a type-based bits organization solution is used. That is, all coded bits of the hyper tensor (denoted as 1^{st} bit type) for the entire picture precede all coded bits of the primary component residual (denoted as 2^{nd} bit type) for the entire picture, and all coded bits of the primary component residual for the entire picture precede all coded bits of the second component residual (denoted as 3^{rd} bit type) for the entire picture. Therefore, even when the picture is split into multiple regions by having num_threads_z, num_threads_r_primary, and num_threads_r_secondary greater than 1, in order to decode only one region, the decoder still needs to parse and/or decode the different types of coded bits of all previous regions in raster-scan order. Furthermore, due to that there is no JPEG marker between the coded bits of different regions, it is not easy for the systems layer to encapsulate the coded bits of different regions into different data structures or data units for region-based transmission and/or processing. An example of such systems-layer data structure or data unit is a file format sub-sample. Another example is a file format sample in a track or item carrying only a subset of the regions. Yet another example is a real-time transport protocol (RTP) packet.
2) Currently it is possible for num_threads_z, num_threads_r_primary, and num_threads_r_secondary to have different values, which seems not working at all.
3) Currently, it is possible to partition a picture into multiple horizontally-split regions by having num_threads_z, num_threads_r_primary, and num_threads_r_secondary greater than 1. However, it is not possible to partition a picture into multiple vertically-split regions or into multiple horizontally-and-vertically-split regions.
   A use case for partitioning a picture into multiple vertically-split regions is a single-picture to cover a multi-page document, which is often used nowadays in document sharing in social media, wherein the picture has a normal height but a very large value of width, and in this case, the picture is rendered piece by piece, each piece corresponding to one page of the original multi-page document, and the user turns pages back and forth by sliding on the screen to the right and to the left, respectively.
   A use case for partitioning a picture into multiple vertically-split regions or into multiple horizontally-and-vertically-split regions is virtual reality or 360 degree image, wherein it is ideal for the client to be able to only receive and decode the minimum set of regions that fully covers the current field of view of the user. Similarly, this capability can also be used for traditional region of interest (ROI) coding, which enables the client to be able to only receive and decode the minimum set of regions that fully covers the ROI of the user.
4) Currently, it is possible to partition a picture into multiple regions, and at the same time enable the correct decoding of a subset of each region independently from other regions by having tiles being subsets of regions and alignment of tiling between luma and chroma. However, there lacks a high-level indication of this regional access capability, e.g., in the picture header.
5) Currently, it is possible to partition a picture into multiple regions, and at the same time enable the correct decoding of a subset of each region independently from other regions. However, it is not possible to enable correct decoding of the entire regions.

### 4. Detailed Solutions

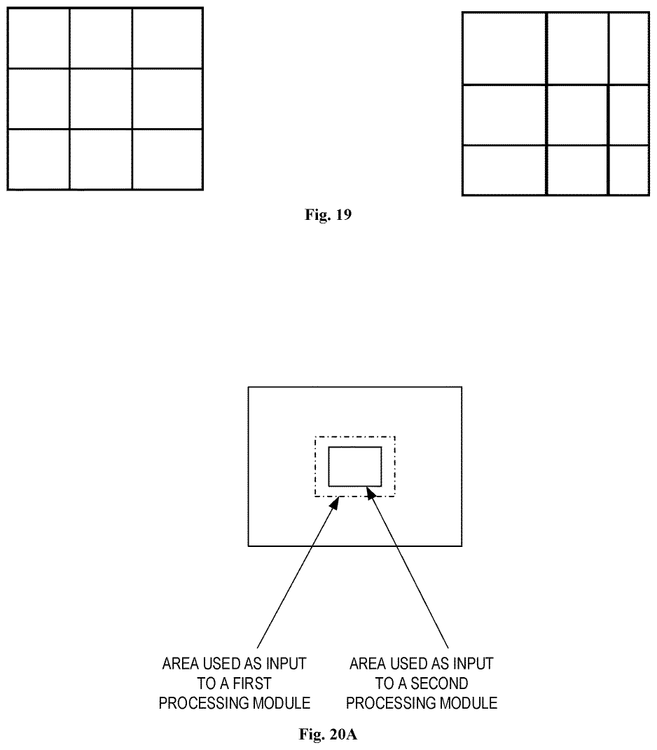

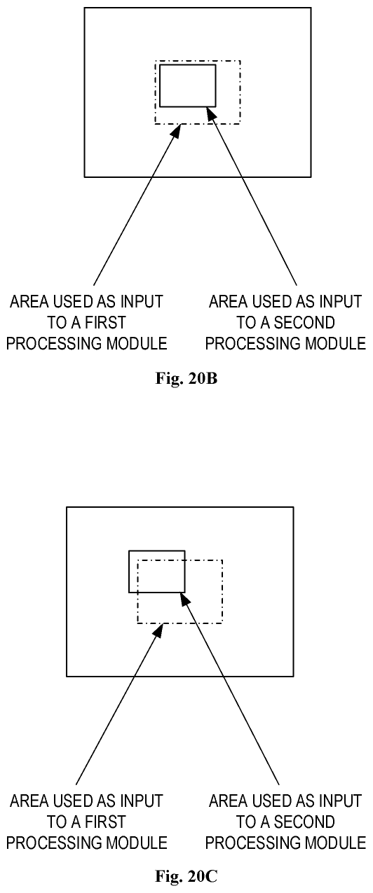

To solve the above-described problems, methods as summarized below are disclosed. The solutions should be considered as examples to explain the general concepts and should not be interpreted in a narrow way. Furthermore, these solutions can be applied individually or combined in any manner.
1) It is proposed that a subset (such as a subpicture, or a tile, or a slice, or a region) of samples in a picture can be reconstructed independently from samples in the picture out of the subset, with a NN-based decoder such as a JPEG-AI decoder.
2) To solve problems 1 and 2, one or more of the following methods apply:
   a. Instead of using the current type-based bits organization solution for a whole picture, it is proposed to restrict the type-based bits organization solution to be region-based instead of picture-based.
      i. Alternatively, furthermore, the bits of all types for a first region are coded firstly, followed by the bits of a second region.
      ii. Alternatively, furthermore, the bits for a first region are organized following the type-based solution, that is, bits for one type in the first region are coded firstly, followed by bits for another type in the first region.
      iii. Alternatively, furthermore, an indicator (e.g., 1-bit flag or a starting code or an ending code) may be signalled after all bits of all types for a first region before coding the 2^{nd} region.
      iv. Alternatively, furthermore, an indicator (e.g., 1-bit flag or a starting code or an ending code) may be signalled before all bits of all types for a region.
      v. Alternatively, furthermore, an indicator (e.g., 1-bit flag or a starting code or an ending code) may be signalled before/after all bits of one type for a region.
   b. Coded bits of different types (e.g., the hyper tensor, primary component residual, and secondary component residual) for the same region are placed together.
      i. For example, coded bits of different types for the same region are not separated by a coded bit of any other region.
      ii. Additionally, one or multiple indications are signalled to control whether such a coded bit placement is applied or not.
   c. A JPEG marker is placed at the beginning of coded bits for at least one region.
      i. A JPEG marker is placed at the beginning of coded bits for each region.
      ii. In one example, for a region, a JPEG marker is placed at the beginning of each type (hyper tensor, primary component residual, or secondary component residual) of coded bits.
      iii. In another example, for a region, a JPEG marker is placed at the beginning the hyper tensor coded bits, but not at the beginning of the coded bits of the other types (i.e., primary component residual and secondary component residual).
   d. A first number of regions is applied on the hyper tensor coded bits, a second number of regions is applied on the primary component residual coded bits, and a third number of eregions is applied on the secondary component residual coded bits, and the numbers may satisfy:
      i. It may be required that the first number should be equal to the second number.
      ii. It may be required that the first number should be equal to the third number.
      iii. It may be required that the second number should be equal to the third number.
      iv. A single indication may be signaled to indicate the number of regions.
         1. The first number, and/or the second number and/or the third number may be set equal to the signaled number of regions, without being signaled individually.
3) To solve problem 3, one or more of the following NN-based image and/or video coding methods apply:
   a. Enable partitioning a picture into multiple vertically-split regions.
      i. E.g. the number of vertical splits is indicated.
      ii. In one example, the number of vertical splits minus 1 is signalled.
      iii. In one example, the number of vertical splits is signalled and the value is constrained to be greater than 0.
   b. Enable partitioning a picture into multiple horizontally-and-vertically-split regions.
      i. E.g. the number of vertical splits and/or the number of horizontal splits are indicated.
      ii. In one example, the number of vertical splits minus 1 and the number of horizontal splits minus 1 are signalled.
      iii. In one example, the number of vertical splits and the number of horizonal splits are signalled and the values are both constrained to be greater than 0.
   c. Additionally, the maximum number of vertically-split and/or horizontally-split regions is constrained.
      i. In one example, the maximum number of regions is equal to a positive integer N, which may depend on the profile and level.
   d. Additionally, the position of vertically-split and/or horizontally-split regions is constrained.
      i. In one example, the upper-left luma position of a region shall be located at (2\hat{ }X, 2\hat{ }Y) relative to the upper-left luma position of the picture, where X and Y are non-negative integers.
         1. In one example, both X and Y are equal to 4.
         2. In one example, both X and Y are equal to 5.
         3. In one example, both X and Y are equal to 6.
   e. Alternatively, the minimal number of luma samples and/or chroma samples contained in one region is constrained.
      i. In one example, the number of luma samples in one region shall be no smaller than 2.
      ii. In one example, the number of luma samples in one region shall be no smaller than 4.
      iii. In one example, the number of luma samples in one region shall be no smaller than 16.
      iv. In one example, the number of luma samples in one region shall be no smaller than 64.
   f. Alternatively, the maximum number of luma samples and/or chroma samples contained in one region is constrained.
      i. In one example, the number of luma samples in one region shall be smaller than a positive integer N, which may depend on the profile and level.
4) To solve problem 4, an indication of regional access capability is signalled in a bitstream coded by an NN-based coder, e.g., to an NN-based decoder such as a JPEG-AI decoder, e.g., in the picture header.
   a. In one example, the indication indicates that it is possible to decode a region independently from other regions.
      i. In one example, the indication may indicate that it is possible to decode each region independently from other regions.
   b. In one example, the indication indicates that it is possible to correctly decode a region independently from other regions.
      i. In one example, the indication may indicate that it is possible to correctly decode each region independently from other regions.
   c. In one example, when it indicated that regional access is enabled, one or more of the following constraints are imposed:
      i. Each luma or chroma sample on a region boundary shall also be on a tile boundary.
      ii. Each tile is a subset of a region. This implies that tile width is less than or equal to region width, and tile height is less than or equal to region height.
      iii. Tiles for luma and for chroma are aligned. This implies that (tile_size_Luma_ver+sᵥₑᵣ−1)/sᵥₑᵣ shall be equal to tile_size_Chroma_ver, and (tile_size_Luma_hor+sₕₒᵣ−1)!sₕₒᵣ shall be equal to tile_size_Chroma_hor.
5) To solve problem 5, one or more of the following methods apply:
   a. In one example, an indication is signalled for a region to indicate whether the entire region can be correctly decoded independently from other regions.
      i. In one example, an indication may be signaled for each region individually.
   b. In one example, an indication is signalled for a region to indicate whether the entire region can be decoded independently from other regions.
      i. In one example, an indication may be signaled for each region individually.
   c. In one example, for any particular region, when it is indicated that the entire region can be correctly decoded independently from other regions, regardless of the tile overlap value signalled for the picture, zero overlap is applied when the boundaries of the region are processed in the decoding process.
      i. In one example, alternatively, for any particular region, when it is indicated that the entire region can be correctly decoded independently from other regions, in the decoding process the boundaries of the region are handled in the same manner as picture boundaries.
   d. For a particular region, when it is indicated that the entire region can be decoded independently from other regions, regardless of the tile overlap value signalled for the picture, zero overlap is applied when at least one boundary of the region is processed in the decoding process.
      i. In one example, alternatively, for any particular region, when it is indicated that the entire region can be correctly decoded independently from other regions, in the decoding process at least one boundary of the region are handled in the same manner as picture boundaries.
   e. For item 5.c., 5.c.i, 5.d, or 5.d.i, one or more of the following apply:
      i. Additionally or alternatively, padding might be applied at at least one region boundary if it is indicated that the said region can be decoded independently.
         1. The padding amount might depend on the size of the region.
         2. The padding amount might be determined according to the modulo of the region size.
         3. The padding might be repetitive padding or padding with a constant value.
      ii. Additionally or alternatively, the region size might be multiple of M samples.
         1. The M might be of the form 2^{N}, wherein N might be a non-negative integer.
         2. The M might be 64, or 128, or 256.
         3. When the region size is determined to be multiple of M samples, all of the regions that are not at the right or bottom image boundary might be restricted to have a size that is multiple of M.
         4. As an example if the region size is determined to be multiple of 64, no padding might be necessary for processing of the said region. Since padding requires extra processing, restricting the region sizes to be multiple of 64 eliminates the extra processing.
         a. The padding operation might be necessary only at the regions that coincide with right or bottom image boundary.
         b. The padding operation might be performed in a way to make the region size multiple of 64.
6) To solve problem 5, according to some example embodiments of the present disclosure, the following might be performed.
   a. The process of entropy decoding of a region might be performed independently from other regions.
   b. The process of sample prediction of latent tensor reconstruction of a region might be performed independently from other regions.
   c. The process of filtering of a region might be performed independently from other regions.
      i. The filtering process might comprise a convolution operation.
      ii. The convolution process might comprise padding (repetitive padding or padding with a constant), if the convolution process requires samples outside of a region.
      iii. The convolution process might be restricted to use samples inside of a region.
      iv. The convolution process might be implemented as cross-correlation process.
   d. The process of tensor reconstruction of a region might be performed independently from other regions.
      i. A bitstream might be decoded according to an order, wherein all samples corresponding to a region might be decoded before decoding of any samples corresponding to another region.
         1. A hyper latent (or a hyper tensor substream) of a region might be decoded first,
         2. A primary residual stream of a region might be decoded secondly, and
         3. A secondary residual stream of a region might be decoded thirdly, wherein a sample corresponding to a second region is not decoded after the decoding of the first sample of the hyper latent and before the end of decoding of the last sample of the region.
      ii. A residual tensor or a latent or a hyper latent tensor might be reconstructed according to an order, wherein samples of each region might be grouped together.
      iii. A residual tensor or a latent or a hyper latent tensor might be reconstructed according to an order, wherein all samples of a first region is reconstructed first, then all samples of a second region are reconstructed.
   e. Any of the above mentioned processed might comprise a neural network that might be applied to process a region independently from other regions.
      i. The said neural network might be a hyper decoder or a hyper scale decoder or alike.
      ii. The output of the neural network might be standard deviation logarithm tensor, standard deviation tensor or alike.
      iii. The output of the neural network might be prediction tensor, explicit prediction tensor or alike.
      iv. The said neural network might be performed multiple times on each of the regions in decoding of an image.
      v. A cropping might be applied during or at the end of the processing with the neural network, wherein the cropping among is determined according to the region size.
         1. Cropping might be applied only if a region shares a boundary with the bottom or right boundary of an image.
         2. Cropping might not be applied if a region does not share any boundary with the bottom or right boundary of an image.
   f. A lossless decoder, (arithmetic decoder, asymmetric numeral systems or alike) might be applied to obtain the residuals corresponding to a region independently of other regions.
   g. The probability parameters of a region might be obtained independently of other regions.
      i. Probability parameters (e.g. sigma parameters, gaussian sigma parameters etc.) corresponding to a region might be used to decode the samples of only one region and not used to obtain (i.e. decode) the samples of a second region.
   h. The sample prediction of latent sample prediction process might comprise a multi-state context model process.
   i. The coordinates of a region (e.g. vertical coordinate, horizontal coordinate) and/or the size of a region might be determined according to image size and a depth parameter.
      i. Vertical coordinate of a region might be obtained according to i*VerRegionSize/2^{d}.
      ii. Vertical ending coordinate of a region might be obtained according to (i==NumVerSplits−1)?ceil((img_height+64)+_{2d}):(i+1)*VerRegionSize/2^{d}.
      iii. Horizontal coordinate of a region might be obtained according to i*HorRegionSize/2^{d}.
      iv. Horizontal ending coordinate of a region might be obtained according to (j==NumHorSplits−1)ceil((img_width+64)+_{2d}):(j+1)*HorRegionSize/2^{d}.
   Wherein the I and j are the indices of the region, img_width, img_height are the width and height of the image and “d” is the depth of the tensor.
   A neural network used to process the regions might comprise multiple processing layers, each one processing an input tensor and outputting an output tensor. The depth parameters might correspond to the position of a tensor output.
7) In one example, a first bitstream coded with at least one NN may be processed to get a second bitstream and the second bitstream may be decoded.
   a. In one example, a sub-stream denoted as the second bitstream may be extracted from the first bitstream, and the sub-stream may be decoded.
      i. In one example, the sub-stream may be a subset of the first bitstream.
         1. In one example, the sub-stream may be a modified subset of the first bitstream.
      ii. In one example, a sub-stream may correspond to a region in the picture corresponding to the first bitstream.
   b. In one example, whether and/or how the first bitstream is processed to generate the second bitstream may be indicated in the first and/or second bitstream.
8) According to some example embodiments of the present disclosure, data corresponding to a region might be removed and/or extracted from the bitstream.
   a. The data might be a substream, a bitstream, a syntax element or like.
      i. The data might comprise quality map information, a residual data, luma residual data, chroma residual data, a hyper latent data, residual latent data or alike.
   b. An indication might be included in the bitstream to indicate data corresponding to which region is present (or absent) in a bitstream.
      i. The indication might be an index.
         1. The indication might indicate a region index or a substream index.
         2. The indication might be a list of indices, wherein each entry of the list might indicate the regions that are removed from the bitstream.
         3. The indication might be a list of indices, wherein each entry of the list might indicate the regions that are present in the bitstream.
      ii. The indication might be a flag.
         1. The flag might indicate if a region is present in the bitstream or absent in the bitstream.
      iii. The indication might indicate the number of regions that are present or absent in the bitstream.
         1. The indication might indicate the number of regions in a vertical dimension or a horizontal dimension that are present or absent in a bitstream.
         2. The indication might be num_present_hor_splits_minus1 or num_present_ver_splits_minus1.
         3. The indication might indicate total number of regions present or absent in the bitstream.
   c. An indication might be included in the bitstream to indicate if data corresponding to a region is present (or absent) in a bitstream.
      i. The data might comprise information related to;
         1. part of a region.
         2. residual information of a region.
         3. hyper latent information of a region.
         4. Quality map information of a region
      ii. A first indication might be included in the bistream to indicate the size of the data.
         1. The first indication might indicate the number of bits or number of bytes.
         2. The first indication might be coded using predictive coding.
         3. The first indication might be coded using fixed length or variable length coding.
         4. A second indication might be included in the bitstream to indicate the length of the first indication.
         a. The second indication might indicate the number of bits or number of bytes that is used to encode/decode the first indication.
         b. The second indication might be q_ls, z_ls, r_primary_ls or r_secondary_ls as exemplified in embodiment 2.
         c. The second indication might be included in the bitstream (or obtained from the bitstream) based on a third indication.
         i. The third indication might be a flag.
         5. The first indication might be z_stream_size, q_stream_size, r_primary_stream_size, or r_secondary_stream_size as exemplified in embodiment 1 or 2.
   d. An indication might be included in the bitstream to indicate if all regions are included in the bitstream or if a region is removed and/or extracted from the bitstream.
      i. The indication might be a flag.
      ii. The indication might be a region_set_exracted_flag flag.
      iii. If the value of the indication is true (or false), a second indication might be included in the bitstream to indicate:
         1. number of regions that are removed (or present).
         2. The indices of regions that are removed or present.
         3. A flag to indicate if a region is removed or present.
   e. An indication might be included in the bitstream to indicate an area corresponding to regions that are removed or present.
      i. The area information might include a start coordinate and a size information.
      ii. The area information might include a number of regions that are removed or present.
      iii. The area information might include indices of a regions that are removed or present.
9) According to some example embodiments of the present disclosure, the regions might be encoded/decoded independently or dependently.
   a. An indication might be included in the bitstream to indicate if a region might be decoded independently or dependently.
   b. If a region is indicated to be decoded independently:
      i. Samples corresponding to a neighbor region of the said independent region are not used in the processing of at least one processing module.
         1. The processing module might be a hyper decoder, a hyper scale decoder, a sample prediction module, a latent prediction module, an MCM (multi-stage-context) module, an entropy decoding module or a synthesis transform module, etc.
         2. The input of the processing module is set to comprise only the samples corresponding to said independent region.
         3. The output of the processing module is assigned to the said independent region.
      ii. Samples corresponding to none of the neighbor regions of the said independent region are used in the processing of at least one processing module.
   c. If a region is indicated to be decoded dependently:
      i. At least one sample corresponding to a neighbor region of the said dependent region is used in the processing of at least one processing module.
         1. The processing module might be a hyper decoder, a hyper scale decoder, a sample prediction module, a latent prediction module, an MCM (multi-stage-context) module, an entropy decoding module or a synthesis transform module, etc.
         2. An extension size is used to determine the amount of samples to be used from a neighbor region.
         a. The extension size might be used to determine the size of the input of the processing module.
         b. The size might indicate the extension of the input of the processing module in either one of the horizontal or vertical direction.
         i. The size might indicate the extension amount in left/right/bottom or top direction.
         c. The extension size might be used to determine the cropping amount of the output of a processing module (how much of the samples to be discarded from the output of the processing module).
         d. The extension size might be different for different processing modules.
         i. The extension size might be 1 for hyper decoder and hyper scale decoder.
         ii. The extension size might be 4 or 8 for latent reconstruction process or MCM process or sample prediction process.
         iii. The extension size might be indicated in the bitstream.
         1. An indication might be included in the bitstream to determine the amount of extension in the input and output.
   ii. The dependent regions might be removed from the bitstream.
   iii. An independent region cannot be removed from the bitstream if a dependent region is present in the bitstream that requires samples from the said independent region.
   iv. A sample corresponding to an independent region or a dependent region might be used in the processing of a dependent region.
10) The bitstream corresponding to a region might be encoded/decoded using an entropy coder in parallel.
   a. A data corresponding to a region might be coded/decoded using an entropy coder/decoder in parallel.
      i. The data might comprise information related to;
         1. part of a region.
         2. residual information of a region.
         3. hyper latent information of a region.
         4. Quality map information of a region.
   b. An indication might be included in the bitstream to indicate the number of parallel processing units (e.g. threads) can be used.
      i. The indication might indicate the number of threads.
      ii. The indication might be:
         1. num_threads_q_minus1,
         2. num_threads_z_minus1,
         3. num_threads_r_pimary_minus1,
         4. num_threads_r_secondary_minus1.
      iii. The indication might be different for different data types. For example the number of parallel processing threads might be different for data corresponding to luma information or chroma information. The number might be different for hyper latent information (e.g. hyper tensor) or residual information or quality map information or picture header.
      iv. The indication might be same for different data types.
   c. The above mentioned parallel processing units (e.g. number of threads) might be predefined or inferred.
   d. The parallel processing units (e.g. number of threads), or the maximum number of parallel processing units (maximum number of threads) might be determined based on:
      i. A profile indication,
      ii. A picture size indication.
      iii. A number of regions indication,
      iv. Etc.
11) According to some example embodiments of the present disclosure, the maximum number or maximum size or minimum size of a region might be determined based on:
   a. A profile indication,
   b. A picture size indication.
   c. A number of regions indication,
   d. Etc.
12) According to some example embodiments of the present disclosure, the regions might be centrally aligned, equipartitioned or shifted.
   a. An indication might be included in the bitstream to indicate that region coordinates are shifted.
   b. The regions might be equipartitioned. E.g. the regions might have same size except for the right or bottom boundary.
      i. An example is depicted in FIG. 19 on the left. The 4 regions (except for the regions at the right and bottom boundary have equal sizes).
   c. The regions might be shifted. Compared to the equipartitioned case, the regions might be shifted to:
      i. Extend the size of the regions on the left and/or top boundary, and/or
      ii. Reduce the size of the regions at the right and/or bottom boundary.
      iii. An example is depicted in FIG. 19 on the right.
   d. The processing areas corresponding to a region might be centrally aligned or shifted;
      i. During the processing of a region the tensor used as input to a first processing module might be centrally aligned with the tensor used as input to a second processing module.
      ii. During the processing of a region the tensor used as input to a first processing module might be shifted with respect to the tensor used as input to a second processing module.
      iii. This is exemplified in FIGS. 20A-20C, which illustrate three example alignment schemes. More specifically, FIG. 20A illustrates a scheme with centrally aligned processing areas corresponding to a region, FIG. 20B illustrates an example of shifted areas, and FIG. 20C illustrates a further example of shifted areas.
   e. In one example the processing of a synthesis transform might be performed according to centrally aligned regions. And at least one processing unit is performed using non-aligned (e.g. shifted) regions.
   f. In one example the processing of a synthesis transform might be performed according to centrally aligned regions. And at least one processing unit is performed using either the centrally aligned or non-aligned (e.g. shifted) regions.
      i. The at least one processing unit might be one or more of the following:
         1. Hyper decoder,
         2. hyper scale decoder,
         3. entropy decoder,
         4. sample prediction unit,
         5. MCM (multi-stage context model),
         6. latent sample reconstruction unit.
      ii. The determination of if centrally aligned regions are used or not is determined based on an indication.
         1. The indication might be included in a bitstream.
         2. The indication might be inferred based on one or more of the following:
         a. Picture size,
         b. profile indication,
         c. level indication,
         d. etc.
13) The correspondence between an index of a sub-stream and a region in the original picture may depend on at least one signaled indication.
   a. In one example, the location (such as the coordinate of the top-left position) and/or the size (such as width and height) of the region corresponding with an index may be signaled.
   b. Alternatively, the correspondence between an index of a sub-stream and a region in the original picture may be derived.
      i. In one example, the location (such as the coordinate of the top-left position) and/or the size (such as width and height) of the region corresponding with an index may be derived based on the region partitioning way of the whole picture and/or the index scanning order of regions.
14) Constrains may be applied to regions in a picture coded with at least one NN.
   a. For example, two regions should not be overlapped.
   b. For example, all regions should cover the whole picture.
   c. For example, the region location (such as the coordinate of the top-left position denoted as (X, Y)) may be constrained.
      i. For example, X and/or Y must be in a form of k×N, where k is an integer and N is a predefined integer such as 2, 4, 8, 16.
   d. The region size (such as width W and height H) may be constrained.
      i. For example, X and/or Y must be in a form of k×N, where k is an integer and N is a predefined integer such as 2, 4, 8, 16.
   e. The number of total regions may be no larger than a predefined integer such as 16.
   f. The number of rows of regions may be no larger than a predefined integer such as 8.
   g. The number of columns of regions may be no larger than a predefined integer such as 8.
15) In one example, a syntax element signaled related to region based coding with at least one NN may be coded in a predictive way.
16) In one example, a picture partitioned flag indicating whether the picture is partitioned into a set of rectangular regions in signalled in the picture header.
17) In one example, an indication of the granularity of the regions the picture is partitioned into is signalled in the picture header.
   a. In one example, the indication is signaled using a syntax element region_granularity_idc that coded as N bits, where N is equal to 2, 3, or 4.
   b. In one example, a variable RegionGranularity, which indicates the granularity of the regions the picture is partitioned into, is derived to be equal to (region_granularity_idc+1)*128.
18) In one example, a default number of parallelly decodable sub-streams in each of one or more of the quality map codestream, the hyper tensor codestream, the primary component residual tensor codestream, and the secondary component residual tensor codestream is signalled.
19) In one example, a length for a syntax element indicating the sub-bitstream size for each of one or more of the quality map codestream, the hyper tensor codestream, the primary component residual tensor codestream, and the secondary component residual tensor codestream is signalled using two bits, withe values specifying that the length is of 1, 2, 3, or 4 bytes, respectively.
20) In one example, the syntax elements region_set_extracted_flag, num_present_ver_splits_minus1, and num_present_hor_splits_minus1 are signalled in the picture header syntax structure instead of directly in the picture syntax structure.
21) In one example, at the end of picture header syntax structure, zero or more bits equal to 0 are appended until the length of the picture header structure is an integer times of 8 bits.
22) In one example, the num_ver_splits_minus1 and num_hor_splits_minus1 are conditionally signalled in the picture header syntax structure, present only when the picture partitioned flag is equal to 1.
23) In one example, it specified that, when num_ver_splits_minus1 is not present, its value is inferred to be equal to 0.
24) In one example, it specified that, when num_hor_splits_minus1 is not present, its value is inferred to be equal to 0.
25) In one example, the variable VerRegionSize is set equal to (((img_height+RegionGranularity−1)/RegionGranularity)/NumHorSplits)*RegionGranularity.
26) In one example, the variable HorRegionSize is set equal to (((img_width+RegionGranularity−1)/RegionGranularity)/NumVerSplits)*RegionGranularity.
27) In one example, it specified that, when region_partitioning_flag is equal to 1, the value of NumVerSplits*NumHorSplits shall be greater than 1.
28) In one example, it specified that, when regional_access_enabled_flag is not present, its value is inferred to be equal to 1.
29) In one example, it specified that, when independent_region_flag[i][j] is not present, its value is inferred to be equal to 1.
30) In one example, an indication is signalled to indicate whether region-specific numbers of threads for the quality map, hyper tensor, primary component residual tensor, and secondary component residual tensor codestreams are enabled.
31) In one example, at the end of the tools header syntax structure, zero or more bits equal to 0 are appended until the length of the tools header structure is an integer times of 8 bits.
32) In one example, the number of bytes in the hyper tensor codestream for a region excluding the first two-byte marker minus 1, e.g., by the syntax element z_stream_size_minus1, is signalled.
33) In one example, the number of parallelly decodable sub-streams in the hyper tensor codestream for a region minus 1, e.g., by the syntax element num_threads_z_minus1, may be signalled.
34) In one example, an indication indicating whether the num_threads_z_minus1 syntax element is present in the hyper tensor codestream for a region is signalled.
35) In one example, it is specified that, when num_threads_z_minus1 is not present, its value is inferred to be equal to a default value.
36) In one example, at the end of the hyper tensor codestream for a region, zero or more bits equal to 0 are appended until the length of the codestream is an integer times of 8 bits.
37) In one example, the number of bytes in the quality map codestream for a region excluding the first two-byte marker minus 1, e.g., by the syntax element q_stream_size_minus1, is signalled.
38) In one example, the number of parallelly decodable sub-streams in the quality map codestream for a region minus 1, e.g., by the syntax element num_threads_q_minus1, may be signalled.
39) In one example, an indication indicating whether the num_threads_q_minus1 syntax element is present in the quality map codestream for a region is signalled.
40) In one example, it is specified that, when num_threads_q_minus1 is not present, its value is inferred to be equal to a default value.
41) In one example, at the end of the quality map codestream for a region, zero or more bits equal to 0 are appended until the length of the codestream is an integer times of 8 bits.
42) In one example, the number of bytes in the primary component residual tensor codestream for a region excluding the first two-byte marker minus 1, e.g., by the syntax element r_primary_stream_size_minus1, is signalled.
43) In one example, the number of parallelly decodable sub-streams in the primary component residual tensor codestream for a region minus 1, e.g., by the syntax element num_threads_r_primary_minus1, may be signalled.
44) In one example, an indication indicating whether the num_threads_r_primary_minus1 syntax element is present in the primary component residual tensor codestream for a region is signalled.
45) In one example, it is specified that, when num_threads_r_primary_minus1 is not present, its value is inferred to be equal to a default value.
46) In one example, at the end of the primary component residual tensor codestream for a region, zero or more bits equal to 0 are appended until the length of the codestream is an integer times of 8 bits.
47) In one example, the number of bytes in the secondary component residual tensor codestream for a region excluding the first two-byte marker minus 1, e.g., by the syntax element r_secondary_stream_size_minus1, is signalled.
48) In one example, the number of parallelly decodable sub-streams in the secondary component residual tensor codestream for a region minus 1, e.g., by the syntax element num_threads_r_secondary_minus1, may be signalled.
49) In one example, an indication indicating whether the num_threads_r_secondary_minus1 syntax element is present in the secondary component residual tensor codestream for a region is signalled.
50) In one example, it is specified that, when num_threads_r_secondary_minus1 is not present, its value is inferred to be equal to a default value.
51) In one example, at the end of the secondary component residual tensor codestream for a region, zero or more bits equal to 0 are appended until the length of the codestream is an integer times of 8 bits.

### General Aspects

52) Additional operations may be applied to or with the proposed method.
a) A syntax element (a.k.a. an indication) disclosed above may be binarized as a flag, a fixed length code, an EG(x) code, a unary code, a truncated unary code, a truncated binary code, etc. It can be signed or unsigned.
b) A syntax element representing a coding tool or a coding method may not be signalled and implicitly determined to be unused, if the coding tool or the coding method is regarded as not applicable or cannot be used.
c) A syntax element disclosed above may be coded with at least one context model. Or it may be bypass coded.
d) A syntax element disclosed above may be signaled in a conditional way.
e) A syntax element disclosed above may be signaled at block level/sequence level/group of pictures level/picture level/slice level/tile group level.
f) Whether to and/or how to apply the disclosed methods above may be signalled at block level/sequence level/group of pictures level/picture level/slice level/tile group level.
g) Whether to and/or how to apply the disclosed methods above may be dependent on coded information, such as colour format, colour component, slice/picture type.
53) The proposed methods may be applied to other image/video compression solutions with NN-based coding tools involved.

### 5. Embodiments

Below are some example embodiments for the detailed solutions aspects summarized above in Section 4. Most relevant parts that have been added or modified are shown by using bolded words (e.g., this format indicates added text), and some of the deleted parts are shown by using words in italics between double curly brackets (e.g., {{this format indicates deleted text}}). There may be some other changes that are editorial in nature and thus not highlighted. It should be understood that only markings in this section are intended to represent changes.

### 5.1. Embodiment 1

This embodiment is for some of the detailed solution items summarized above in Section 4.

### 1. (3.5.20) Padding Layer

padding layer is denoted as Padd (Hᵢₙ, Wᵢₙ, d, s_{d}), where Hᵢₙ, Wᵢₙ are height and width of tensor—input to Analysis transform, s_{d} is stride of proceeding convolution, d is depth of convolution layer in deep learnable encoder. Padding layer receives tensor of size [C, h_{d-1}, w_{d-1}] and outputs tensor of size [C, s_{d}h_{d}, s_{d}w_{d}], where h_{d}=ceil(h_{d-1}/s_{d}); w_{d}=ceil(w_{d-1}/s_{d}), h₀=Hᵢₙ, w₀=Wᵢₙ. By default padding is performed by replication. Different model of padding can be specified (for example, padding by zeros).

padding layer is denoted as Padd(s), where h, w are height and width of the input tensor and s is stride. Padding layer receives tensor of size [C, h, w] and outputs tensor of size [C, h+h % s, w+w % s]. Default padding is performed by replication when the padding mode is not explicitly specified. Different model of padding can be specified (for example, padding by zeros).

### 2. (3.5.22) Cropping Layer

cropping layer is denoted as Crop (Hᵢₙ, Wᵢₙ, d, s_{d}), where Hᵢₙ, Wᵢₙ are height and width of tensor—output to Synthesis transform, s_{d} is stride of proceeding transposed convolution, d is depth of convolution layer in deep learnable reconstruction process. Cropping layer outputs a tensor of size [C, h_{d-1}, w_{d-1}], where h_{d-1}, w_{d-1} defined in Table 2. Note, that h₀=Hᵢₙ, w₀=Wᵢₙ. Cropping is performed by discarding redundant elements. cropping layer is alternatively denoted as Crop(h, w), where h and w are height and width of the output tensor. Cropping layer outputs a tensor of size [C, h, w] by discarding redundant elements.

### 3. (8.4) Latent Space Tiles

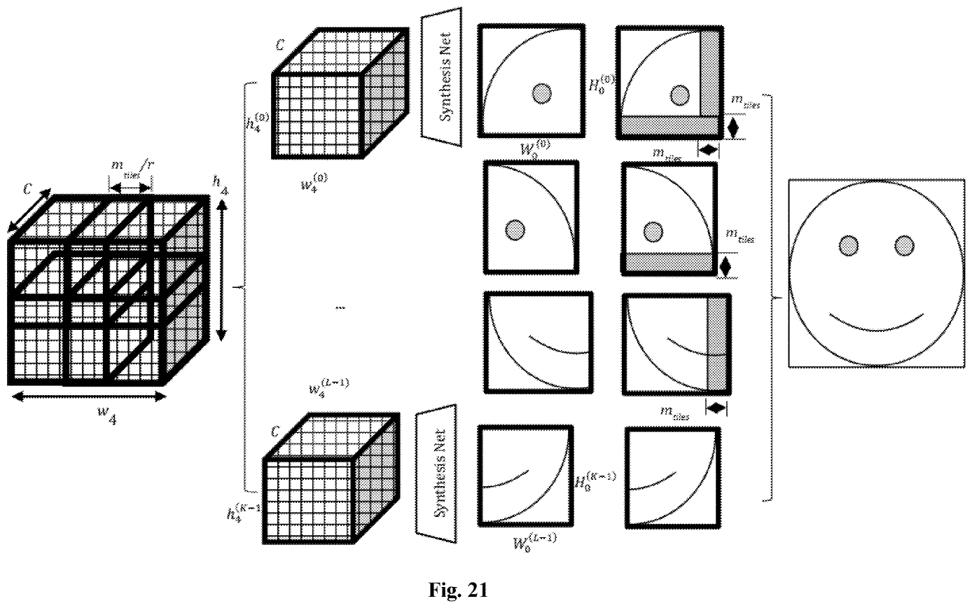

Latent space tiles decoding can be enabled for each component independently by flags signalled in picture header (section 9.3). If tile_enable_Luma or tile_enable_Choma is true then corresponding component is decoded unsing latent tiling process illustrated on FIG. 21.

The number and location of tiles are determined by values tile size S_{tileHor} and S_{tileVer} (equal to tile_size_Luma hor and tile_size_Luma_ver for primary component and tile_size_Chroma_hor and tile_size_Chroma_ver for secondary component respectively) and tile overlap mₜᵢₗₑ (tile_overlap_Luma for primary component tile_overlap_Chroma for secondary component) signalled in picture header (section 9.3). Further, the ratio r=Hᵢₙ/h₄=wᵢₙ/w₄ between signal domain size and latent tensor size is known, which is r=24 for primary and r=23 for secondary component.

The number of tiles vertically is K=ceil((Hᵢₙ−mₜᵢₗₑ)/(S_{tileVer}−mₜᵢₗₑ)) and horizontally L=ceil ((Wᵢₙ−mₜᵢₗₑ)/(S_{tileHor}−mₜᵢₗₑ)), where Hᵢₙ, Wᵢₙ are height and width of output color plane. Hᵢₙ, Wᵢₙ are height and width of output color plane.

For k=0, . . . , K−1 and l=0, . . . , L−1,
Define tiles coordinates and sizes

$$◦ {i}_{0}^{( k )} = k \cdot ( {S}_{tileVer} - {m}_{tile} ) - vertical dimension tile start in signal domain ;$$

$$◦ {i}_{0}^{( k )} = {i}_{0}^{( k )} - {m}_{tile} / 2 if$$

top tile boundary is not at image boundary and
top tile boundary is not at a region boundary with independent_region_flag equal to 1.

$$◦ {i}_{4}^{( k )} = {i}_{0}^{( k )} / r - vertical dimension tile start in latent space ;$$

$$◦ {H}_{0}^{( k )} = ( k < K - 1 ) ? {S}_{tileVer - {m}_{tile}} : {H}_{in} - {i}_{0}^{( k )} - vertical dimension tile start in signal domain ;$$

$$◦ {H}_{0}^{( k )} = {H}_{0}^{( k )} + {m}_{tile} / 2 if$$

bottom tile boundary is not at image boundary and
bottom tile boundary is not at a region boundary with independent_region_flag equal to 1.

$$◦ {h}_{4}^{( k )} = ceil ( {H}_{0}^{( k )} / r ) - vertical dimension tile start in latent space ;$$

$$◦ {j}_{0}^{( l )} = l \cdot ( {S}_{tileHor} - {m}_{tile} ) - horizontal dimension tile start in signal domain ;$$

$$◦ {j}_{0}^{( k )} = {j}_{0}^{( k )} - {m}_{tile} / 2 if$$

left tile boundary is not at image boundary and
left tile boundary is not at a region boundary with independent_region_flag equal to 1.

$$◦ {j}_{4}^{( l )} = {j}_{0}^{( l )} / r - horizontal dimension tile start in latent space ;$$

$$◦ {W}_{0}^{( l )} = ( l < L - 1 ) ? {S}_{tileHor - {m}_{tile}} : {W}_{in} - {j}_{0}^{( l )} - horizontal dimension tile start in signal domain ;$$

$$◦ {W}_{0}^{( k )} = {W}_{0}^{( k )} + {m}_{tile} / 2 if$$

right tile boundary is not at image boundary and
right tile boundary is not at a region boundary with independent_region_flag equal to 1.

$$◦ {w}_{4}^{( l )} = ceil ( {W}_{0}^{( l )} / r ) - horizontal dimension tile start in latent space .$$

tile latent space tensor

$$◦ For c = 0 , … , C - 1 , i = 0 , … , {h}_{4}^{( k )} - 1 and j = 0 , … , {w}_{4}^{( l )} - 1$$

$${\hat{y}}_{k , l} [ c , i , j ] = \hat{y} [ c , {i}_{4}^{( k )} + i , {j}_{4}^{( l )} + j ]$$

$$◦ For c = 0 , … , {C}_{d} - 1 , i = 0 , … , {h}_{4}^{( k )} - 1 and j = 0 , … , {w}_{4}^{( l )} - 1$$

$${\tilde{y}}_{k , l} [ c , i , j ] = \tilde{y} [ c , {i}_{4}^{( k )} + i , {j}_{4}^{( l )} + j ]$$

Synthesis transform for one tile
   Synthesis transform described in section 8.3 with ŷ_{k,l}, \tilde{y}_{k,l} of sizes

$${h}_{4}^{( k )} and {w}_{4}^{( l )}$$

as inputs and \ddot{x}_{k,l} of size

$${H}_{0}^{( k )} and {W}_{0}^{( l )}$$

as output.
Merging reconstructed parts of tensor into one

$$◦ {ov}_{l} = \{ \begin{matrix}0 , if {i}_{0}^{( k )} == 0 or left tile boundary coincides with a \\ region boundary and independent\_region \_flag is equal to 1 \\ for the region which comprises the tile . {m}_{tile} / 2 , otherwise\end{matrix}$$

overlap used on left boundary of the tile

$$◦ {ov}_{t} = \{ \begin{matrix}0 , if {j}_{0}^{( k )} == 0 or top tile boundary coincides with a \\ region boundary and independent\_region \_flag is equal to 1 \\ for the region which comprises the tile . {m}_{tile} / 2 , otherwise\end{matrix}$$

overlap used on top boundary of the tile

$$◦ {ov}_{r} = \{ \begin{matrix}0 , if {i}_{0}^{( k )} + {W}_{0}^{( l )} \geq {W}_{in} or right tile boundary coincides with a \\ region boundary and independent\_region \_flag is equal to 1 \\ for the region which comprises the tile . {m}_{tile} / 2\end{matrix}$$

overlap used on right boundary of the tile

$$◦ {ov}_{b} = \{ \begin{matrix}0 , if {j}_{0}^{( l )} + {H}_{0}^{( k )} \geq {H}_{in} or right tile boundary coincides with a \\ region boundary and independent\_region \_flag is equal to 1 \\ for the region which comprises the tile {m}_{tile} / 2\end{matrix}$$

overlap used on bottom boundary of the tile

$$◦ {H}_{1}^{( k )} = {H}_{0}^{( k )} - {ov}_{t} - {ov}_{b}$$

vertical dimension tile size in signal domain without tile overlap;

$$◦ {W}_{1}^{( l )} = {W}_{0}^{( l )} - {ov}_{l} - {ov}_{r}$$

horizontal dimension tile size in signal domain without tile overlap;

$$For c = 0 , … , {C}_{i n} - 1 , i = 0 , … , {H}_{1}^{( k )} - 1 and j = 0 , … , {W}_{1}^{( l )} - 1 ,$$

$$⌊ \hat{x} [ c , {i}_{0}^{( k )} + o {v}_{t} + i , {j}_{0}^{( l )} + o {v}_{l} + j ] = {\hat{x}}_{k , l} [ c , {ov}_{t} + i , {ov}_{l} + j ] .$$

Tile size location and overlap signalling in Picture Header is described in Annex C.

### 4. (9.2) Code Stream Layout

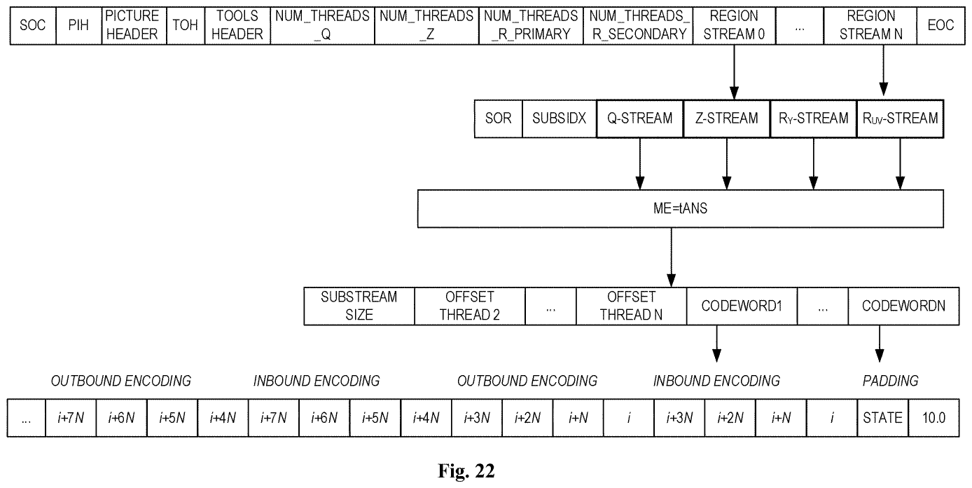

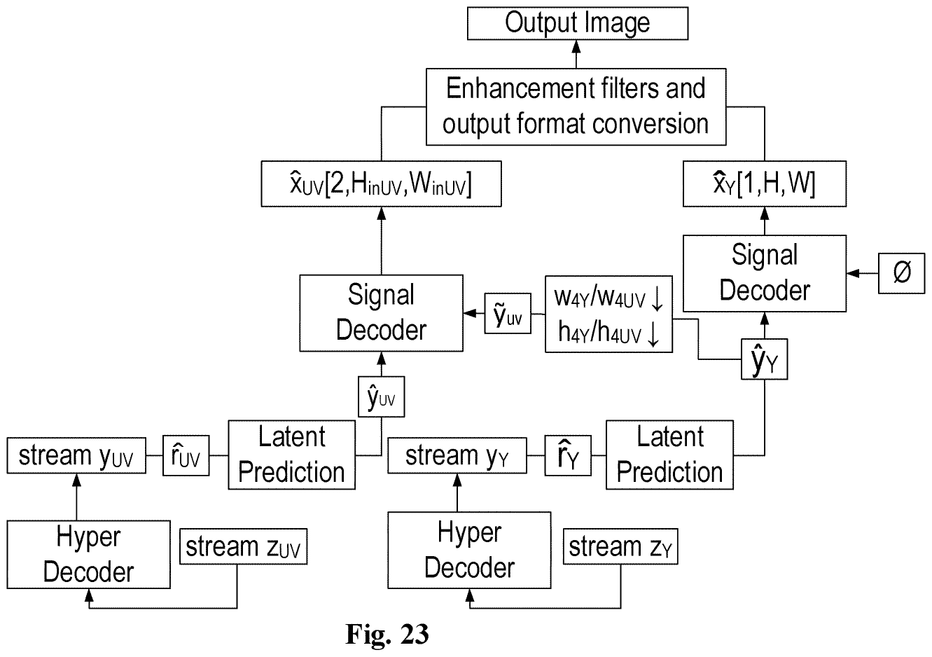

Code stream structure is depicted in FIG. 22. The code stream is composed of the following parts with byte boundary, which are:
9. SOC—Start Of Codestream marker;
10. PIH (Picture Header marker) followed by picture header (section 9.3);
11. TOH (Tools Header marker) followed by tools information (section 9.3.1.1);
12. SOR (Start of region-stream marker) followed by codestream of hyper tensor z, including 2 (“stream z_{Y}” in FIG. 23) and \ddot{z}_{UV} (“stream z_{UV}” in FIG. 23), codestream of primary component residual, which includes \hat{r}_{Y} (“stream y_{γ}” in FIG. 23), and codestream of secondary component residual, which includes \hat{r}_{UV} (“stream y_{UV}” in FIG. 23), for one region.
   13. EOC—End Of Codestream marker.

The overall syntax structure of an image is:

| | Descriptor |
|---|---|
| picture( ) { | |
| SOC | u(16) |
| picture_header( ) | |
| tools_header( ) | |
| region_set_exracted_flag | u(1) |
| if( region_set_exracted_flag ) { | |
| num_present_ver_splits_minus1 | u(7) |
| num_present_hor_splits_minus1 | u(7) |
| } | |
| for( i = 0; i < NumVerSplits; i++ ) { | |
| for( j = 0; j < NumHorSplits; j++ ) { | |
| SOR | u(16) |
| subsIdx | u(8) |
| q_stream_for_one_region(subsIdx) | |
| z_stream_for_one_region(subsIdx) | |
| r_primary_stream_for_one_region(subsIdx) | |
| r_secondary_stream_for_one_region(subsIdx) | |
| } | |
| } | |
| EOC | u(16) |
| } | |

Each code stream starts with a 16-bit marker. All markers used in this specification are as follows:

| Code | | | |
|---|---|---|---|
| assignment | Symbol | Description | Mandatory/Optional |
| 0xff80 | SOC | Start of codestream | Mandatory |
| 0xff81 | EOC | End of codestream | Mandatory |
| 0xff82 | PIH | Picture header | Mandatory |
| 0xff83 | TOH | Tools header | Optional |
| 0xff84 | VUI | Reserved for | Optional |
| | | rendering | |
| | | information | |
| 0xff85 | xxx | Reserved | Optional |
| 0xff86 | xxx | Reserved | Optional |
| 0xff87 | xxx | Reserved | Optional |
| 0xff88 | SOR | Start of region | Mandatory |
| | | substream | |
| 0xff8c | xxx | Reserved | Optional |
| 0xff8d | xxx | Reserved | Optional |
| 0xff8e | xxx | Reserved | Optional |
| 0xff8f | xxx | Reserved | Optional |

region_set_exracted_flag equal to 1 specifies that the picture( ) syntax structure contains a set of extracted regions that forms a rectangular region of the full picture. region_set_exracted_flag equal to 0 specifies that the picture( ) syntax structure contains the full picture.
num_present_ver_splits_minus1 plus 1 specifies the number of columns of regions contained in the picture( ) syntax structure. The value of num_present_ver_splits_minus1 shall be less than or equal to num_ver_splits_uminus1.
num_present_hor_splits_minus1 plus 1 specifies the number of rows of regions contained in the picture( ) syntax strucure. The value of num_present_hor_splits_minus1 shall be less than or equal to num_hor_splits_minus1.

When region_set_exracted_flag equal to 1, the value of the variable NumVerSplits is updated to be equal to num_present_ver_splits_minus1+1, and the value of the variable NumHorSplits is updated to be equal to num_present_hor_splits_minus1+1.
subsIdx indicates the region substream index.

5. (9.3.1) Syntax table

| | Descriptor |
|---|---|
| picture_header( ) { | |
| PIH | u(16) |
| picture header size | u(16) |
| img_width | u(16) |
| img_height | u(16) |
| picture_format | u(2) |
| bit_depth | u(1) |
| bit c_ver | u(1) |
| bit_c_hor | u(1) |
| bit s ver | u(1) |
| bit s hor | u(1) |
| num_ver_splits_minus1 | u(7) |
| num_hor_splits_minus1 | u(7) |
| if( NumVerSplits > 1 \| \| NumHorSplits > 1 ) { | |
| regional_access_enabled_flag | u(1) |
| if( regional_access_enabled_flag ) | |
| for( i = 0; i < NumVerSplits; i++ ) | |
| for( j = 0; j < NumHorSplits; j++ ) | |
| independent_region_flag[ i ][ j ] | u(1) |
| } | |
| num_threads_q_minus1 | u(7) |
| num_threads_z_minus1 | u(7) |
| num_threads_r_primary_minus1 | u(7) |
| num threads_r_secondary_minus1 | u(7) |
| color_transform_header( ) | u(1) |
| model_header( ) | |
| } | |

6. (9.3.1.1.) Model header

| | Descriptor |
|---|---|
| tile_header_Luma(tile_signaling_type) { | |
| tile_enable_Luma | u(1) |
| if (tile_enable_Luma) { | |
| tile_size_Luma_hor | u(13) |
| tile_size_Luma_ver | u(13) |
| tile_overlap_Luma | u(8) |
| } | |
| } | |
| tile_header_Chroma(tile_signaling_type) { | |
| tile_enable_Chroma | u(1) |
| if (tile_enable_Chroma) { | |
| tile_size_Chroma_hor | u(13) |
| tile_size_Chroma_ver | u(13) |
| tile_overlap_Chroma | u(8) |
| } | |
| } | |
| color_transform_header( ) { | |
| color_transform_enable | u(1) |
| if( color_transform_enable ) | |
| for ( i=0;i<3;i++ ) | |
| for ( j=0;j<3;j++ ) | |
| color_transform_matrix[i][j] | u(8) |
| for ( i=0;i<3;i++ ) | |
| color_transform_offset[i] | u(8) |
| } | |

### 7. (9.3.2) Picture Header Semantics

Following serves information is signalled:
picture_header_size is the number of bytes in the picture header excluding the first two-byte marker;
img_width plus 128 specifies width of an input picture (from 128 to 65600);
img_height plus 128 specifies height of the input picture (from 128 to 65600);
picture_format is a data format of the output picture (YUV420=0, YUV444=1, sRGB=2, YUV422=3);
bit_depth is a bit-depth the output picture (“0” corresponds to 8 and “1” corresponds to 10);
bit_c_ver is one bit value which defines c_ver=1+bit_c_ver, c_ver controls internal subsampling mode of the secondary component in vertical direction as defined in Table 3 and Table 2. If bit_c_ver is not present in bit-stream then c_ver is equal to 2.
bit_c_hor is one bit value which defines c_hor=1+bit_c_hor, c_ver controls internal subsampling mode of the secondary component in vertical direction as defined in Table 3 and Table 2. If bit_c_hor is not present in bit-stream then c_hor is equal to 2.
bit_s_ver is one bit value which defines s_ver which is used for align coding subsampling mode of the secondary component and subsampling mode in output picture format in vertical direction as defined in Table 3. Usage of s_ver is descried in section 7.6 If bit_c_ver is not present in bit-stream then s_ver is equal to 1. bit_s_hor is one bit value which defines c_hor=1+bit_c_hor, c_ver controls internal subsampling mode of the secondary component in vertical direction as defined in Table 3 Usage of s_ver is descried in section 7.6 If bit_c_ver is not present in bit-stream then s_hor is equal to 1.
num_ver_splits_minus1 plus 1 specifies the number of vertical splits. The variable NumVerSplits is derived to be equal to num_ver_splits_minus1+1. The maximum value of NumVerSplits is constrained such that the width of each vertical split shall be greater than or equal to 128 pixels. The maximum value of NumVerSplits may also be further constrained depending on the profile and the level to which the codestream conforms.

The variable VerRegionSize is set equal to (((img_height+127)/128)/NumHorSplits)*128. num_hor_splits_minus1 plus 1 specifies the number of horizontal splits. The variable NumHorSplits is derived to be equal to num_hor_splits_minus1+1. The maximum value of NumHorSplits is constrained such that the height of each horizontal split shall be greater than or equal to 128 pixels. The maximum value of NumHorSplits may also be further constrained depending on the profile and the level to which the codestream conforms.

The picture is partitioned into NumVerSplits*NumHorSplits rectangular regions.

The variable HorRegionSize is set equal to (((img_width+127)/128)/NumVerSplits)*128. The tensor RC[7][NumHorSplits][NumVerSplits][6] array is set as follows:
For d=0 . . . 6, i=0 . . . NumHorSplits−1, j=0 . . . NumVerSplits−1;
   RC[d][i][j][0]=i*VerRegionSize/2^{d}
   RC[d][i][j][1]=(i==NumHorSplits−1)?ceil(Hᵢₙ/2^{d}):(i+1)*VerRegionSize/2^{d}
   RC[d][i][j][2]=j*HorRegionSize/2^{d}
   RC[d][i][j][3]=(j==NumHorSplits−1)?ceil(Wᵢₙ/2^{d}):(j+1)*HorRegionSize/2^{d}
   RC[d][i][j][4]=RC[d][i][j][1]−RC[d][i][j][0]
   RC[d][i][j][5]=RC[d][i][j][3]−RC[d][i][j][2]
For d=0 . . . 6, y=0 . . . ceil(Hᵢₙ/2d)−1, x=0 . . . ceil(Hᵢₙ/2d)−1;
   i=0 . . . NumHorSplits−1, j=0 . . . NumVerSplits−1;
   if y>=RC[d][i][j][0] and y<RC[d][i][j][1] and x>=RC[d][i][j][2] and x<RC[d][i][j][3];
      sample2substrIdx[d][y][x] is set equal to i*NumVerSplits+j
regional_access_enabled_flag equal to 1 specifies that a subset of each rectangular region can be correctly decoded without the presence of coded data of other rectangular regions, where the subset is obtained by shifting the boundaries of the rectangular region towards the inside by the tile overlap size. regional_access_enabled_flag equal to 0 specifies that there may or may not be such a subset of each rectangular region that can be correctly decoded without the presence of coded data of other rectangular regions.

When regional_access_enabled_flag is equal to 1, the following constraints apply:
The value of tile_size_Luma_ver shall be less than or equal to VerRegionSize.
The value of tile_size_Luma_hor shall be less than or equal to HorRegionSize.
(tile_size_Luma_ver+sᵥₑᵣ−1)/sᵥₑᵣ shall be equal to tile_size_Chroma_ver.
(tile_size_Luma_hor+sₕₒᵣ−1)/sₕₒᵣ shall be equal to tile_size_Chroma_hor.
Each luma or chroma sample on a region boundary shall also be on a tile boundary.
independent_region_flag[i][j] equal to 1 specifies that the rectangular region on the i-th row and the j-th column can be correctly decoded without the presence of coded data of other rectangular regions.
independent_region_flag[i][j] equal to 0 specifies that the rectangular region on the i-th row and the j-th column may or may not be correctly decoded without the presence of coded data of other rectangular regions.
num_threads_z_minus1 plus 1 is the number of parallelly decodable sub-stream in the hyper tensor codestream; the maximum value of num_threads_z_minus1 is 127.
num_threads_q_minus1 plus 1 is the number of parallelly decodable sub-stream in the quality map codestream; the maximum value of num_threads_q_minus1 is 127.
num_threads_r_primary_minus1 plus 1 is the number of parallelly decodable sub-stream in primary component residual tensor codestream; the maximum value of num_threads_r_primary_minus1 is 127 and is dependens on profiles and levels.
num_threads_r_secondary_minus1 plus 1 is the number of parallelly decodable sub-stream in secondary component residual tensor codestream; the maximum value of num_threads_r_secondary_minus1 is 127 and is dependens on profiles and levels.
scale_comp[2] are vertical and horizontal ratio between primary and secondary components sizes of coded picture sᵥₑᵣ=scale_comp[0] and sₕₒᵣ=scale_comp[1]; if not present (res_changer_enable=false) then sᵥₑᵣ=2 and sₕₒᵣ=2. Allowed values are listed in Table 3.
independent_beta_uv is a flag (false/true) which indicates do the rate control parameter (β) for primary and secondary components are the same.
beta_displacement_log_y—parameter indicating ratio between rate control parameter beta selected by encoder for primary component and one used in the model training.
betaDisplacementLogY=beta displacement_log_y−2¹¹
beta_displacement_log_uv—parameter indicating ratio between rate control parameter beta selected by encoder for secondary component and one used in the model training.
betaDisplacementLogUV=beta displacement_log_uv−2¹¹
model_id is an identificator of pre-stored checkpoint with model's weights, model_id=0, 1, 2, 3 or 4. opIdx is an identificator for operation point, 0 means “base”, 1 means “high” operation point.
tile_enable_Luma and tile_enable_Chroma are enable flags for tiling of primary and secondary components.
tile_size_Luma_ver and tile_size_Chroma_ver are the sizes of tiles for primary and secondary components in the vertical direction.
tile_size_Luma_hor and tile_size_Chroma_hor are the sizes of tiles for primary and secondary components in the horizontal direction.
tile_overlap_Luma and tile_overlap_Luma are sizes of tiles overlapping areas for primary and secondary components.
cube_group_flag is 1-bit unsigned integer. cube_group_flag=0 indicates no cube_flag is signalled in one group, and cube flags of one group are set to be 1. cube_group_flag=1 indicates cube flags of one group are signaled.
cube_luma_flag is 1D array of size ((h_{4,Y}+7)>>3)·((w_{4,Y}+7)>>3), which contains cube flags for primary component. 1 indicates Skip Mode is applied to one cube of residual tensor of primary component \hat{r}_{Y}. 0 indicates Skip Mode is disable for one cube of residual tensor of primary component \hat{r}_{Y}.
cube_chroma_flag is 1D array of size ((h_{4,UV}+7)>>3)·((w_{4,UV}+7)>>3), which contains cube flags for secondary component. 1 indicates Skip Mode is applied to one cube of residual tensor of secondary component \hat{r}_{UV}. 0 indicates Skip Mode is disable for one cube of residual tensor of secondary component \hat{r}_{UV}.
color_transform_enable is an enable flag for color convertion module.
color_transform_matrix[i][j] is a matrix of color convertion. If not present (color_transform_enable is false) then default ITU-R BT.709 colour transform is used (refer to section 7.8).
color_transform_offset[i] is an offset for color transformation If not present (color_transform_enable is false) then default ITU-R BT.709 colour transform is used (refer to section 7.8).

8. (9.5.1.1) Syntax table of hyper tensor

| | Descriptor |
|---|---|
| z stream_for_one_region(substrIdx) { | |
| z_stream size | u(24) |
| for (i =1; i <= num_threads_z_minus1; ++i) { | |
| thread_offsets_z[i] | u(24) |
| } | |
| for (i =0; i <= num_threads_z_minus1; ++i) { | |
| sub_stream[i]=sub_stream_init(i, num_threads_z_minus1+1, thread_offsets_z, z_stream_size) | |
| } | |
| for (ch =0; ch < z_primary_ch; ++ch) { | |
| for (i =0; i <= num_threads_z minus1; ++i) { | |
| decode_z_data(sub_stream[i], z_primary[substrIdx] [ch][], ch, RC[6][i][j][5],, | |
| RC[6][i][j][4], i, num_threads_z_minus1+1) | |
| } | |
| } | |
| for (ch =0; ch < z_secondary_ch; ++ch) { | |
| for (i =0; i <= num_threads_z_minus1; ++i) { | |
| decode_z_data(sub_stream[i], z_secondary[substrIdx][ch][], ch, RC[6][i][j][5], | |
| RC[6][i][j][4], i, num_threads_z_minus1+1) | |
| } | |
| } | |
| } | |

### 9. (9.5.2) Quality Map Information Decoder

The input of this process is
Codestream for quality map;
Indicators for sigma tables which are decoded in picture header:
   quality_map_entropy_index_y for primary component.
   quality_map_entropy_index_uv for secondary component.

The output of this process is
quality_map_delta_Y is an array of size [w_{4Y}, h_{4Y}] with information used for deriving scaling factor (section 12.2) for primary component residual tensor.
quality_map_delta_UV is an array of size [w_{4UV}, h_{4UV}] with information used for deriving scaling factor (section 12.2) for secondary component residual tensor.

Here sizes [w_{4Y}, h_{4Y}] and [w_{4UV}, h_{4UV}] are defined in Table 2.
q_primary_sigma_Idx is a 2D array of size [numHorSplits*numVerSplits][ ], and each element in this array is equal to q_sigma_Idx[quality_map_entropy_index_y], where the q_sigma_Idx[k] is derived according to Table 4.
q_secondary_sigma_Idx is a 2D array of size [numHorSplits*numVerSplits][ ], and each element in this array is equal to q_sigma_Idx[quality_map_entropy_index_uv].
q_primary is a 2D array of size [numHorSplits*numVerSplits][ ], q_secondary is a 2D array of size [numHorSplits*numVerSplits][ ].
quality_map_delta_Y and quality_map_delta_UV are determined by determined by:
   for y=0 . . . NumHorSplits and x=0 . . . NumVerSplits
      k is set equal to 0.
      For i=RC[4][y][x][0] . . . RC[4][y][x][1]−1,
         j=RC[4][y][x][2] . . . RC[4][y][x][3]−1
         quality_map_delta_UV[i, j]=q_secondary[y*NumVerSplits+x][k]
         quality_map_delta_Y[i, j]=q_primary[y*NumVerSplits+x][k]
         k=k+1

TABLE 4
Determining q_sigma_Idx for quality map delta decoding

| | k | | | | | | | |
|---|---|---|---|---|---|---|---|---|
| | 0 | 1 | 2 | 3 | 4 | 5 | 6 | 7 |
| q_sigma_Idx[k] | 0 | 4 | 5 | 6 | 8 | 10 | 14 | 18 |

10. (9.5.2.1) Syntax table of quality map information tensor

| | Descriptor |
|---|---|
| q_stream_for_one_region(substrIdx) | |
| q_stream_size | u(24) |
| for (i =1; i <= num_threads_q_minus1; ++i) { | |
| thread_offsets_q[i] | u(24) |
| } | |
| for (i =0; i <= num_threads_q_minus1; ++i) { | |
| sub_stream[i]=sub_stream_init(i, num_threads_q_minus1+1, thread_offsets_q, | |
| q_stream_size) | |
| } | |
| for (i =0; i <= num_threads_q_minus1; ++i) { | |
| decode_r_data(sub_stream[i], q_primary[substrIdx][ ], | |
| q_primary_sigma_Idx_2D[substrIdx][ ], i, num_threads_q_minus1+1) | |
| } | |
| for (i =0; i <= num_threads_q_minus1; ++i) { | |
| decode_r_data(sub_stream[i], q_secondary[substrIdx][ ], q_secondary_sigma_Idx_2D | |
| [substrIdx][ ], i, num_threads_q_minus1+1) | |
| } | |
| } | |

### 11. (9.5.3) Primary Residual Stream Decoder

The input of this process is
Primary component residual codestream;
mask_skip[Cₚ, h_{4Y}, W_{4Y}] generated by Skip Mask generation (section 13.3.2) for primary component;
sigma_Idx_primary—tensor of size [Cₚ, h_{4Y}, W_{4Y}] which is the output of Sigma quantization (section 10.8) for primary component.
The output of this process is
r_primary—one dimensional array {s} of residual tensor elements which is an input of decoder skip process (section 13.3.4) for primary component.

Here sizes Cₚ, w_{4Y}, h_{4Y} are defined in Table 2. A one dimensional array sigma_Idx_primary_1D is determined though following steps:
Set count[NumVerSplits*NumHorSplits] equal to all zeros,
For c=0 . . . Cₚ−1,
   For i=0 . . . h_{4Y}−1,
      For j=0 . . . w_{4Y}−1
         subIdx=sample2SubstrIdx(4, i, j)
         if mask_skip[c,i,j] is equal to True, sigma_Idx_primary_2D[subIdx][count[subIdx]] is set to equal to sigma_Idx_primary[c,i,j] and increase count[subIdx] by 1.

12. (9.5.3.1) Syntax table of primary residual tensor

| | Descriptor |
|---|---|
| r_primary_stream_for_one_region(substrIdx) { | |
| r_primary_stream_size | u(32) |
| for (i =1; i <= num_threads_r_primary_minus1; ++i) { | |
| thread_offsets_r_primary[i] | u(32) |
| } | |
| for (i=0; i <= num_threads_r_primary_minus1; ++i) { | |
| sub_stream[i]=sub_stream_init(i, num_threads_r_primary_minus1+1, | |
| thread_offsets_r_primary, r_primary_stream_size) | |
| decode_r_data(sub_stream[i], r_primary[substrIdx][ ], sigma_Idx_primary_2D[substrIdx][ ], | |
| i, num_threads_r_primary_minus1+1) | |
| } | |
| } | |

### 13. (9.5.4) Secondary Residual Stream Decoder

The input of this process is
Codestream for secondary component residual;
mask_skip[Cₛ, h_{4UV}, w_{4UV}] generated by Skip Mask generation (section 13.3.2) for secondary component;
sigma_Idx_secondary—tensor of size [Cₛ, h_{4UV}, w_{4UV}] which is the output of Sigma quantization (section 10.8) for secondary component.
The output of this process is
r_secondary—one dimensional array {s} of residual tensor elements which is an input of decoder skip process (section 13.3.4) for secondary component.

Here sizes Cₛ, h_{4UV}, w_{4UV} are defined in Table 2. A one dimensional array sigma_Idx_secondary_1D is determined though following steps:
Set count1[NumVerSplits*NumHorSplits] equal to all zeros
For c=0 . . . Cₚ−1,
   For i=0 . . . h_{4Y}−1,
      For j=0 . . . w_{4Y}−1
         subIdx=sample2SubstrIdx(4,i,j)
         if mask_skip[c,i,j] is equal to True, sigma_Idx_secondary_2D[subIdx][count[subIdx]] is set to equal to sigma_Idx_secondary[c,i,j] and increase count[subIdx] by 1.

14. (9.5.4.1) Syntax table of secondary residual tensor

| | Descriptor |
|---|---|
| r_secondary_stream_for_one_region (substrIdx) { | |
| r_secondary_stream_size | u(24) |
| for (i =1; i <= num_threads_r_secondary_minus1; ++i) { | |
| thread_offsets_r_secondary[i] | u(24) |
| } | |
| for (i=0; i <= num_threads_r_secondary_minus1; ++i) { | |
| sub_stream[i]=sub_stream_init(i, num_threads_r_secondary_minus1+1, | |
| thread_offsets_r_secondary, r_secondary_stream_size) | |
| decode_r_data(sub_stream[i], r_secondary[substrIdx] [ ], | |
| sigma_Idx_secondary_2D[substrIdx] [ ], i, num_threads_r_secondary_minus1+1) | |
| } | |
| } | |

15. (10.3) Hyper Latent Tensor Reconstruction Input of this process is reconstructed z_primary and z_secondary tensors.

Output of this process is 2[C, h₆, W₆] reconstructed hyper tensor.
The following ordered steps are applied:
s tensor is set equal to z_primary if primary component is being processed, or z_secondary tensor if secondary component is being processed.
k is set equal to 0.
for y=0 . . . NumHorSplits and x=0 . . . NumVerSplits
   k=0
   For c=0 . . . C−1
      For i=RC[6][y][x][0] . . . RC[6][y][x][1]−1,
         j=RC[6][y][x][2] . . . RC[6][y][x][3]−1
         \hat{z}[c,i,j]=s[y*NumVerSplits+x][c][k] and k=k+1

### 16. (10.4) Hyper Scale Decoder

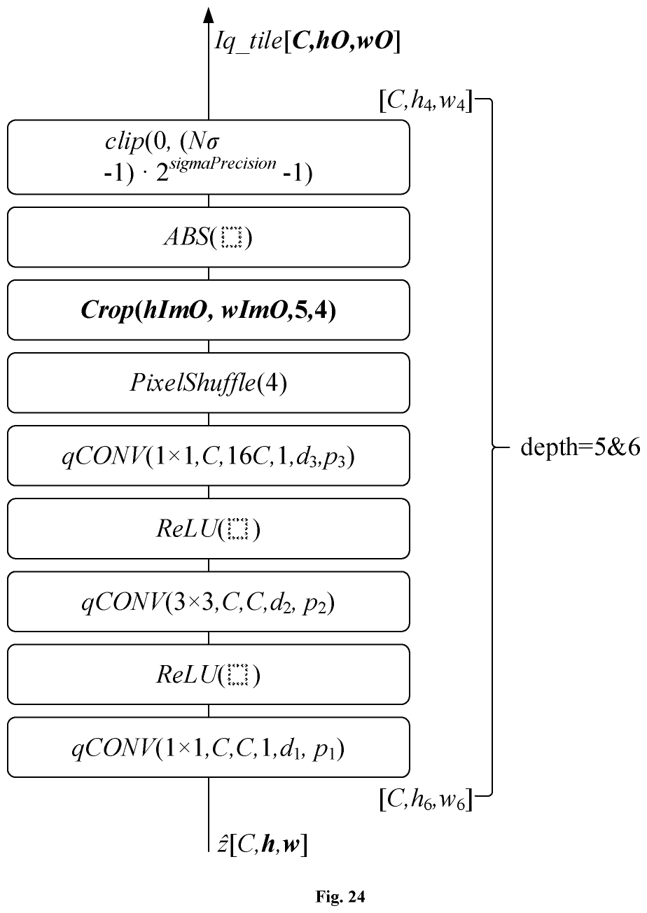

Hyper scale decoder net is depicted in FIG. 24.

The input of hyper scale decoder is
\hat{z}[C, h₆, w₆] reconstructed hyper tensor,
sizes of input/output tensor Hᵢₙ, Wᵢₙ,
operation point indicator opIdx,
model parameters for Hyper Scale Decoder Net defined by pair (modelIdx, opIdx), all multiplier parameters in those models are 8-bits integer.

The output of hyper scale decoder is standard deviation logarithm tensor I_{σ}[C,h₄,w₄] with integer values in a range 0≤I_{σ}<((N_{σ}−1)<<sigmaPrecision), where N_{σ}, sigmaPrecision are defined in section 0. Sizes of those tensors for primary and secondary components are listed in Table 2. All operation in scalable hyper decoder are integer, an accumulator in all computations is within 32 bits integer diapason, multipliers in model parameters are quantized to 8-bits integer. This guarantees bit-exact behaviour of this neural network module. Hyper scale decoder uses special type of operations quantized convolutions. For each quantized convolution in the process the set of clipping values {dₖ} and de-scaling shifts parameters {pₖ}(1≤k≤3) are specified for each channel. All clipping values in quantized convolutions are dₖ=2⁷. De-scaling shifts {pₖ} are provided in section 15.6.
NOTE—the magnitude of integerized weights in quantized model doesn't exceed 2⁷, shift and clipping value combination ensures the register of quantized convolution is within 32-bits.

The sequence of operations in this module doesn't depend on operation point indicator (opIdx), but model parameters are different for base and high operation point.

Hyper scale decoder starts with quantized convolution kernel size 1×1, stride 1, followed by rectified linear unit. Then there is a stride 1 quantized convolution with kernel size 3×3, followed by rectified linear unit. The next stride 1 quantized convolution (kernel size 1×1) increases the number of channels to 16C. It is followed by pixel shuffle (stride 4), which brings number of channels back to C. The cropping layer (stride 4, depth 5) ensures the size of output tensor is [C,h₄,w₄]. The process concluded with abs operation.

The hyper decoder operation is applied in tiled manner. The following are the processing:
for Vtile=0 . . . NumHorSplits−1 and Htile=0 . . . NumVerSplits−1
   ext=independent_region_flag[Vtile][Htile]?1:0
   pad_{left}=ext if Htile>0 else 0
   pad_{right}=ext if Htile<NumVerSplits−1 else 0
   padₜₒₚ=ext if Vtile>0 else 0
   pad_{bottom}=ext if Vtile<NumHorSplits−1 else 0
   y=RC[6][Vtile][Htile][0]−padₜₒₚ
   x=RC[6][Vtile][Htile][1]−pad_{left}
   yO=RC[4][Vtile][Htile][0]
   xO=RC[4][Vtile][Htile][1]
   yE=RC[4][Vtile][Htile][2]
   xE=RC[4][Vtile][Htile][3]
   h=RC[6][Vtile][Htile][4]+padₜₒₚ+pad_{bottom}
   w=RC[6][Vtile][Htile][5]+pad_{left}+pad_{right}
   hO=RC[4][Vtile][Htile][4]+padₜₒₚ*4+pad_{bottom}*4
   wO=RC[4][Vtile][Htile][5]+pad_{left}*4+pad_right*4
   hImO=RC[0][Vtile][Htile][4]+padₜₒₚ*64+pad_{bottom}*64
   wImO=RC[0][Vtile][Htile][5]+pad_{left}*64+pad_{right}*64
   the tensor part \hat{z}[C, y . . . y+h−1, x . . . x+w−1] is fed into the hyper scale decoder to obtain the tensor Iqₜᵢₗₑ[C, hO, wO]
   I_{σ}[C, yO . . . yE−1, xO . . . xE−1]=Iqₜᵢₗₑ[C, padₜₒₚ*4 . . . RC[4][Vtile][Htile][4]+padₜₒₚ−1, pad_{left}*4 . . . RC[4][Vtile][Htile][5]+pad_{left}+1].

Model with weights are storied in electronic attachment, in format specified in section 4.8 and locates in <oper_point>/model_<MID>/<COMP>/hyper_scale_decoder.onnx, where <oper_point> is “base” or “high”, <MID> is an integer from 0 to 5, <COMP> is “primary” or “secondary”.

### 17. (11.2) Hyper Decoder

The learning-based hyper decoder consists of two independent pipe-lines with identical neural network architecture, except input size and number of channels.
The input of this process is
[C, h_{b}, w_{b}] reconstructed hyper latent tensor,
model parameters for Hyper Decoder Net defined by (modelIdx),
operation point indicator opIdx.

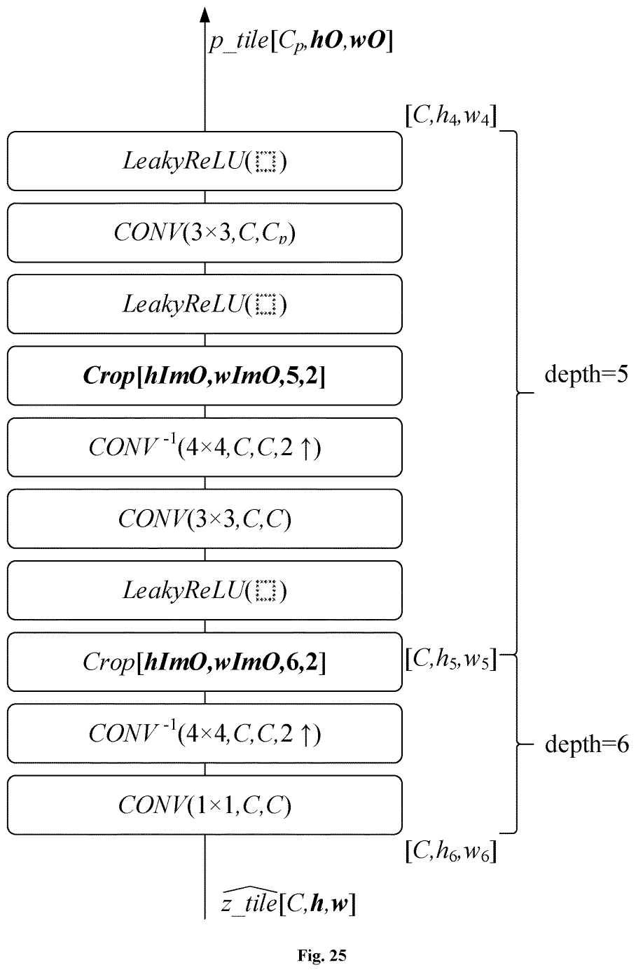

The output of this process is
p[Cₚ, h₄, w₄] is explicit prediction (part of prediction tensor derived from explicitly signalled information), with channels size Cₚ=(opIdx+1)C.
Hyper decoder process is depicted in FIG. 25.

Hyper decoder starts stride 1 convolution with kernel size 1×1, followed by inverse convolution (stride 2, kernel size 4×4), cropping layer (depth 6) and leacky rectified linear unit. Next step is stride 1 convolution with kernel size 3×3, followed by inverse convolution (stride 2, kernel size 4×4), cropping layer (depth 5) and leacky rectified linear unit. Number of channels kep un-changed till this point (equal to number of channels C of input tensor). Hyper decoder concluded by stride 1 convolution with kernel size 3×3 which increases number of channels to 2C for high operation point and keeps number fo channes unchanged for base operation point followed by leacky rectified linear unit.

The hyper decoder operation is applied in tiled manner. The following are the processing:
for Vtile=0 . . . NumHorSplits−1 and Htile=0 . . . NumVerSplits−1
   ext=independent_region_flag[Vtile][Htile]?1:0
   pad_{left}=ext if Htile>0 else 0
   pad_{right}=ext if Htile<NumVerSplits−1 else 0
   padₜₒₚ=ext if Vtile>0 else 0
   C pad_{bottom}=ext if Vtile<NumHorSplits−1 else 0
   y=RC[6][Vtile][Htile][0]−pad_top
   x=RC[6][Vtile][Htile][1]−pad_left
   yO=RC[4][Vtile][Htile][0]
   xO=RC[4][Vtile][Htile][1]
   h=RC[6][Vtile][Htile][4]+pad_top+pad_bottom
   w=RC[6][Vtile][Htile][5]+pad_left+pad_right
   hO=RC[4][Vtile][Htile][4]+pad_top*4+pad_bottom*4
   wO=RC[4][Vtile][Htile][5]+pad_left*4+pad_right*4
   hImO=RC[0][Vtile][Htile][4]+pad_top*64+pad_bottom*64
   wImO=RC[0][Vtile][Htile][5]+pad_left*64+pad_right*64
   the tensor part \hat{z}[C, y . . . y+h−1, x . . . x+w−1] is fed into the hyper decoder to obtain the tensor p_tile[Cₚ, hO, wO]
   p[Cₚ, yO . . . RC[4][Vtile][Htile][1]−1, xO . . . RC[4][Vtile][Htile][3]−1]=p_tile[Cₚ, padₜₒₚ*4 . . . RC[4][Vtile][Htile][4]+padₜₒₚ−1, pad_{left}*4 . . . RC[4][Vtile][Htile][5]+pad_{left}+1].

Model with weights are storied in electronic attachment, in format specified in section 4.8 and locates in <oper_point>/model_<MID>/<COMP>/hyper_decoder.onnx, where <oper_point> is “base” or “high”, <MID> is an integer from 0 to 5, <COMP> is “primary” or “secondary”.

### 18. (11.3) Latent Tensor Reconstruction Process

The input of this process is
operation point indicator opIdx,
\hat{r}[C,h₄,w₄] reconstructed residual tensor, which is an out out of SKIP Model process (13.3.4),
p[Cₚ, h₄, w₄] explicit prediction, with channels size Cₚ=(opIdx+1)C, which is an output of Hyper
Decoder (11.2),
The output of this process is
ŷ′[C,h₄,w₄] reconstructed latent tensor.
The process is as follows.
If opIdx==0 (base operation point) then multi-stage context modelling process is by-passed,
explicit prediction is added to residual ŷ′=\hat{r}+p[0:C−1,h₄,w₄]:

If opIdx==1 (high operation point) then:
Multi-stage Context Modelling process (section 11.4) is used.

### 19. (11.4) Tiled Multistage Context Modelling

The input of this process is
\hat{r}[C,h₄,w₄] reconstructed residual tensor, which is an out out of SKIP Model process (13.3.4),
p[2C,h₄,w₄] explicit prediction, which is an output of Hyper Decoder (11.2),
Eight MCMₖ, k=0, . . . 7 models with parameters defined by (modelIdx, k).

The output of this process is
ŷ′[C,h₄,w₄] reconstructed latent tensor.
μ[C,h₄,w₄] reconstructed latent tensor.

The following steps are applied:
for Vtile=0 . . . NumHorSplits−1 and Htile=0 . . . NumVerSplits−1
   ext=independent_region_flag[Vtile][Htile]?8:0
   pad_{left}=ext if Htile>0 else 0
   pad_{right}=ext if Htile<NumVerSplits−1 else 0
   padₜₒₚ=ext if Vtile>0 else 0
   pad_{bottom}=ext if Vtile<NumHorSplits−1 else 0
   y=RC[4][Vtile][Htile][0]−pad_top
   x=RC[4][Vtile][Htile][1]−pad_left
   h=RC[4][Vtile][Htile][4]+pad_top+pad_bottom
   w=RC[4][Vtile][Htile][5]+pad_left+pad_right
   Multistage Context Modelling subsection is invoked with \hat{r}[C, y . . . y+h−1, x . . . x+w−1] and p[2C, y . . . y+h−1,x . . . x+w−1] as inputs and ŷ′_tile[C,h,w] and p_tile [C, h, w] as outputs.
   ŷ′[C,y . . . RC[4][Vtile][Htile][1]−1, x . . . RC[4][Vtile][Htile][3]−1]=ŷ′_tile[C, padₜₒₚ . . . RC[4][Vtile][Htile][4]+padₜₒₚ−1, pad_{left} . . . RC[4][Vtile][Htile][5]+pad_{left}−1]
   μ[C,y . . . RC[4][Vtile][Htile][1]−1, x . . . RC[4][Vtile][Htile][3]−1]=y_tile[C, padₜₒₚ . . . RC[4][Vtile][Htile][4]+padₜₒₚ−1, pad_{left} . . . RC[4][Vtile][Htile][5]+pad_{left}−1].

### 20. (11.5) Multistage Context Modelling

The input of this process is
\hat{r}[h, w] reconstructed residual tensor, which is an out out of SKIP Model process (13.3.4),
p[2C, h, w] explicit prediction, which is an output of Hyper Decoder (11.2),
Eight MCMₖ, k=0, . . . 7 models with parameters defined by (modelIdx, k).

The output of this process is
ŷ′_tile [C, h, w] reconstructed latent tensor.

The process consists of following steps:
h2 and w2 are set equal to (h+1)/2, (w+1)/2 respectively.
padding layer (depth 5, stride 2) and down-shuffle (11.5.1) M=2 of explicit prediction tensor p[2C, h, w] to \ddot{p}[8C, h2, w2] re-shaped prediction tensor,
padding layer (depth 5, stride 2) and down-shuffle (11.5.1) M=1 of reconstructed residual \hat{r}[C, h, w] to \ddot{r}[4C, h2, w2] re-shaped residual tensor,
split \ddot{p}[8C, h2, w2] into four parts \ddot{p}ₗ=\ddot{p}[2lC:2(l+1)C−1,h2, w2],l=0, . . . , 3 (each parts consists of 2C out of 8C channels),
split \ddot{r}[4C, h2, w2] into eight parts \ddot{p}ₗ=\ddot{p}[kC/2:(k+1)C/2−1, h2, w2], k=0, . . . , 7 (each parts consists of C/2 out of 4C channels),
For k=0, . . . , 3,
   MCM(k) process which
      takes as an input
         {ÿₘ}, m=0, . . . , k−1 previously reconstructed parts of re-shaped latent space tensor,
         \ddot{r}ₖ—collocated part of reconstructed residual tensor,
         \ddot{p}_{k%4}—part of re-shaped explicit prediction tensor,
      outputs
         produces ÿₖ=ÿ[kC/2:(k+1)C/2−1, h2, w2],
Channel net process (11.5.4) over ÿ[0:(2C−1, h2, w2] tensor,
For k=3, . . . , 7,
   MCM(k) process which
      takes as an input
         {ÿₘ}, m=0, . . . , k−1 previously reconstructed parts of re-shaped latent space tensor,
         \ddot{r}ₖ—collocated part of reconstructed residual tensor,
         \ddot{p}_{k%4}—part of re-shaped explicit prediction tensor,
      outputs
         produces

$${\ddot{y}}_{k} = \ddot{y} [ \frac{k C}{2} : \frac{( k + 1 ) C}{2} - 1 , h 2 , w 2 ] .$$

up-shuffle (11.5.2) M=2 and cropping layer (h,w) ÿ[4C, h2, w2] to ŷ′_tile[C, h, w].
up-shuffle (11.5.2) M=2 and cropping layer (h,w) \ddot{μ}[4C, h2, w2] to μ_tile[C, h, w](to be further used in LSBS process 13.4.2).

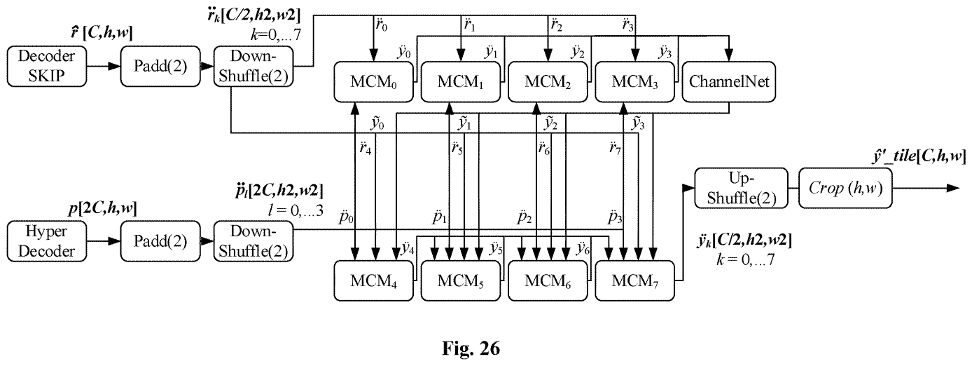

Multi-stage context modelling process is depicted in FIG. 26. This is a recurrent process: later stages uses previously obtained elements of output tensor as an input. Data flow which corresponds usage of previous stages output is marked with arrows in FIG. 26.

Models with weights are storied in electronic attachment, in format specified in section 4.8 and locates in high/model_<MID>/<COMP>/MCM/stage<N>.onnx, where <MID> is an integer from 0 to 5, <COMP> is “primary” or “secondary”, <N> is a number of MCM's stage from 0 to 7.

### 21. (13.3.4) Decoder Side SKIP Operation

At the decoder, the inputs of skip mode process are

1D array s[num_res_elements] after decoding by me-tANS (section 9.5.2) to from the “stream−y”,
mask_skip[C,h₄,w₄].

The output of this process is
the residual tensor \hat{r}[C,h₄,w₄].

The output of the lossless decoding process is a 1D array {sₖ}, whose size is equal to the total number of “1”s in the mask_skip [C,h₄,w₄] tensor.

In other words, the mask_skip [C,h₄,w₄] tensor determines which samples of the residual tensor \hat{r} are included in the bitstream. All of the other samples of the quantized residual tensor are inferred to be equal to zero.

The process of residual skip mode at the decoder is as follows:
Dimensions [C,h₄,w₄] are set equal to number of channels, height and width of the sigma tensor σ (Table 2).
Tensors \hat{r}[C,h₄,w₄] is initialized to be equal to all zeros.
The counter k=0.
The following ordered steps are applied:
for Vtile=0 . . . NumHorSplits−1 and Htile=0 . . . NumVerSplits−1
   k=0
   i=RC[4][Vtile][Htile][0] . . . RC[4][Vtile][Htile][1]−1,
      j=RC[4][Vtile][Htile][2] . . . RC[4][Vtile][Htile][3]−1
         For c=0 . . . C−1,
         If mask_skip [c,i,j] is equal to 1, \hat{r}[c,i,j]=(s[sample2SubStrIdx[4,i,j]][k]−2¹⁶⁻¹+1), k=k+1.
         Otherwise \hat{r}[c,i,j]=0.

### 22. (14.1.1)) Inter Channel Correlation Information Filter Tiling and Output Selection Process

The ICCI filter processes the input in tiles using the same method described in Section 8.4. The tile size icci_tile_size and tile overlap icci_tile_overlap are same for the primary (Luma) and secondary (Chroma) components and signalled in picture header (Section 9.3). The ratio r between input domain size and output tensor size is fixed to 1 for each component. The minimum tile size is limited to 176 for the stable computation of the model selection explained next.

In total, 10 ICCI filters are included into the design. In each tile tileID for each color component comp=0 . . . 2 (“0”-“y”, “1”-“u”, “2”-“v”) the filter is selected based on icci_model_idx[comp][tileID] value which is coded in picture header (Section 9.3). In case icci_model_idx=0, the ICCI processing is bypassed.

The ICCI process is applied in a region based manner. When processing a sample (y,x) firstly the following parameters are set:
Vtile and Htile are set equal to the vertical and horizontal coordinates of the region that the sample at (y,x) belongs.
If indepdent_region_flag[Vtile][Htile] equal to 1;
   ymin=RC[2−sᵥₑᵣ][Vtile][Htile][0]
   ymax=RC[2−sᵥₑᵣ][Vtile][Htile][2]−1
   xmin=RC[2−sₕₒᵣ][Vtile][Htile][1]
   xmax=RC[2−sₕₒᵣ][Vtile][Htile][3]−1
Else;
   ymin and xmin are set equal to zero, ymax and xmax are set equal to H_{UV}−1 and W_{UV}−1 respectively.

When processing the sample at (y,x), only the input samples within the boundaries of xmin, xmax, ymin and ymax are used. The region is extended at the boundaries using replication padding.

### 23. (14.2) Adaptive Upsampler

This section details the primary component guided adaptive upsampler process. This process provides enhancement of secondary components (colour information planes) of image utilising information from primary component.

This process is enabled if EFE_upsampler_enabled_flag is true.
The input of this process is
\hat{x}_{Y}[1, H_{Y}, W_{Y}](output of synthesis transfor for primary component),
\hat{x}_{UV} [2, H_{inUV}, W_{inUV}](output of synthesis transfor for secondary component),
The output of this process is
enhanced secondary component \hat{x}′_{UV} [2, H_{UV}, W_{UV}] which goes to the ICCI filter block (section 14.1) and \hat{x}″_{UV} [2, H_{UV}, W_{UV}] which goes to the non-linear filter block (section 14.3).

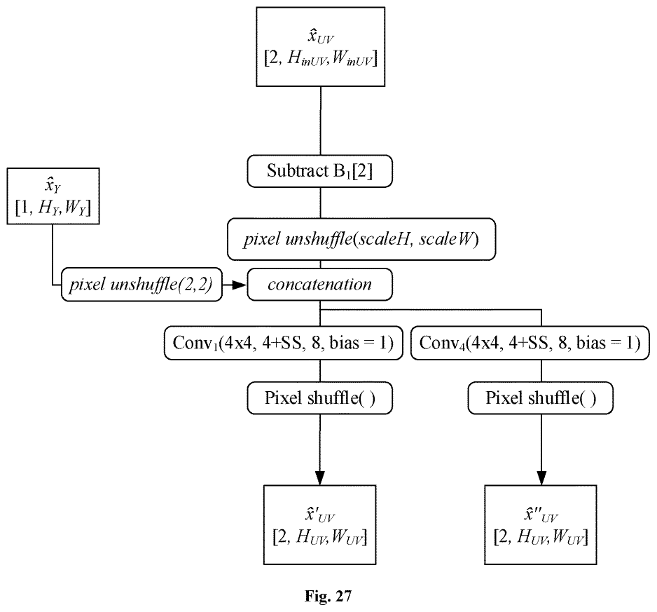

FIG. 27 illustrates an example implementation of primary component guided adaptive up-sampling filter.

If EFE_upsampler_enabled_flag is equal to 0, the \hat{x}′_{UV}[2,H,W] is up-sampled by bi-cubic interpolation as described in section 7.6. Otherwise the following ordered steps are performed:
The parsing process according to parsing table in section 9.4.1. is invoked to obtain W_{1A}, W_{1B}, W_{4A}, W_{4B} and B₁.
Tiling process is as described in section 14.2.2 is invoked with parsed syntax elements as inputs and Tile1 tensor as output.
Parameter update process as specified in section Section 14.2.1. is invoked with W_{4A} and W_{1A} as inputs and modified W_{4A} and W_{1A} as outputs.
B₁[2] is vector is subtracted channelwise from \hat{x}′_{UV}[2, H_{inUV}, W_{inUV}].

$$U [ 2 \cdot {scale}_{ν e r} \cdot {scale}_{h o r} , \frac{H + 1}{2} , \frac{W + 1}{2} ] and Y [ 4 , \frac{H + 1}{2} , \frac{W + 1}{2} ]$$

are set equal to pixelUnshuffle(\hat{x}′_{UV}, scaleᵥₑᵣ, scaleₕₒᵣ) and pixelUnshuffle(\hat{x}′_{Y}, 2,2) respectively.
for Vtile=0 . . . NumHorSplits−1 and Htile=0 . . . NumVerSplits−1
   for x=RC[1][Vtile][Htile][1] . . . RC[1][Vtile][Htile][3]−1, y=RC[1][Vtile][Htile][0] . . . RC[1][Vtile][Htile][2]−1, k=0 . . . 1, i=0 . . . oᵥₑᵣ−1, j=0 . . . oₕₒᵣ−1 the following is performed:
      ch=4k+2i+j
      chₒᵤₜ=k·oᵥₑᵣ·oₕₒᵣ+oₕₒᵣ·i+j
      chᵢₙ=k·scaleᵥₑᵣ·scaleₕₒᵣ+scaleₕₒᵣ·(i % scaleᵥₑᵣ)+(j % scaleₕₒᵣ)
      t_{idx}=Tile1[k, y,x]
      If indepdent_region_flag[Vtile][Htile] equal to 1;
         ymin=RC[1][Vtile][Htile][0]
         ymax=RC[1][Vtile][Htile][2]−1
         E xmin=RC[1][Vtile][Htile][1]
         xmax=RC[1][Vtile][Htile][3]−1
      Else;
         ymin and xmin are set equal to zero, ymax and xmax are set equal to

$$\frac{H + 1}{2} - 1 and \frac{W + 1}{2} - 1$$

respectively.
U′[chₒᵤₜ,y,x]=U[chᵢₙ,y,x]*W_{4A}[t_{idx},ch]+Y[2i+j,y,x]*W_{4B}[t_{idx},k]+B₁[k]
U′[chₒᵤₜ, y, x]=U[chᵢₙ, y, x]*W_{1A}[0, ch]+Y[2i+j, y, x]*W_{1B}[0, k]+B₁[k]
\hat{x}′_{UV}[2,H_{UV},W_{UV}] and \hat{x}″_{UV}[2,H_{UV},W_{UV}] are set equal to pixelshuffle(U′, oᵥₑᵣ, oₕₒᵣ) and pixelshuffle(U″, oᵥₑᵣ, oₕₒᵣ) respectively.
Where “*” is 2D cross-correlation operator with kernel size 4×4:

$$b ★ a = {\sum }_{j = - 1}^{j = 2} {\sum }_{i = - 1}^{i = 2} b [ clip ( y min , y max - 1 , y + i ) , \\ clip ( x min , x max , x + j ) ] a [ i + 1 , j + 1 ] .$$

### 24. (14.4.1) LEF General Process

LEF process receives primary variance tensor \hat{σ}_{Y}[Cₚ, h_{4,Y}, W_{4,Y}] and reconstructed primary \hat{x}′_{Y}[1,H,W] as inputs. The output of LEF process is edge enhanced modified \hat{x}′_{Y}[1,H,W].

The following ordered steps are performed:
Picture header parsing process is invoked as described in section Section 9.3. to obtain targetBppIdx.
chIdx is set equal to reference_channel_idx_table[tagetBppIdx].
The

$${\hat{σ}}_{Y \_ channel}^{1} [ 1 , {H}_{Y} , {W}_{Y} ]$$

tensor is obtained as follows, for i=0 . . . H_{Y}−1, j=0 . . . W_{Y}−1;

$${\hat{σ}}_{Y \_ channel}^{1} [ 0 , i , j ] = {\hat{σ}}_{Y} ( chIdx , floor ( i \cdot {h}_{4 , Y} \div {H}_{Y} ) , floor ( i \cdot {w}_{4 , Y} \div {W}_{Y} )$$

thr[3]=luma_edge_filter_thr_list_table [targetBppIdx]
intensity[4]=luma_edge_filter_intensity_list [targetBppIdx]

$$⌊ {\hat{x}}_{Y}^{′} = {\hat{x}}_{Y}^{′} \div 255$$

for Vtile=0 . . . NumHorSplits−1 and Htile=0 . . . NumVerSplits−1
   If indepdent_region_flag[Vtile][Htile] equal to 1;
      ymin=RC[0][Vtile][Htile][0]
      ymax=RC[0][Vtile][Htile][2]−1
      xmin=RC[0][Vtile][Htile][1]
      xmax=RC[0][Vtile][Htile][3]−1
   Else;
      ymin and xmin are set equal to zero, ymax and xmax are set equal to

$$\frac{H + 1}{2} - 1 and \frac{W + 1}{2} - 1$$

respectively.
for x=RC[0][Vtile][Htile][1] . . . RC[0][Vtile][Htile][3]−1, y=RC[0][Vtile][Htile][0] . . . RC[0][Vtile][Htile][2]−1, k=0 . . . 1, i=0 . . . oᵥₑᵣ−1, j=0 . . . oₕₒᵣ−1 the following is performed:
   \hat{x}_{blur}[0, y, x]=\hat{x}′_{Y}*kernel

Where “*” is 2D cross-correlation operator with kernel size 3×3:

$$b ★ a = {\sum }_{j = - 1}^{j = 2} {\sum }_{i = - 1}^{i = 2} b [ clip ( y min , y max - 1 , y + i ) , \\ clip ( x min , x max , x + j ) ] a [ i + 1 , j + 1 ] .$$

\hat{x}_{edge}=\hat{x}′_{Y}−\hat{x}_{blur}

$${\hat{σ}}_{Y \_ channel}^{1} [ 1 , {H}_{Y} , {W}_{Y} ] = {\hat{σ}}_{Y \_ channel}^{1} [ 1 , {H}_{Y} , {W}_{Y} ] \div 8190$$

For i=0 . . . H_{Y}−1, j=0 . . . W_{Y}−1;

$$tIdx = \{ \begin{matrix}0 , & {\hat{σ}}_{{Y}_{channel}}^{1} [ 0 , i , j ] < thr [ 0 ] \\ 1 , & thr [ 0 ] \leq {\hat{σ}}_{{Y}_{channel}}^{1} [ 0 , i , j ] < thr [ 1 ] \\ 2 , & thr [ 1 ] \leq {\hat{σ}}_{{Y}_{channel}}^{1} [ 0 , i , j ] < thr [ 2 ] \\ 3 , & thr [ 2 ] \leq {\hat{σ}}_{{Y}_{channel}}^{1} [ 0 , i , j ]\end{matrix}$$

Ŷ[i,j]=\hat{x}_{edge}[0,i,j]*intensity[tIdx]+\hat{x}_{blur}[0,i,j]
Ŷ is modified as follows, for i=0 . . . H_{Y}−1, j=0 . . . W_{Y}−1:
   Ŷ[i,j]=clip(0,1,Ŷ[i,j])·255
In this process zero padding is used when the indices of a tensor exceeds the tensor boundaries.
The weights tensor kernel is defined as follows:

$$kernel = [ \begin{matrix}1 \div 13 & 1 \div 13 & 1 \div 13 \\ 1 \div 13 & 5 \div 13 & 1 \div 13 \\ 1 \div 13 & 1 \div 13 & 1 \div 13\end{matrix} ]$$

The reference_channel_idx_table is defined as follows:
   reference_channel_idx_table=[23, 23, 65, 65, 65]
The luma_edge_filter_intensity_list is as follows:

| luma_edge_filter_intensity_ | | | | |
|---|---|---|---|---|
| list [X][Y] | Y = 0 | Y = 1 | Y = 2 | Y = 3 |
| X = 0 | 1.00 | 1.10 | 1.25 | 1.40 |
| X = 1 | 1.00 | 1.08 | 1.12 | 1.16 |
| X = 2 | 1.00 | 1.05 | 1.06 | 1.07 |
| X = 3 | 1.00 | 1.02 | 1.03 | 1.04 |
| X = 4 | 1.00 | 1.01 | 1.02 | 1.03 |

The luma_edge_filter_thr_list_table is defined as follows:

| luma_edge_filter_thr_list_ | | | |
|---|---|---|---|
| table [X][Y] | Y = 0 | Y = 1 | Y = 2 |
| X = 0 | 0.3 | 2.0 | 6.0 |
| X = 1 | 0.4 | 3.0 | 7.0 |
| X = 2 | 0.5 | 6.0 | 10.0 |
| X = 3 | 0.6 | 7.0 | 12.0 |
| X = 4 | 0.7 | 8.0 | 14.0 |

### 5.2 Embodiment 2

Alternatively or additionally to the embodiment 1, the following might be a further implementation of the present disclosure.

1. (9.3.1) Syntax table

| | Descriptor |
|---|---|
| picture_header( ) { | |
| PIH | u(16) |
| picture_header_size | u(16) |
| img_width | u(16) |
| img_height | u(16) |
| picture_format | u(2) |
| bit_depth | u(1) |
| bit_c_ver | u(1) |
| bit_c_hor | u(1) |
| bit_s_ver | u(1) |
| bit_s_hor | u(1) |
| num_ver_splits_minus1 | u(7) |
| num_hor_splits_minus1 | u(7) |
| if( Num VerSplits > 1 NumHorSplits > 1 ) { | |
| regional_access_enabled_flag | u(1) |
| if( regional_access_enabled_flag ) | |
| for( i = 0; i < Num VerSplits; i++ ) | |
| for( j = 0; j < NumHorSplits; j++ ) | |
| independent_region_flag[ i ][ j ] | u(1) |
| } | |
| num_threads_q_minus1 | u(7) |
| num_threads_z minus1 | u(7) |
| num_threads_r_primary_minus1 | u(7) |
| num_threads_r_secondary_minus1 | u(7) |
| q_ls | u(8) |
| z_ls | u(8) |
| r_primary_ls | u(8) |
| q_stream_ls | u(8) |
| color_transform_header( ) | u(1) |
| model_header( ) | |
| } | |

q_ls indicates the number of bytes used to code the size of the q_stream.
z_is indicates the number of bytes used to code the size of the z_stream.
r_primary_ls indicates the number of bytes used to code the size of the r_primary_stream.
r_secondary_ls indicates the number of bytes used to code the size of the r_secondary_stream.

2. (9.5.1.1) Syntax table of hyper tensor

| | Descriptor |
|---|---|
| z_stream_for_one_region(substrIdx) { | |
| z_stream size | u(8*z_ls) |
| for (i =1; i <= num_threads_z_minus1; ++i) { | |
| thread_offsets_z[i] | u(24) |
| } | |
| for (i =0; i <= num_threads_z_minus1; ++i) { | |
| sub_stream[i]=sub_stream_init(i, num_threads_z_minus1+1, thread_offsets_z, z_stream_size) | |
| } | |
| for (ch =0; ch < z_primary_ch; ++ch) { | |
| for (i =0; i <= num_threads_z_minus1; ++i) { | |
| decode_z_data(sub_stream[i], z_primary[substrIdx] [ch][ ], ch, RC[6][i][j][5],, | |
| RC[6][i][j][4], i, num_threads_z_minus1+1) | |
| } | |
| } | |
| for (ch =0; ch < z_secondary_ch; ++ch) { | |
| for (i =0; i <= num_threads_z_minus1; ++i) { | |
| decode_z_data(sub_stream[i], z_secondary[substrIdx][ch][ ], ch, RC[6][i][j][5], | |
| RC[6][i][j][4], i, num_threads_z_minus1+1) | |
| } | |
| } | |
| } | |

3. (9.5.2.1) Syntax table of quality map information tensor

| | Descriptor |
|---|---|
| q_stream_for_one_region(substrIdx) | |
| q_stream size | u(8*q_ls) |
| for (i =1; i <= num_threads_q_minus1; ++i) { | |
| thread_offsets_q[i] | u(24) |
| } | |
| for (i =0; i <= num_threads_q minus1; ++i) { | |
| sub_stream[i]=sub_stream_init(i, num_threads_q_minus1+1, thread_offsets_q, | |
| q_stream_size) | |
| } | |
| for (i =0; i <= num_threads_q_minus1; ++i) { | |
| decode_r_data(sub_stream[i], q_primary[substrIdx][ ], | |
| q_primary_sigma_Idx_2D[substrIdx][ ], i, num_threads_q_minus1+1) | |
| } | |
| for (i =0; i <= num_threads_q_minus1; ++i) { | |
| decode_r_data(sub_stream[i], q_secondary[substrIdx][ ], q_secondary_sigma_Idx_2D | |
| [substrIdx][ ], i, num_threads_q_minus1+1) | |
| } | |
| } | |

4. (9.5.3.1) Syntax table of primary residual tensor

| | Descriptor |
|---|---|
| r_primary_stream_for_one_region(substrIdx) { | |
| r_primary_stream_size | u(8*r_primary_ls) |
| for (i =1; i <= num_threads_r_primary_minus1; ++i) { | |
| thread_offsets_r_primary[i] | u(32) |
| } | |
| for (i=0; i <= num_threads_r_primary_minus1; ++i) { | |
| sub_stream[i]=sub_stream_init(i, num_threads_r_primary_minus1+1, | |
| thread_offsets_r_primary, r_primary_stream_size) | |
| decode_r_data(sub_stream[i], r_primary[substrIdx][ ], sigma_Idx_primary_2D[substrIdx][ ], i, | |
| num_threads_r_primary_minus1+1) | |
| } | |
| } | |

5. (9.5.4.1) Syntax table of secondary residual tensor

| | Descriptor |
|---|---|
| r_secondary_stream_for_one_region (substrIdx) { | |
| r_secondary_stream_size | u(8*r_secondary_ls) |
| for (i =1; i <= num_threads_r_secondary_minus1; ++i) { | |
| thread_offsets_r_secondary[i] | u(24) |
| } | |
| for (i=0; i <= num_threads_r_secondary_minus1; ++i) { | |
| sub_stream[i]=sub_stream_init(i, num_threads_r_secondary_minus1+1, | |
| thread_offsets_r_secondary, r_secondary_stream_size) | |
| decode_r_data(sub_stream[i], r_secondary[substrIdx] [ ], | |
| sigma_Idx_secondary_2D[substrIdx] [ ], i, num_threads_r_secondary_minus1+1) | |
| } | |
| } | |

### 5.3 Embodiment 3

This embodiment is for some of the solution items 16 to 51 summarized above in Section 4, and those aspects that are the same as Embodiment 1 and/or Embodiment 2 are not shown.

### 1. (5.2) Specification of Syntax Functions and Descriptors

The functions presented here are used in the syntactical description. These functions are expressed in terms of the value of a bitstream pointer that indicates the position of the next bit to be read by the decoding process from the bitstream.
read_bits(n) reads the next n bits from the bitstream and advances the bitstream pointer by n bit positions. When n is equal to 0, read_bits(n) is specified to return a value equal to 0 and to not advance the bitstream pointer.
read_bits_from_back(n) reads the n bits from the end of a sub-stream in bitstream and move back the sub-stream bitstream pointer by n bit positions. When n is equal to 0, read_bits_from_back(n) is specified to return a value equal to 0 and to not move the sub-stream bitstream pointer.
byte_aligned( ) is specified as follows:
If the current position in the bitstream is a byte-aligned position, i.e., the current position is an integer multiple of 8 bits from the position of the first bit in the bitstream, the return value of byte_aligned( ) is equal to TRUE.
Otherwise, the return value of byte_aligned( ) is equal to FALSE.

The following descriptors specify the parsing process of each syntax element:
b(8): byte having any pattern of bit string (8 bits). The parsing process for this descriptor is specified by the return value of the function read_bits(8).
f(n): fixed-pattern bit string using n bits written (from left to right) with the left bit first. The parsing process for this descriptor is specified by the return value of the function read_bits(n).
i(n): signed integer using n bits. When n is “v” in the syntax table, the number of bits varies in a manner dependent on the value of other syntax elements. The parsing process for this descriptor is specified by the return value of the function read_bits(n) interpreted as a two's complement integer representation with most significant bit written first.
se(v): signed integer 0-th order Exp-Golomb-coded syntax element with the left bit first. The parsing process for this descriptor is specified in clause Annex C with the order k equal to 0.
u(n): unsigned integer using n bits. When n is “v” in the syntax table, the number of bits varies in a manner dependent on the value of other syntax elements. The parsing process for this descriptor is specified by the return value of the function read_bits(n) interpreted as a binary representation of an unsigned integer with most significant bit written first.
ub(n): unsigned integer using n bits. When n is “v” in the syntax table, the number of bits varies in a manner dependent on the value of other syntax elements. The parsing process for this descriptor is specified by the return value of the function read_bits_from_back(n) interpreted as a binary representation of an unsigned integer with most significant bit written first.

### 2. (9.2) Code Stream Layout

. . . .

The overall syntax structure of an image is:

| | Descriptor |
|---|---|
| picture( ) { | |
| SOC | u(16) |
| picture_header( ) | |
| tools_header( ) | |
| for( i = 0; i < NumVerSplits; i++ ) { | |
| for( j = 0; j < NumHorSplits; j++ ) { | |
| SOR | u(16) |
| subsIdx | u(8) |
| q_stream_for_one_region(subsIdx) | |
| z_stream_for_one_region(subsIdx) | |
| r_primary_stream_for_one_region(subsIdx) | |
| r_secondary_stream_for_one_region(subsIdx) | |
| } | |
| } | |
| EOC | u(16) |
| } | |

subsIdx indicates the region substream index.

3. (9.3) Picture header
This sub-stream contains information about image height H, width W, latent space tiles location and sizes,
control flags for each tool, scaling factors for primary and secondary component, modelIdx-learnable model
index and displacement for rate control parameters (β_{Y} for primary and β_{UV} for secondary component).

| | Descriptor |
|---|---|
| picture_header( ) { | |
| PIH | u(16) |
| picture_header_size | u(16) |
| img_width | u(16) |
| img_height | u(16) |
| picture_format | u(2) |
| bit_depth | u(1) |
| bit_c_ver | u(1) |
| bit_c_hor | u(1) |
| bit_s_ver | u(1) |
| bit_s_hor | u(1) |
| region_partitioning_flag | u(1) |
| if( region_partitioning_flag ) { | |
| region_granularity_idc | u(4) |
| num_ver_splits_minus1 | u(7) |
| num_hor_splits_minus1 | u(7) |
| regional_access_enabled_flag | u(1) |
| if( regional_access_enabled_flag ) | |
| for( i = 0; i < Num VerSplits; i++ ) | |
| for(j = 0; j < NumHorSplits; j++ ) | |
| independent_region_flag[ i ][ j ] | u(1) |
| } | |
| num_threads_q_default_minus1 | u(7) |
| num_threads_z_default_minus1 | u(7) |
| num_threads_r_primary_default_minus1 | u(7) |
| num_threads_r_secondary_default_minus1 | u(7) |
| if( region_partitioning_flag ) | |
| region_specific_threads_numbers_enabled_flag | u(1) |
| q_ls_in_bytes_minus1 | u(2) |
| z_ls_in_bytes_minus1 | u(2) |
| r_primary_ls_in_bytes_minus1 | u(2) |
| r_secondary_ls_in_bytes_minus1 | u(2) |
| color_transform_header( ) | u(1) |
| model_header( ) | |
| if( region_partitioning_flag ) { | |
| region_set_extracted_flag | u(1) |
| if( region_set_extracted_flag ) { | |
| num_present_ver_splits_minus1 | u(7) |
| num_present_hor_splits_minus1 | u(7) |
| } | |
| } | |
| while( !byte_aligned( ) ) | |
| byte_alignment_bit_equal_to_zero /* equal to 0 */ | f(1) |
| } | |

bit_s_hor is one bit value which defines c_hor=1+bit_c_hor, c_ver controls internal sub sampling mode of the secondary component in vertical direction as defined in Table 3 Usage of s_ver is descried in section 7.6 If bit_c_ver is not present in bit-stream then s_hor is equal to 1.
region_partitioning_flag equal to 1 specifies that the picture is partitioned into a set of rectangular regions. region_partitioning_flag equal to 0 specifies that the picture is not partitioned into a set of rectangular regions.
region_granularity_idc specifies the granularity of the regions. The variable RegionGranularity is derived to be equal to (region_granularity_idc+1)*128.
num_ver_splits_minus1 plus 1 specifies the number of vertical splits. When num_ver_splits_minus1 is not present, its value is inferred to be equal to 0.

The variable NumVerSplits is derived to be equal to num_ver_splits_minus1+1. The maximum value of NumVerSplits is constrained such that the width of each vertical split shall be greater than or equal to RegionGranularity pixels. The maximum value of NumVerSplits may also be further constrained depending on the profile and the level to which the codestream conforms.

The variable VerRegionSize is set equal to (((img_height+RegionGranularity−1)/RegionGranularity)/NumHorSplits)*RegionGranularity.
num_hor_splits_minus1 plus 1 specifies the number of horizontal splits. When num_hor_splits_minus1 is not present, its value is inferred to be equal to 0.

The variable NumHorSplits is derived to be equal to num_hor_splits_minus1+1. The maximum value of NumHorSplits is constrained such that the height of each horizontal split shall be greater than or equal to RegionGranularity pixels. The maximum value of NumHorSplits may also be further constrained depending on the profile and the level to which the codestream conforms.

The variable HorRegionSize is set equal to (((img_width+RegionGranularity−1)/RegionGranularity)/NumVerSplits)*RegionGranularity.

When region_partitioning_flag is equal to 1, the value of NumVerSplits*NumHorSplits shall be greater than 1.

The picture is partitioned into NumVerSplits*NumHorSplits rectangular regions.

The tensor RC[7][NumHorSplits][NumVerSplits][6] array is set as follows:

For d=0 . . . 6, i=0 . . . NumHorSplits−1,j=0 . . . NumVerSplits−1;
RC[d][i][j][0]=i*VerRegionSize/2^{d}
RC[d][i][j][1]=(i==NumHorSplits−1)?ceil(Hᵢₙ/2^{d}):(i+1)*VerRegionSize/2^{d}
RC[d][i][j][2]=j*HorRegionSize/2^{d}
RC[d][i][j][3]=(j==NumHorSplits−1)?ceil(Wᵢₙ/2^{d}):(j+1)*HorRegionSize/2^{d}
RC[d][i][j][4]=RC[d][i][j][1]−RC[d][i][j][0]
RC[d][i][j][5]=RC[d][i][j][3]−RC[d][i][j][2]

For d=0 . . . 6, y=0 . . . ceil(Hᵢₙ/2^{d})−1, x=0 . . . ceil(Hᵢₙ/2^{d})−1;
i=0 . . . NumHorSplits−1, j=0 . . . NumVerSplits−1;
if y>=RC[d][i][j][0] and y<RC[d][i][j][1] and x>=RC[d][i][j][2] and x<RC[d][i][j][3];
   sample2substrIdx[d][y][x] is set equal to i*NumVerSplits+j.
regional_access_enabled_flag equal to 1 specifies that a subset of each rectangular region can be correctly decoded without the presence of coded data of other rectangular regions, where the subset is obtained by shifting the boundaries of the rectangular region towards the inside by the tile overlap size. regional_access_enabled_flag equal to 0 specifies that there may or may not be such a subset of each rectangular region that can be correctly decoded without the presence of coded data of other rectangular regions. When regional_access_enabled_flag is not present, its value is inferred to be equal to 1.

When regional_access_enabled_flag is equal to 1, the following constraints apply:
The value of tile_size_Luma_ver shall be less than or equal to VerRegionSize.
The value of tile_size_Luma_hor shall be less than or equal to HorRegionSize.
(tile_size_Luma_ver+sᵥₑᵣ−1)/sᵥₑᵣ shall be equal to tile_size_Chroma_ver.
(tile_size_Luma_hor+sₕₒᵣ−1)/sₕₒᵣ shall be equal to tile_size_Chroma_hor.
Each luma or chroma sample on a region boundary shall also be on a tile boundary.
independent_region_flag[i][j] equal to 1 specifies that the rectangular region on the i-th row and the j-th column can be correctly decoded without the presence of coded data of other rectangular regions.
independent_region_flag[i][j] equal to 0 specifies that the rectangular region on the i-th row and the j-th column may or may not be correctly decoded without the presence of coded data of other rectangular regions. When independent_region_flag[i][j] is not present, its value is inferred to be equal to 1.
num_threads_q_default_minus1 plus 1 specifies the default number of parallelly decodable sub-stream ins the quality map codestream; the maximum value of num_threads_q_default_minus1 is 127.
num_threads_z_default_minus1 plus 1 specifies the default number of parallelly decodable sub-streams in the hyper tensor codestream; the maximum value of num_threads_z_default_minus1 is 127.
num_threads_r_primary_default_minus1 plus 1 specifies the default number of parallelly decodable sub-streams in the primary component residual tensor codestream; the maximum value of num_threads_r_primary_default_minus1 is 127 and is dependens on profiles and levels.
num_threads_r_secondary_default_minus1 plus 1 specifies the default number of parallelly decodable sub-streams in the secondary component residual tensor codestream; the maximum value of num_threads_r_secondary_default_minus1 is 127 and is dependens on profiles and levels.
q_ls_in_byte_minus1 plus 1 specifies the number of bytes used to code the size of the q_stream. The variable qLs is set equal to q_ls_in_byte_minus1+1.
z_ls_in_byte_minus1 plus 1 specifies the number of bytes used to code the size of the z_stream. The variable zLs is set equal to z_ls_in_byte_minus1+1.
r_primary_ls_in_byte_minus1 plus 1 specifies the number of bytes used to code the size of the r_primary_stream. The variable rPls is set equal to r_primary_ls_in_byte_minus1+1.
r_secondary_ls_in_byte_minus1 plus 1 specifies the number of bytes used to code the size of the r_secondary_stream. The variable rSls is set equal to r_secondary_ls_in_byte_minus1+1.
region_specific_threads_numbers_enabled_flag equal to 1 specifies that region-specific numbers of threads for the quality map, hyper tensor, primary component residual tensor, and secondary component residual tensor codestreams are enabled. region_specific_threads_numbers_enabled_flag equal to 0 specifies that region-specific numbers of threads for the quality map, hyper tensor, primary component residual tensor, and secondary component residual tensor codestreams are not enabled. When region_specific_threads_numbers_enabled_flag is not present, its value is inferred to be equal to 0.
region_set_extracted_flag equal to 1 specifies that the picture( ) syntax structure contains a set of extracted regions that forms a rectangular region of the full picture. region_set_extracted_flag equal to 0 specifies that the picture( ) syntax structure contains the full picture. When region_set_extracted_flag is not present, its value is inferred to be equal to 0.
num_present_ver_splits_minus1 plus 1 specifies the number of columns of regions contained in the picture( ) syntax structure. The value of num_present_ver_splits_minus1 shall be less than or equal to num_ver_splits_minus1. When num_present_ver_splits_minus1 is not present, its value is inferred to be equal to num_ver_splits_minus1.
num_present_hor_splits_minus1 plus 1 specifies the number of rows of regions contained in the picture( ) syntax structure. The value of num_present_hor_splits_minus1 shall be less than or equal to num_hor_splits_minus1. When num_present_hor_splits_minus1 is not present, its value is inferred to be equal to num_hor_splits_minus1.

When region_set_extracted_flag is equal to 1, the value of the variable NumVerSplits is updated to be equal to num_present_ver_splits_minus1+1, and the value of the variable NumHorSplits is updated to be equal to num_present_hor_splits_minus1+1.
byte_alignment_bit_equal_to_zero shall be equal to 0.
. . . .

4. (9.4) Tools header
This optional sub-stream contains information about tools. When the tools_header( ) marker segment is not
present in the bitstream, the following tool enabling flags are set to be 0: rvs_enable_flag, lsbs_enable_flag,
grfs_enable_flag, gain_3D_enable_flag, icci_enable_flag, LEF_enabled_flag, EFE_upsampler_enabled_flag,
and EFE nonlinear_filter_enabled_flag.
. . .

| | Descriptor |
|---|---|
| tools_header( ) { | |
| TOH | u(16) |
| tools_header_size | u(8) |
| rvs_header( ) | |
| lsbs_header( ) | |
| EFE_upsampler_parameters ( ) | |
| ICCI_header( ) | |
| EFE_non_linear_filter_parameters( ) | |
| LEF_parameters( ) | |
| Gain_parameters( ) | |
| while( !byte_aligned( ) ) | |
| byte_alignment_bit_equal_to_zero /* equal to 0 */ | f(1) |

tools_header_size is the number of bytes in the tools header excluding the first two-byte marker; byte_alignment_bit_equal_to_zero shall be equal to 0.
rvs_enable_flag—is a flag used in the RVS for each color component. 0 indicates RVS disabled, 1 indicates RVS turn on.
. . . .

5. (9.5.1.1 and 9.5.1.2) Hyper tensor syntax and semantics
. . .

| | Descriptor |
|---|---|
| z_stream_for_one_region(substrIdx) { | |
| z_stream_size_minus1 | u(8*zLs) |
| if( region_specific_threads_numbers_enabled_flag ) | |
| num_threads_z_region_override_flag | u(1) |
| if( num_threads_z_region_override_flag ) | |
| num_threads_z_minus1 | u(7) |
| for (i =1; i <= num_threads_z_minus1; ++i) { | |
| thread_offsets_z[i] | u(24) |
| } | |
| for (i =0; i <= num_threads_z_minus1; ++i) { | |
| sub_stream[i]=sub_stream_init(i, num_threads_z_minus1+1, thread_offsets_z, | |
| z_stream_size_minus1+1) | |
| } | |
| for (ch =0; ch < z_primary_ch; ++ch) { | |
| for (i =0; i <= num_threads_z_minus1; ++i) { | |
| decode_z_data(sub_stream[i], z_primary[substrIdx] [ch][ ], ch, RC[6][i][j][5],, | |
| RC[6][i][j][4], i, num_threads_z_minus1+1) | |
| } | |
| } | |
| for (ch =0; ch < z_secondary_ch; ++ch) { | |
| for (i =0; i <= num_threads_z_minus1; ++i) { | |
| decode_z_data(sub_stream[i], z_secondary[substrIdx][ch][ ], ch, RC[6][i][j][5], | |
| RC[6][i][j][4], i, num_threads_z_minus1+1) | |
| } | |
| } | |
| while( !byte_aligned( ) ) | |
| byte_alignment_bit_equal_to_zero /* equal to 0 */ | f(1) |
| } | |

z_stream_size_minus1 plus 1 is the number of bytes in the hyper tensor codestream excluding the first two-byte marker;
num_threads_z_region_override_flag equal to 1 specifies that the num_threads_z_minus1 syntax element is present. num_threads_z_region_override_flag equal to 0 specifies that the num_threads_z_minus1 syntax element is not present. When num_threads_zregion_override_flag is not present, its value is inferred to be equal to 0.
num_threads_z_minus1 plus 1 specifies the number of parallelly decodable sub-streams in the hyper tensor codestream for the current region. When num_threads_z_minus1 is not present, its value is inferred to be equal to num_threads_z_default_minus1.
thread_offsets_z[i] is the number of bytes between the start of the hyper tensor sub-stream i and the start of the hyper tensor codestream (excluding the first two-byte marker).
byte_alignment_bit_equal_to_zero shall be equal to 0.

6. (9.5.2.1 and 9.5.2.2) Quality map information tensor syntax and semantics
. . .

| | Descriptor |
|---|---|
| q_stream_for_one_region(substrIdx) | |
| q_stream_size_minus1 | u(8*qLs) |
| if( region_specific_threads_numbers_enabled_flag ) | |
| num_threads_q_region_override_flag | u(1) |
| if( num_threads_q_region_override_flag ) | |
| num_threads_q_minus1 | u(7) |
| for (i =1; i <= num_threads_q_minus1; ++i) { | |
| thread_offsets_q[i] | u(24) |
| } | |
| for (i =0; i <= num_threads_q_minus1; ++i) { | |
| sub_stream[i]=sub_stream_init(i, num_threads_q_minus1+1, thread_offsets_q, | |
| q_stream_size_minus1+1) | |
| } | |
| for (i =0; i <= num_threads_q_minus1; ++i) { | |
| decode_r_data(sub_stream[i], q_primary[substrIdx][ ], q_primary_sigma_Idx_2D[substrIdx][ ], | |
| i, num_threads_q_minus1+1) | |
| } | |
| for (i =0; i <= num_threads_q_minus1; ++i) { | |
| decode_r_data(sub_stream[i], q_secondary[substrIdx][ ], q_secondary_sigma_Idx_2D | |
| [substrIdx][ ], i, num_threads_q_minus1+1) | |
| } | |
| while( !byte_aligned( ) ) | |
| byte_alignment_bit_equal_to_zero /* equal to 0 */ | f(1) |
| } | |

q_stream_size_minus1 plus 1 is the number of bytes in the quality map codestream excluding the first two-byte marker;
num_threads_q_region_override_flag equal to 1 specifies that the num_threads_q_minus1 syntax element is present. num_threads_q_region_override_flag equal to 0 specifies that the num_threads_q_minus1 syntax element is not present. When num_threads_q_region_override_flag is not present, its value is inferred to be equal to 0.
num_threads_q_minus1 plus 1 specifies the number of parallelly decodable sub-streams in the quality map codestream for the current region. When num_threads_q_minus1 is not present, its value is inferred to be equal to num_threads_q_default_minus1.
thread_offsets_q[i] is the number of bytes between the start of the quality map sub-stream i and the start of the quality map codestream (excluding the first two-byte marker).
byte_alignment_bit_equal_to_zero shall be equal to 0.

7. (9.5.3.1 and 9.5.3.2) Primary residual tensor syntax and semantics
. . .

| | Descriptor |
|---|---|
| r_primary_stream_for_one_region(substrIdx) { | |
| r_primary_stream_size_minus1 | u(8*rPls) |
| if( region_specific_threads_numbers_enabled_flag ) | |
| num_threads_rp_region_override_flag | u(1) |
| if( num_threads_rp_region_override_flag ) | |
| num_threads_r_primary_minus1 | u(7) |
| for (i =1; i <= num_threads_r_primary_minus1; ++i) { | |
| thread_offsets_r_primary[i] | u(32) |
| } | |
| for (i=0; i <= num_threads_r_primary_minus1; ++i) { | |
| sub_stream[i]=sub_stream_init(i, num_threads_r_primary_minus1+1, | |
| thread_offsets_r_primary, r_primary_stream_size_minus1+1) | |
| decode_r_data(sub_stream[i], r_primary[substrIdx][ ], sigma_Idx_primary_2D[substrIdx][ ], i, | |
| num_threads_r_primary_minus1+1) | |
| } | |
| while( !byte_aligned( ) ) | |
| byte_alignment_bit_equal_to_zero /* equal to 0 */ | f(1) |
| } | |

r_primary_stream_size_minus1 plus 1 is the number of bytes in the primary component residual tensor codestream excluding the first two-byte marker;
num_threads_rp_region_override_flag equal to 1 specifies that the num_threads_r_primary_minus1 syntax element is present. num_threads_rp_region_override flag equal to 0 specifies that the num_threads_r_primary_minus1 syntax element is not present. When num_threads_rp_region_override_flag is not present, its value is inferred to be equal to 0.
num_threads_rprimary_minus1 plus 1 specifies the number of parallelly decodable sub-streams in the primary component residual tensor codestream for the current region. When num_threads_r_primary_minus1 is not present, its value is inferred to be equal to num_threads_r_primary_default_minus1.
thread_offsets_r_primary[i] is the number of bytes between the start of the primary component residual tensor sub-stream i and the start of the primary component residual tensor codestream (excluding the first two-byte marker);
byte_alignment_bit_equal_to_zero shall be equal to 0.

8. (9.5.4.1 and 9.5.4.2) Secondary residual tensor syntax and semantics
. . .

| | Descriptor |
|---|---|
| r_secondary_stream_for_one_region (substrIdx) { | |
| r_secondary_stream_size_minus1 | u(8*rSls) |
| if( region_specific_threads_numbers_enabled_flag ) | |
| num_threads_rs_region_override_flag | u(1) |
| if( num_threads_rs_region_override_flag ) | |
| num_threads_r_secondary_minus1 | u(7) |
| for (i =1; i <= num_threads_r_secondary_minus1; ++i) { | |
| thread_offsets_r_secondary[i] | u(24) |
| } | |
| for (i=0; i <= num_threads_r_secondary_minus1; ++i) { | |
| sub_stream[i]=sub_stream_init(i, num_threads_r_secondary_minus1+1, | |
| thread_offsets_r_secondary, r_secondary_stream_size_minus1) | |
| decode_r_data(sub_stream[i], r_secondary[substrIdx] [ ] , | |
| sigma_Idx_secondary_2D[substrIdx] [ ], i, num_threads_r_secondary_minus1+1) | |
| } | |
| while( !byte_aligned( ) ) | |
| byte_alignment_bit_equal_to_zero /* equal to 0 */ | f(1) |
| } | |

r_secondary_stream_size_minus1 plus 1 is the number of bytes in the secondary component residual tensor codestream excluding the first two-byte marker;
num_threads_rs_region_override_flag equal to 1 specifies that the num_threads_r_secondary_minus1 syntax element is present. num_threads_rs_region_override flag equal to 0 specifies that the num_threads_r_secondary_minus1 syntax element is not present. When num_threads_rsregion_override_flag is not present, its value is inferred to be equal to 0. num_threads_rsecondary_minus1 plus 1 specifies the number of parallelly decodable sub-streams in the secondary component residual tensor codestream for the current region. When num_threads_r_secondary_minus1 is not present, its value is inferred to be equal to num_threads_r_secondary_default_minus1.
thread-offsets_r_secondary[i] is the number of bytes between the start of the secondary component residual tensor sub-stream i and the start of the secondary component residual tensor codestream (excluding the first two-byte marker);
byte_alignment_bit_equal_to_zero shall be equal to 0.

More details of the embodiments of the present disclosure will be described below which are related to neural network-based visual data coding. As used herein, the term “visual data” may refer to an image, a video, a picture in a video, or any other visual data suitable to be coded. To solve the above problems and some other problems not mentioned, visual data processing solutions as described below are disclosed. The embodiments of the present disclosure should be considered as examples to explain the general concepts and should not be interpreted in a narrow way. Furthermore, these embodiments can be applied individually or combined in any manner.

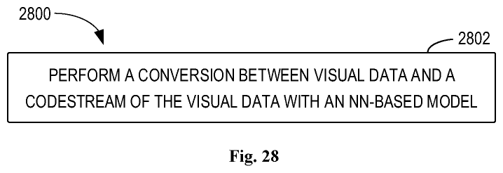

FIG. 28 illustrates a flowchart of a method 2800 for visual data processing in accordance with some embodiments of the present disclosure. At 2802, a conversion between the visual data and a codestream of the visual data is performed with a neural network (NN)-based model. For example, a codestream may comprise a sequence of bits. In addition, the codestream may further comprise associated codes which are used as markers. As used herein, the codestream may also be referred to as a bitstream.

In some embodiments, the conversion may include encoding the visual data into the codestream. Additionally or alternatively, the conversion may include decoding the visual data from the codestream. By way of example rather than limitation, the decoding model shown in FIG. 6 may be employed for decoding the visual data from the bitstream.

As used herein, an NN-based model may be a model based on neural network technologies. For example, an NN-based model may specify sequence of neural network modules (also called architecture) and model parameters. The neural network module may comprise a set of neural network layers. Each neural network layer specifies a tensor operation which receives and outputs tensor, and each layer has trainable parameters. It should be understood that the possible implementations of the NN-based model described here are merely illustrative and therefore should not be construed as limiting the present disclosure in any way.

In addition, the codestream comprises at least one indication indicating whether multithreads is used for coding at least one of the following: a hyper tensor codestream in the codestream, a quality map codestream in the codestream, a primary component residual codestream in the codestream, or a secondary component residual codestream in the codestream. For example, a thread may be a parallel processing unit. If the multithreads is enabled, a plurality of segments of a codestream may be processed with a plurality of threads in parallel. Thereby, the processing speed can be massively enhanced and thus coding efficiency can be improved.

By way of example rather than limitation, the at least one indication may comprise at least one of the following: an indication indicating whether multithreads is used for coding the hyper tensor codestream, an indication indicating whether multithreads is used for coding the quality map codestream, an indication indicating whether multithreads is used for coding the primary residual codestream, or an indication indicating whether multithreads is used for coding the secondary residual codestream. Moreover, the at least one indication may be comprised in a picture header in the codestream.

In view of the above, the codestream comprises at least one indication indicating whether multithreads is used for coding at least one of the following: a hyper tensor codestream in the codestream, a quality map codestream in the codestream, a primary component residual codestream in the codestream, or a secondary component residual codestream in the codestream. Compared with the conventional solution lacking such an indication(s), the proposed method can better support the application of multithreads for coding the codestream, and thus the coding efficiency can be improved.

In some embodiments, the codestream may comprise a substream for tools header, and zero or more bits may be added at the end of the substream until a length of the substream is an integer times of 8 bits. The additional bit(s) may have any value, such as 0, 1, or the like. For example, the added bits may be allowed to comprise one or more byte alignment bits. In one example embodiment, instances of the additional bit(s) may be extension bits only. In another example embodiment, instances of the additional bit(s) may be byte alignment bits only. In a further example embodiment, instances of the additional bit(s) may be extension bits followed by byte alignment bits. Thereby, the byte alignment of the substream for tools header can be ensured. It should be understood that the possible implementation of the additional bit(s) described here are merely illustrative and therefore should not be construed as limiting the present disclosure in any way.

In some embodiments, the codestream may comprise a first substream for hyper tensor and an indication indicating a size of the first substream. For example, the first substream may be a substream with an SOZ marker. The size of the first substream may be represented by the number of bytes. Additionally or alternatively, the first substream may comprise a marker identifier of the first substream, and the number of bytes for the marker identifier may be excluded from the size of the first substream. Furthermore, the number of bytes for the indication indicating the size of the first substream may also be excluded from the size of the first substream.

In some embodiments, the codestream may be allowed to comprise a first indication indicating the number of threads for coding the hyper tensor codestream. In addition, the codestream may further comprise an indication indicating whether the first indication is comprised in the hyper tensor codestream.

In accordance with a determination that the first indication is absent from the codestream, a value of the first indication may be inferred to be equal to a predetermined value.

In some embodiments, zero or more bits may be added at the end of the first substream until a length of the first substream is an integer times of 8 bits. The additional bit(s) may have any value, such as 0, 1, or the like. For example, the added bits may be allowed to comprise one or more byte alignment bits. In one example embodiment, instances of the additional bit(s) may be extension bits only. In another example embodiment, instances of the additional bit(s) may be byte alignment bits only. In a further example embodiment, instances of the additional bit(s) may be extension bits followed by byte alignment bits. Thereby, the byte alignment of the first substream can be ensured. It should be understood that the possible implementation of the additional bit(s) described here are merely illustrative and therefore should not be construed as limiting the present disclosure in any way.

In some embodiments, the codestream may comprise a second substream for quality map and an indication indicating a size of the second substream. For example, the second substream may be a substream with an SOQ marker. The size of the second substream may be represented by the number of bytes. Additionally or alternatively, the second substream may comprise a marker identifier of the second substream, and the number of bytes for the marker identifier may be excluded from the size of the second substream. Furthermore, the number of bytes for the indication indicating the size of the second substream may also be excluded from the size of the second substream.

In some embodiments, the codestream may further comprise a second indication indicating the number of threads for coding the quality map codestream. In addition, the codestream may further comprise an indication indicating whether the second indication is comprised in the quality map codestream. In accordance with a determination that the second indication is absent from the codestream, a value of the second indication may be inferred to be equal to a predetermined value.

In some embodiments, zero or more bits may be added at the end of the second substream until a length of the second substream is an integer times of 8 bits. The additional bit(s) may have any value, such as 0, 1, or the like. For example, the added bits may be allowed to comprise one or more byte alignment bits. In one example embodiment, instances of the additional bit(s) may be extension bits only.

In another example embodiment, instances of the additional bit(s) may be byte alignment bits only. In a further example embodiment, instances of the additional bit(s) may be extension bits followed by byte alignment bits. Thereby, the byte alignment of the second substream can be ensured. It should be understood that the possible implementation of the additional bit(s) described here are merely illustrative and therefore should not be construed as limiting the present disclosure in any way.

In some embodiments, the codestream may comprise a third substream for primary component residual and an indication indicating a size of the third substream. For example, the third substream may be a substream with an SORp marker. The size of the third substream may be represented by the number of bytes. Additionally or alternatively, the third substream may comprise a marker identifier of the third substream, and the number of bytes for the marker identifier may be excluded from the size of the third substream. Furthermore, the number of bytes for the indication indicating the size of the third substream may also be excluded from the size of the third substream.

In some embodiments, the codestream may further comprise a third indication indicating the number of threads for coding the primary component residual codestream. In addition, the codestream may further comprise an indication indicating whether the third indication is comprised in the primary component residual codestream. In accordance with a determination that the third indication is absent from the codestream, a value of the third indication may be inferred to be equal to a predetermined value.

In some embodiments, zero or more bits may be added at the end of the third substream until a length of the third substream is an integer times of 8 bits. The additional bit(s) may have any value, such as 0, 1, or the like. For example, the added bits may be allowed to comprise one or more byte alignment bits. In one example embodiment, instances of the additional bit(s) may be extension bits only. In another example embodiment, instances of the additional bit(s) may be byte alignment bits only. In a further example embodiment, instances of the additional bit(s) may be extension bits followed by byte alignment bits. Thereby, the byte alignment of the third substream can be ensured. It should be understood that the possible implementation of the additional bit(s) described here are merely illustrative and therefore should not be construed as limiting the present disclosure in any way.

In some embodiments, the codestream may comprise a fourth substream for secondary component residual and an indication indicating a size of the fourth substream. For example, the fourth substream may be a substream with an SORs marker. The size of the fourth substream may be represented by the number of bytes. Additionally or alternatively, the fourth substream may comprise a marker identifier of the fourth substream, and the number of bytes for the marker identifier may be excluded from the size of the fourth substream. Furthermore, the number of bytes for the indication indicating the size of the fourth substream may also be excluded from the size of the fourth substream.

In some embodiments, the codestream may further comprise a fourth indication indicating the number of threads for coding the secondary component residual codestream. In addition, the codestream may further comprise an indication indicating whether the fourth indication is comprised in the secondary component residual codestream. In accordance with a determination that the fourth indication is absent from the codestream, a value of the fourth indication may be inferred to be equal to a predetermined value.

In some embodiments, zero or more bits may be added at the end of the fourth substream until a length of the fourth substream may be an integer times of 8 bits. The additional bit(s) may have any value, such as 0, 1, or the like. For example, the added bits may be allowed to comprise one or more byte alignment bits. In one example embodiment, instances of the additional bit(s) may be extension bits only. In another example embodiment, instances of the additional bit(s) may be byte alignment bits only. In a further example embodiment, instances of the additional bit(s) may be extension bits followed by byte alignment bits. Thereby, the byte alignment of the fourth substream can be ensured. It should be understood that the possible implementation of the additional bit(s) described here are merely illustrative and therefore should not be construed as limiting the present disclosure in any way.

In some embodiments, the codestream may further comprise a fifth indication indicating the predetermined number of parallelly decodable substreams in each of at least one of the following: the quality map codestream, the hyper tensor codestream, a primary component residual codestream in the codestream, or a secondary component residual codestream in the codestream. In addition, the codestream may further comprise an indication indicating a length of the fifth indication.

In view of the above, the solutions in accordance with some embodiments of the present disclosure can advantageously improve coding efficiency and coding quality.

According to further embodiments of the present disclosure, a non-transitory computer-readable recording medium is provided. The non-transitory computer-readable recording medium stores a codestream of visual data which is generated by a method performed by an apparatus for visual data processing. The method comprises: performing a conversion between the visual data and the codestream with a neural network (NN)-based model, wherein the codestream comprises at least one indication indicating whether multithreads is used for coding at least one of the following: a hyper tensor codestream in the codestream, a quality map codestream in the codestream, a primary component residual codestream in the codestream, or a secondary component residual codestream in the codestream.

According to still further embodiments of the present disclosure, a method for storing codestream of visual data is provided. The method comprises: performing a conversion between the visual data and the codestream with a neural network (NN)-based model; and storing the codestream in a non-transitory computer-readable recording medium, wherein the codestream comprises at least one indication indicating whether multithreads is used for coding at least one of the following: a hyper tensor codestream in the codestream, a quality map codestream in the codestream, a primary component residual codestream in the codestream, or a secondary component residual codestream in the codestream.

Implementations of the present disclosure can be described in view of the following clauses, the features of which can be combined in any reasonable manner.

Clause 1. A method for visual data processing, comprising: performing a conversion between visual data and a codestream of the visual data with a neural network (NN)-based model, wherein the codestream comprises at least one indication indicating whether multithreads is used for coding at least one of the following: a hyper tensor codestream in the codestream, a quality map codestream in the codestream, a primary component residual codestream in the codestream, or a secondary component residual codestream in the codestream.

Clause 2. The method of clause 1, wherein the at least one indication comprises at least one of the following: an indication indicating whether multithreads is used for coding the hyper tensor codestream, an indication indicating whether multithreads is used for coding the quality map codestream, an indication indicating whether multithreads is used for coding the primary residual codestream, or an indication indicating whether multithreads is used for coding the secondary residual codestream.

Clause 3. The method of any of clauses 1-2, wherein the at least one indication is comprised in a picture header in the codestream.

Clause 4. The method of any of clauses 1-3, wherein the codestream comprises a substream for tools header, and zero or more bits are added at the end of the substream until a length of the substream is an integer times of 8 bits.

Clause 5. The method of any of clauses 1-4, wherein the codestream comprises a first substream for hyper tensor and an indication indicating a size of the first substream.

Clause 6. The method of clause 5, wherein the size of the first substream is represented by the number of bytes, and/or the first substream comprises a marker identifier of the first substream, and the number of bytes for the marker identifier is excluded from the size of the first substream.

Clause 7. The method of any of clauses 1-6, wherein the codestream is allowed to comprise a first indication indicating the number of threads for coding the hyper tensor codestream.

Clause 8. The method of any of clauses 1-7, wherein the codestream comprises a first substream for hyper tensor, and zero or more bits are added at the end of the first substream until a length of the first substream is an integer times of 8 bits.

Clause 9. The method of any of clauses 1-8, wherein the codestream comprises a second substream for quality map and an indication indicating a size of the second substream.

Clause 10. The method of clause 9, wherein the size of the second substream is represented by the number of bytes, and/or the second substream comprises a marker identifier of the second substream, and the number of bytes for the marker identifier is excluded from the size of the second substream.

Clause 11. The method of any of clauses 1-10, wherein the codestream further comprises a second indication indicating the number of threads for coding the quality map codestream.

Clause 12. The method of any of clauses 1-11, wherein the codestream comprises a second substream for quality map, and zero or more bits are added at the end of the second substream until a length of the second substream is an integer times of 8 bits.

Clause 13. The method of any of clauses 1-12, wherein the codestream comprises a third substream for primary component residual and an indication indicating a size of the third substream.

Clause 14. The method of clause 13, wherein the size of the third substream is represented by the number of bytes, and/or the third substream comprises a marker identifier of the third substream, and the number of bytes for the marker identifier is excluded from the size of the third substream.

Clause 15. The method of any of clauses 1-14, wherein the codestream further comprises a third indication indicating the number of threads for coding the primary component residual codestream.

Clause 16. The method of any of clauses 1-15, wherein the codestream comprises a third substream for primary component residual, and zero or more bits are added at the end of the third substream until a length of the third substream is an integer times of 8 bits.

Clause 17. The method of any of clauses 1-16, wherein the codestream comprises a fourth substream for secondary component residual and an indication indicating a size of the fourth substream.

Clause 18. The method of clause 17, wherein the size of the fourth substream is represented by the number of bytes, and/or the fourth substream comprises a marker identifier of the fourth substream, and the number of bytes for the marker identifier is excluded from the size of the fourth substream.

Clause 19. The method of any of clauses 1-18, wherein the codestream further comprises a fourth indication indicating the number of threads for coding the secondary component residual codestream.

Clause 20. The method of any of clauses 1-19, wherein the codestream comprises a fourth substream for secondary component residual, and zero or more bits are added at the end of the fourth substream until a length of the fourth substream is an integer times of 8 bits.

Clause 21. The method of any of clauses 4, 8, 12, 16 and 20, wherein the added bits are allowed to comprise one or more byte alignment bits.

Clause 22. The method of any of clauses 1-21, wherein the codestream further comprises a fifth indication indicating the predetermined number of parallelly decodable substreams in each of at least one of the following: the quality map codestream, the hyper tensor codestream, a primary component residual codestream in the codestream, or a secondary component residual codestream in the codestream.

Clause 23. The method of clause 22, wherein the codestream further comprises an indication indicating a length of the fifth indication.

Clause 24. The method of clause 7, wherein the codestream further comprises an indication indicating whether the first indication is comprised in the hyper tensor codestream, and/or in accordance with a determination that the first indication is absent from the codestream, a value of the first indication is inferred to be equal to a predetermined value.

Clause 25. The method of clause 11, wherein the codestream further comprises an indication indicating whether the second indication is comprised in the quality map codestream, and/or in accordance with a determination that the second indication is absent from the codestream, a value of the second indication is inferred to be equal to a predetermined value.

Clause 26. The method of clause 15, wherein the codestream further comprises an indication indicating whether the third indication is comprised in the primary component residual codestream, and/or in accordance with a determination that the third indication is absent from the codestream, a value of the third indication is inferred to be equal to a predetermined value.

Clause 27. The method of clause 19, wherein the codestream further comprises an indication indicating whether the fourth indication is comprised in the secondary component residual codestream, and/or in accordance with a determination that the fourth indication is absent from the codestream, a value of the fourth indication is inferred to be equal to a predetermined value.

Clause 28. The method of any of clauses 1-27, wherein the visual data comprise a video, a picture of the video, or an image.

Clause 29. The method of any of clauses 1-28, wherein the conversion includes encoding the visual data into the codestream.

Clause 30. The method of any of clauses 1-28, wherein the conversion includes decoding the visual data from the codestream.

Clause 31. An apparatus for visual data processing comprising a processor and a non-transitory memory with instructions thereon, wherein the instructions upon execution by the processor, cause the processor to perform a method in accordance with any of clauses 1-30.

Clause 32. A non-transitory computer-readable storage medium storing instructions that cause a processor to perform a method in accordance with any of clauses 1-30.

Clause 33. A non-transitory computer-readable recording medium storing a codestream of visual data which is generated by a method performed by an apparatus for visual data processing, wherein the method comprises: performing a conversion between the visual data and the codestream with a neural network (NN)-based model, wherein the codestream comprises at least one indication indicating whether multithreads is used for coding at least one of the following: a hyper tensor codestream in the codestream, a quality map codestream in the codestream, a primary component residual codestream in the codestream, or a secondary component residual codestream in the codestream.

Clause 34. A method for storing a codestream of visual data, comprising: performing a conversion between the visual data and the codestream with a neural network (NN)-based model; and storing the codestream in a non-transitory computer-readable recording medium, wherein the codestream comprises at least one indication indicating whether multithreads is used for coding at least one of the following: a hyper tensor codestream in the codestream, a quality map codestream in the codestream, a primary component residual codestream in the codestream, or a secondary component residual codestream in the codestream.

### Example Device

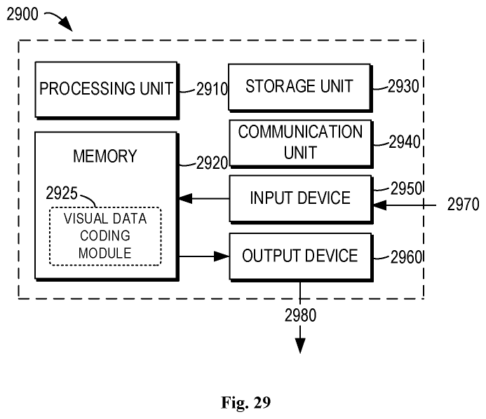

FIG. 29 illustrates a block diagram of a computing device 2900 in which various embodiments of the present disclosure can be implemented. The computing device 2900 may be implemented as or included in the source device 110 (or the visual data encoder 114) or the destination device 120 (or the visual data decoder 124).

It would be appreciated that the computing device 2900 shown in FIG. 29 is merely for purpose of illustration, without suggesting any limitation to the functions and scopes of the embodiments of the present disclosure in any manner.

As shown in FIG. 29, the computing device 2900 includes a general-purpose computing device 2900. The computing device 2900 may at least comprise one or more processors or processing units 2910, a memory 2920, a storage unit 2930, one or more communication units 2940, one or more input devices 2950, and one or more output devices 2960.

In some embodiments, the computing device 2900 may be implemented as any user terminal or server terminal having the computing capability. The server terminal may be a server, a large-scale computing device or the like that is provided by a service provider. The user terminal may for example be any type of mobile terminal, fixed terminal, or portable terminal, including a mobile phone, station, unit, device, multimedia computer, multimedia tablet, Internet node, communicator, desktop computer, laptop computer, notebook computer, netbook computer, tablet computer, personal communication system (PCS) device, personal navigation device, personal digital assistant (PDA), audio/video player, digital camera/video camera, positioning device, television receiver, radio broadcast receiver, E-book device, gaming device, or any combination thereof, including the accessories and peripherals of these devices, or any combination thereof. It would be contemplated that the computing device 2900 can support any type of interface to a user (such as “wearable” circuitry and the like).

The processing unit 2910 may be a physical or virtual processor and can implement various processes based on programs stored in the memory 2920. In a multi-processor system, multiple processing units execute computer executable instructions in parallel so as to improve the parallel processing capability of the computing device 2900. The processing unit 2910 may also be referred to as a central processing unit (CPU), a microprocessor, a controller or a microcontroller.

The computing device 2900 typically includes various computer storage medium. Such medium can be any medium accessible by the computing device 2900, including, but not limited to, volatile and non-volatile medium, or detachable and non-detachable medium. The memory 2920 can be a volatile memory (for example, a register, cache, Random Access Memory (RAM)), a non-volatile memory (such as a Read-Only Memory (ROM), Electrically Erasable Programmable Read-Only Memory (EEPROM), or a flash memory), or any combination thereof. The storage unit 2930 may be any detachable or non-detachable medium and may include a machine-readable medium such as a memory, flash memory drive, magnetic disk or another other media, which can be used for storing information and/or visual data and can be accessed in the computing device 2900.

The computing device 2900 may further include additional detachable/non-detachable, volatile/non-volatile memory medium. Although not shown in FIG. 29, it is possible to provide a magnetic disk drive for reading from and/or writing into a detachable and non-volatile magnetic disk and an optical disk drive for reading from and/or writing into a detachable non-volatile optical disk. In such cases, each drive may be connected to a bus (not shown) via one or more visual data medium interfaces.

The communication unit 2940 communicates with a further computing device via the communication medium. In addition, the functions of the components in the computing device 2900 can be implemented by a single computing cluster or multiple computing machines that can communicate via communication connections. Therefore, the computing device 2900 can operate in a networked environment using a logical connection with one or more other servers, networked personal computers (PCs) or further general network nodes.

The input device 2950 may be one or more of a variety of input devices, such as a mouse, keyboard, tracking ball, voice-input device, and the like. The output device 2960 may be one or more of a variety of output devices, such as a display, loudspeaker, printer, and the like. By means of the communication unit 2940, the computing device 2900 can further communicate with one or more external devices (not shown) such as the storage devices and display device, with one or more devices enabling the user to interact with the computing device 2900, or any devices (such as a network card, a modem and the like) enabling the computing device 2900 to communicate with one or more other computing devices, if required. Such communication can be performed via input/output (I/O) interfaces (not shown).

In some embodiments, instead of being integrated in a single device, some or all components of the computing device 2900 may also be arranged in cloud computing architecture. In the cloud computing architecture, the components may be provided remotely and work together to implement the functionalities described in the present disclosure. In some embodiments, cloud computing provides computing, software, visual data access and storage service, which will not require end users to be aware of the physical locations or configurations of the systems or hardware providing these services. In various embodiments, the cloud computing provides the services via a wide area network (such as Internet) using suitable protocols. For example, a cloud computing provider provides applications over the wide area network, which can be accessed through a web browser or any other computing components. The software or components of the cloud computing architecture and corresponding visual data may be stored on a server at a remote position. The computing resources in the cloud computing environment may be merged or distributed at locations in a remote visual data center. Cloud computing infrastructures may provide the services through a shared visual data center, though they behave as a single access point for the users. Therefore, the cloud computing architectures may be used to provide the components and functionalities described herein from a service provider at a remote location. Alternatively, they may be provided from a conventional server or installed directly or otherwise on a client device.

The computing device 2900 may be used to implement visual data encoding/decoding in embodiments of the present disclosure. The memory 2920 may include one or more visual data coding modules 2925 having one or more program instructions. These modules are accessible and executable by the processing unit 2910 to perform the functionalities of the various embodiments described herein.

In the example embodiments of performing visual data encoding, the input device 2950 may receive visual data as an input 2970 to be encoded. The visual data may be processed, for example, by the visual data coding module 2925, to generate an encoded bitstream. The encoded bitstream may be provided via the output device 2960 as an output 2980.

In the example embodiments of performing visual data decoding, the input device 2950 may receive an encoded bitstream as the input 2970. The encoded bitstream may be processed, for example, by the visual data coding module 2925, to generate decoded visual data. The decoded visual data may be provided via the output device 2960 as the output 2980.

While this disclosure has been particularly shown and described with references to preferred embodiments thereof, it will be understood by those skilled in the art that various changes in form and details may be made therein without departing from the spirit and scope of the present application as defined by the appended claims. Such variations are intended to be covered by the scope of this present application. As such, the foregoing description of embodiments of the present application is not intended to be limiting.

I/We claim:

1. A method for visual data processing, comprising:
performing a conversion between visual data and a codestream of the visual data with a neural network (NN)-based model, wherein the codestream comprises at least one indication indicating whether multithreads is used for coding at least one of the following:
a hyper tensor codestream in the codestream,
a quality map codestream in the codestream,
a primary component residual codestream in the codestream, or
a secondary component residual codestream in the codestream.

2. The method of claim 1, wherein the at least one indication comprises at least one of the following: an indication indicating whether multithreads is used for coding the hyper tensor codestream, an indication indicating whether multithreads is used for coding the quality map codestream, an indication indicating whether multithreads is used for coding the primary residual codestream, or an indication indicating whether multithreads is used for coding the secondary residual codestream, or
wherein the at least one indication is comprised in a picture header in the codestream.

3. The method of claim 1, wherein the codestream comprises a substream for tools header, and zero or more bits are added at the end of the substream until a length of the substream is an integer times of 8 bits, or
wherein the codestream comprises a first substream for hyper tensor and an indication indicating a size of the first substream.

4. The method of claim 3, wherein the added bits are allowed to comprise one or more byte alignment bits, or
wherein the size of the first substream is represented by the number of bytes, and/or the first substream comprises a marker identifier of the first substream, and the number of bytes for the marker identifier is excluded from the size of the first substream.

5. The method of claim 1, wherein the codestream is allowed to comprise a first indication indicating the number of threads for coding the hyper tensor codestream, or
wherein the codestream comprises a first substream for hyper tensor, and zero or more bits are added at the end of the first substream until a length of the first substream is an integer times of 8 bits.

6. The method of claim 1, wherein the codestream comprises a second substream for quality map and an indication indicating a size of the second substream.

7. The method of claim 6, wherein the size of the second substream is represented by the number of bytes, and/or
the second substream comprises a marker identifier of the second substream, and the number of bytes for the marker identifier is excluded from the size of the second substream.

8. The method of claim 1, wherein the codestream further comprises a second indication indicating the number of threads for coding the quality map codestream, or
wherein the codestream comprises a second substream for quality map, and zero or more bits are added at the end of the second substream until a length of the second substream is an integer times of 8 bits.

9. The method of claim 1, wherein the codestream comprises a third substream for primary component residual and an indication indicating a size of the third substream.

10. The method of claim 9, wherein the size of the third substream is represented by the number of bytes, and/or
the third substream comprises a marker identifier of the third substream, and the number of bytes for the marker identifier is excluded from the size of the third substream.

11. The method of claim 1, wherein the codestream further comprises a third indication indicating the number of threads for coding the primary component residual codestream, or
wherein the codestream comprises a third substream for primary component residual, and zero or more bits are added at the end of the third substream until a length of the third substream is an integer times of 8 bits.

12. The method of claim 1, wherein the codestream comprises a fourth substream for secondary component residual and an indication indicating a size of the fourth substream.

13. The method of claim 12, wherein the size of the fourth substream is represented by the number of bytes, and/or
the fourth substream comprises a marker identifier of the fourth substream, and the number of bytes for the marker identifier is excluded from the size of the fourth substream.

14. The method of claim 1, wherein the codestream further comprises a fourth indication indicating the number of threads for coding the secondary component residual codestream, or
wherein the codestream comprises a fourth substream for secondary component residual, and zero or more bits are added at the end of the fourth substream until a length of the fourth substream is an integer times of 8 bits.

15. The method of claim 1, wherein the visual data comprise a video, a picture of the video, or an image.

16. The method of claim 1, wherein the conversion includes encoding the visual data into the codestream.

17. The method of claim 1, wherein the conversion includes decoding the visual data from the codestream.

18. The method of claim 1, wherein the conversion comprises: generating the codestream from the visual data, and
the method further comprises: storing the codestream in a non-transitory computer-readable recording medium.

19. An apparatus for visual data processing comprising a processor and a non-transitory memory with instructions thereon, wherein the instructions upon execution by the processor, cause the processor to perform operations comprising:
performing a conversion between visual data and a codestream of the visual data with a neural network (NN)-based model, wherein the codestream comprises at least one indication indicating whether multithreads is used for coding at least one of the following:
a hyper tensor codestream in the codestream,
a quality map codestream in the codestream,
a primary component residual codestream in the codestream, or
a secondary component residual codestream in the codestream.

20. A non-transitory computer-readable storage medium storing instructions that cause a processor to perform operations comprising:
performing a conversion between visual data and a codestream of the visual data with a neural network (NN)-based model, wherein the codestream comprises at least one indication indicating whether multithreads is used for coding at least one of the following:
a hyper tensor codestream in the codestream,
a quality map codestream in the codestream,
a primary component residual codestream in the codestream, or
a secondary component residual codestream in the codestream.
